(19) United States
(12) Patent Application Publication
(10) Pub. No.: US 2019/0069047 A1
(43) Pub. Date: Feb. 28, 2019

(54) METHODS AND SYSTEMS FOR SHARING LIVE STREAM MEDIA CONTENT

(71) Applicant: VOLLEY MEDIA, LLC, Beaverton, OR (US)

(72) Inventors: Monte Dale Wood, Lake Oswego, OR (US); Stephen David Jones, Chatswood (AU)

(21) Appl. No.: 16/111,627

(22) Filed: Aug. 24, 2018

Related U.S. Application Data
(60) Provisional application No. 62/670,769, filed on May 12, 2018.
(60) Provisional application No. 62/613,021, filed on Jan. 2, 2018.
(60) Provisional application No. 62/593,160, filed on Nov. 30, 2017.
(60) Provisional application No. 62/572,360, filed on Oct. 13, 2017.
(60) Provisional application No. 62/550,512, filed on Aug. 25, 2017.

(51) Int. Cl. H04N 21/845; H04N 21/2187; H04N 21/466; H04N 21/44; H04N 21/458; H04N 21/482

(52) U.S. Cl. CPC H04N 21/8456; H04N 21/2187; H04N 21/4667; G06F 3/0482; H04N 21/458; H04N 21/4825; H04N 21/44008

(57) ABSTRACT

A system for sharing timestamped live stream media content can include a controller configured to be communicably coupled to a content delivery network (CDN) and an app on a user system, where the controller includes a database module and a uniform resource identifier (URI) generator, where the controller is configured to: receive a selection of the timestamped live stream media content from the app on the user system; generate a table populated with the selection and other information associated with the selection of the timestamped live stream media content; generate a uniform resource identifier (URI) derived from contents of the table; and send the URI to the app on the user system.

### CROSS-REFERENCE TO RELATED APPLICATIONS

This application claims priority under 35 U.S.C. § 119 to U.S. Provisional Patent Application Ser. No. 62/670,769, titled “Methods and Systems For Sharing Live Stream Media Content” and filed on May 12, 2018, to U.S. Provisional Patent Application Ser. No. 62/613,021, titled “Video Clip Sharing System” and filed on Jan. 2, 2018, to U.S. Provisional Patent Application Ser. No. 62/593,160, titled “Video Clip Sharing System” and filed on Nov. 30, 2017, to U.S. Provisional Patent Application Ser. No. 62/572,360, titled “Video Clip Sharing System” and filed on Oct. 13, 2017, and to U.S. Provisional Patent Application Ser. No. 62/550,512, titled “Video Clip Sharing System” and filed on Aug. 25, 2017. The entire contents of each of these aforementioned applications are hereby incorporated herein by reference.

### TECHNICAL FIELD

Embodiments described herein relate generally to media sharing, and more particularly to systems, methods, and devices for sharing timestamped live stream media content.

### BACKGROUND

Media content is often generated at a number of live events, such as conferences, meetings, concerts, festivals, theater productions, and sporting events. Such content can include video, sound recordings, and still images. While these live events are often broadcast in their entirety, there are times when individuals want to share specific moments at those live events, in real time, with other individuals.

### SUMMARY

In general, in one aspect, the disclosure relates to a system for sharing live stream media content in real time. The system can include at least one encoder that is configured to mirror, in real time, live streaming content being encoded by a cloud server encoder, where the at least one encoder programs, in real time, the live streaming content to generate live stream media content, where the live streaming content is received in real time by the cloud server encoder from a content provider of a live event. The system can also include a controller communicably coupled to the at least one encoder. The controller can receive the live stream media content from the at least one encoder in real time. The controller can also receive a request for the live stream media content from a user through an app in real time. The controller can further send, in real time, the live stream media content to the user through the app. The controller can also receive, in real time, a selection of a portion of the live stream media content from the user through the app. The controller can further generate, in real time and based on the selection of the portion of the live stream media content, a uniform resource identifier (URI), where the URI is derived from the portion of the live stream media content and associated information. The controller can also send, in real time, the URI to the user through the app.

In another aspect, the disclosure can generally relate to a system for sharing live streaming media content. The system can include a user's app operating on a mobile device. The system can also include a recipient's app operating on a mobile device, the recipient's app operative to communicate with the user's app via electronic messaging. The system can further include a content provider server operating as a source for the live streaming media content. The system can also include a back-end system configured to receive the live streaming media content from the content provider server in substantially real-time. The back-end system can also be configured to assign a streaming media content ID in response to receiving the live streaming media content from the content provider server. The back-end system can also be configured to receive a request from the user's app for one or more live streaming media content presentations. The back-end system can further be configured to send identifying representations associated with the live streaming media content presentations to the user's app. The back-end system can also be configured to receive selection information from the user's app for a selection of one of the live streaming media content representations associated with the live content, the selection information comprising a user ID, a start time for a selection of the live media content, and an end time for the selection of the live streaming media content. The back-end system can further be configured to generate a uniform resource identifier (URI) for the live streaming media content based on the streaming media content ID and the selection information. The back-end system can also be configured to send the URI to the user's app, which is operative to distribute the URI the recipient's app via an electronic message transmitted by the user's app. The back-end system can further be configured to in response to receiving the URI from a recipient's app, retrieve the live streaming media content, the selection information, and content provider information (for example, advertising) from a database having an organization based on the streaming media content ID and the user ID. The back-end system can also be configured to generate a page comprising the selection of the live streaming media content, the selection information, and the content provider information. The back-end system can further be configured to transmit the page to a recipient's mobile device to enable play-back by the mobile device of the live streaming media content selection, the selection information and the content provider information.

These and other aspects, objects, features, and embodiments will be apparent from the following description and the appended claims.

### BRIEF DESCRIPTION OF THE DRAWINGS

The drawings illustrate only example embodiments of sharing live stream media content (also called timestamped live stream media content herein) in real time and are therefore not to be considered limiting of its scope, as sharing live stream media content in real time may admit to other equally effective embodiments. The elements and features shown in the drawings are not necessarily to scale, emphasis instead being placed upon clearly illustrating the principles of the example embodiments. Additionally, certain dimensions or positioning may be exaggerated to help visually convey such principles. In the drawings, reference numerals designate like or corresponding, but not necessarily identical, elements.

FIG. 1A shows a diagram of a system for sharing live stream media content in real time in accordance with certain example embodiments.

FIG. 1B shows an example controller of the system of FIG. 1A.

FIG. 2 shows a high-level flow diagram of a method for sharing timestamped live stream media content in real time in accordance with certain example embodiments.

FIG. 3 shows a flow diagram of a method for sharing timestamped live stream media content in real time from the perspective of a user in accordance with certain example embodiments.

FIG. 4 shows a flow diagram of a method for sharing timestamped live stream media content in real time from the perspective of a live media sharing system in accordance with certain example embodiments.

FIG. 5 shows a flow diagram of a method for sharing timestamped live stream media content in real time from the perspective of a recipient in accordance with certain example embodiments.

FIG. 6 shows a flow diagram of a method for sharing timestamped live stream media content in real time from the perspective of a content provider in accordance with certain example embodiments.

FIG. 7 shows a format of a uniform resource identifier in accordance with certain example embodiments.

FIG. 8 shows a format of a page with selected timestamped live stream media content in real time in accordance with certain example embodiments.

FIGS. 9A and 9B show a detailed flow diagram of the entire process for creating and sharing selected timestamped live stream media content in real time in accordance with certain example embodiments.

FIGS. 10A-10V show a series of images illustrating an example of sharing streaming media content in accordance with certain example embodiments.

FIGS. 11A-11C each shows an analytics output in accordance with certain example embodiments.

FIG. 12 shows a computing device in accordance with certain example embodiments.

### DETAILED DESCRIPTION OF EXAMPLE EMBODIMENTS

The example embodiments discussed herein are directed to systems, methods, and devices for sharing timestamped live stream media content in real time. While example embodiments are described herein as being directed to sharing media content of live events, example embodiments can also be used for sharing media content of historical (pre-recorded) events. Any live or historical events can include, but are not limited to, a movie, a concert, a lecture, a presentation, a performance, surveillance, a sermon, a sporting event, and news coverage. Content from such live events are referred to herein as live media content. This live media content is converted into timestamped live stream media content using example embodiments, which can be shared between individuals in real time.

As defined herein, the term “in real time” (or simply “real time”) is meant to be substantially instantaneous, subject to minimal delays due to processing time and the transmission of data and communication signals. For example, under certain circumstances, “in real time” can mean a delay of only a few seconds (e.g., six seconds, four seconds) between when a live event occurs and when the timestamped live stream media content is shared (or captured for sharing) on an app by a user, as described below. In this way, timestamped live stream media content can be substantially concurrent with the corresponding live event. Example embodiments can be used to provide timestamped live stream media content in real time relative to when the recorded event occurs. Alternatively, example embodiments can be used to provide timestamped live stream media content under some substantial delay relative to when the recorded event occurs.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of sharing timestamped live stream media content in real time will be described more fully hereinafter with reference to the accompanying drawings, in which example embodiments of sharing timestamped live stream media content in real time are shown. Sharing timestamped live stream media content in real time may, however, be embodied in many different forms and should not be construed as limited to the example embodiments set forth herein. Rather, these example embodiments are provided so that this disclosure will be thorough and complete, and will fully convey the scope of sharing timestamped live stream media content in real time to those or ordinary skill in the art. Like, but not necessarily the same, elements (also sometimes called components) in the various figures are denoted by like reference numerals for consistency.

Terms such as “first”, “second”, and “within” are used merely to distinguish one component (or part of a component or state of a component) from another. Such terms are not meant to denote a preference or a particular orientation, and are not meant to limit embodiments of sharing timestamped live stream media content in real time. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

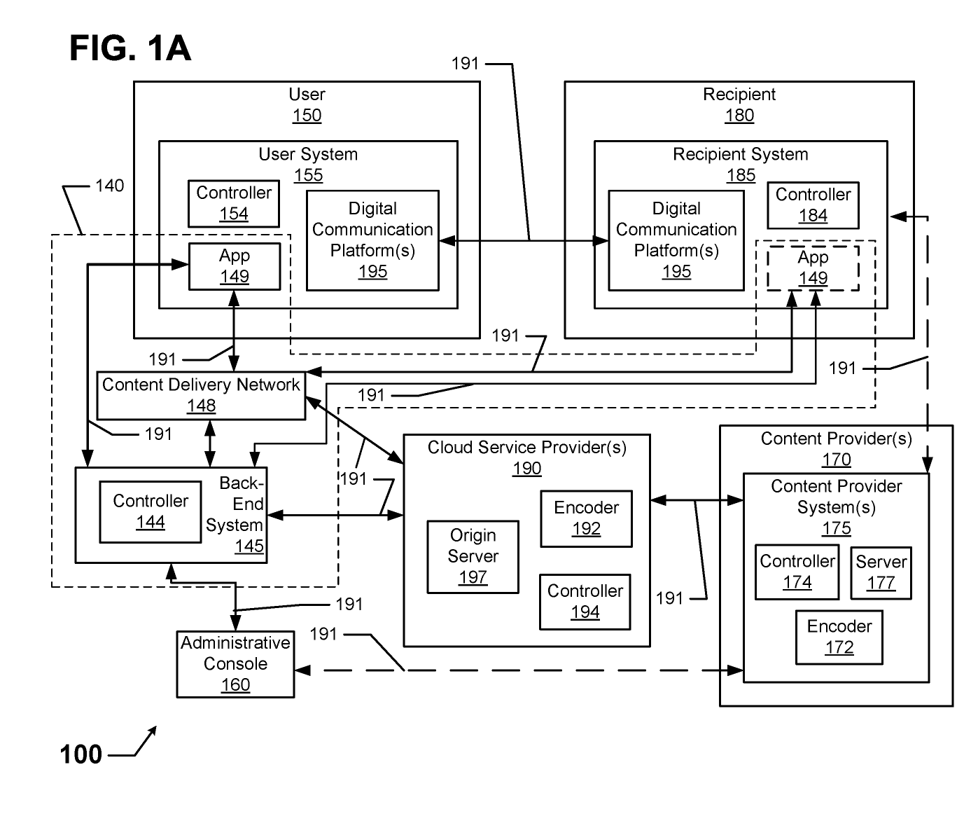

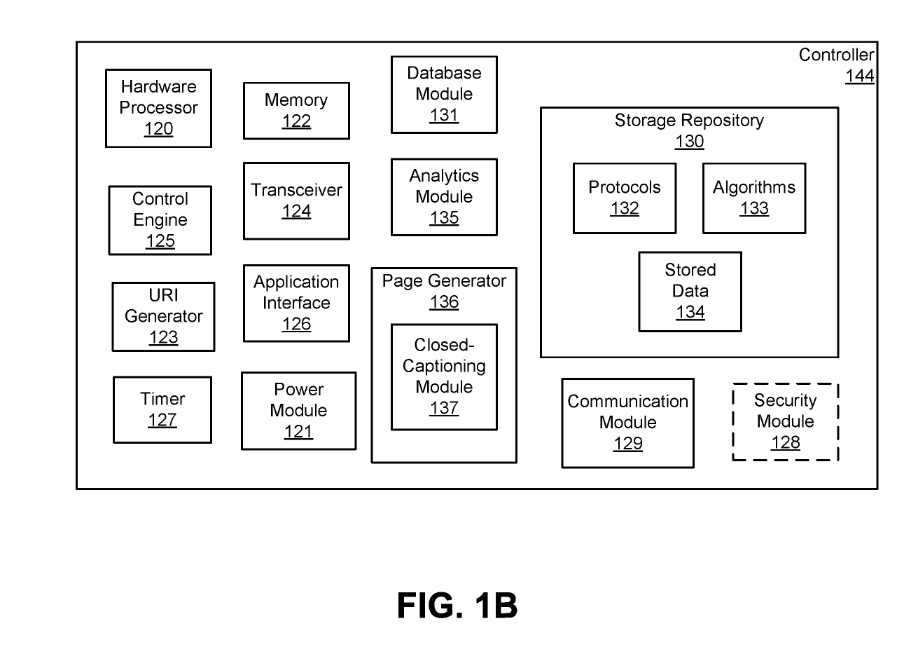

FIG. 1A shows a diagram of a system 100 for sharing timestamped live stream media content in real time in accordance with certain example embodiments. FIG. 1B shows an example controller 144 of the system 100 of FIG. 1A. Referring to FIGS. 1A and 1B, the system 100 can include one or more users 150, one or more recipients 180, one or more content providers 170, one or more cloud service providers 190, an administrative console 160, and a live media sharing system 140. The user 150 includes a user system 155, which includes a controller 154 and a digital communication platform 195. Each recipient 180 includes a recipient system 185, which includes a controller 184 and the digital communication platform 195. The live media sharing system 140 includes an app 149 (which resides on the user system 155 and the recipient system 185), a content delivery network 148 (also called a content distribution network 148 or a CDN 148), and a back-end system 145, which includes a controller 144. Each cloud service provider 190 includes an origin server 197, a controller 194, and an encoder 192. Each content provider 170 includes a content provider system 175, which includes a controller 174, one or more servers 177, and an encoder 172.

The controller 144 of the back-end system 145 of the live media sharing system 140 can include one or more of a number of components. As shown in FIG. 1B, such components, can include, but are not limited to, a control engine 125, a communication module 129, a URI generator 123, a database module 131, an analytics module 135, a page generator 136 (which includes a closed-captioning module 137), a timer 127, a power module 121, a storage repository 130, a hardware processor 120, a memory 122, a transceiver 124, an application interface 126, and, optionally, a security module 128. The storage repository 130 can include protocols 132, algorithms 133, and stored data 134.

The components shown in FIGS. 1A and 1B are not exhaustive, and in some embodiments, one or more of the components shown in FIGS. 1A and 1B may not be included in an example system 100. Any component of the example system 100 can be discrete or combined with one or more other components of the system 100. For example, each controller (e.g., controller 144, controller 154) in the system 100 can have its own transceiver. Also, each component (or portion thereof) can be co-located, or remotely located, relative to another component (or other portions thereof). For example, some of the storage repository 130 of the controller 144 of the live media sharing system 140 can be co-located with the hardware processor 120, while a remainder of the storage repository 130 is remotely located relative to the location of the hardware processor 120.

Generally speaking, the live media sharing system 140, through the app 149, resides on the user system 155 of the user 150 and, in some cases, on the recipient system 185 of each recipient 180. The back-end system 145 and the CDN 148 of the live media sharing system 140 communicate with the app 149 using one or more communication links 191. The CDN 148 of the live media sharing system 140 can also communicate with the origin server 197 of the cloud service provider 190 using one or more communication links 191. The controller 144 of the back-end system 145 of the live media sharing system 140 communicates with the origin server 197 of the cloud service provider 190 using one or more communication links 191. Also, the cloud service provider 190 communicates with one or more content providers 170 using one or more communication links 191.

Further, one or more digital communication platforms 195 (defined below) of the user system 155 communicates with one or more digital communication platforms 195 of the recipient system 185 using one or more communication links 191. In addition, the administrative console 160 communicates with the back-end system 145 using one or more communication links 191. In some cases, the administrative console 160 can communicate with a content provider system 175 using one or more communication links 191. Further, in some cases, a recipient system 185 can communicate with a content provider system 175 using one or more communication links 191.

In alternative embodiments, a component of the system 100 of FIG. 1A that is not shown in direct communication with another component of the system 100 can be in direct communication using one or more communication links 191. Similarly, in other alternative embodiments, communication links 191 between one component of the system 100 of FIG. 1A and another component of the system 100 can be removed to prevent direct communication between those components.

Each communication link 191 can include wired (e.g., Class 1 electrical cables, Class 2 electrical cables, electrical connectors) and/or wireless (e.g., Wi-Fi, visible light communication, cellular networking, Bluetooth, Bluetooth Low Energy, WirelessHART, ISA100, Power Line Carrier, RS485, DALI) technology. For example, a communication link 191 can be (or include) a radio frequency signal that is wirelessly transceived (sent and/or received) between the user system 155 and the recipient system 185 using one or more modems, routers, and/or repeaters. As another example, a communication link 191 can be or include one or more electrical conductors that are coupled to and between the controller 144 of the back-end system 145 and the origin server 197 of the cloud service provider 190. The communication links 191 can transmit signals (e.g., power signals, communication signals, control signals, data) between the client provider system 175, the cloud service provider 190, the user system 155, the back-end system 145, and the recipient system 185.

The app 149 of the live media sharing system 140 is specially-designed software that resides on, is downloaded to, and/or is removed from a system (e.g., a user system 155, a recipient system 185). The app 149 can have any of a number of forms and/or configurations. For example, the app 149 can be (or be part of) an application programming interface (API). As another example, the app 149 can be (or be part of) a software development kit (SDK). As still another example, the app 149 can be a mobile application.

The app 149 allows a user 150, through the user system 155, to interact with the back-end system 145 to view choices of timestamped live stream media content, select one of the choices of timestamped live stream media content, select a portion of live stream media content, annotate (e.g., change start time, change end time, change duration, add commentary) a selected portion of timestamped live stream media content, and submit a selected portion of timestamped live stream media content, with all of the associated annotations and other settings, to the back-end system 145. Again, as stated above, since example embodiments can also be applied to media content that is pre-recorded (e.g., live content that is not streamed in real time, a home movie), the app 149 can also be used to provide annotations, editing, and other enhancements related to the selection of such pre-recorded media content.

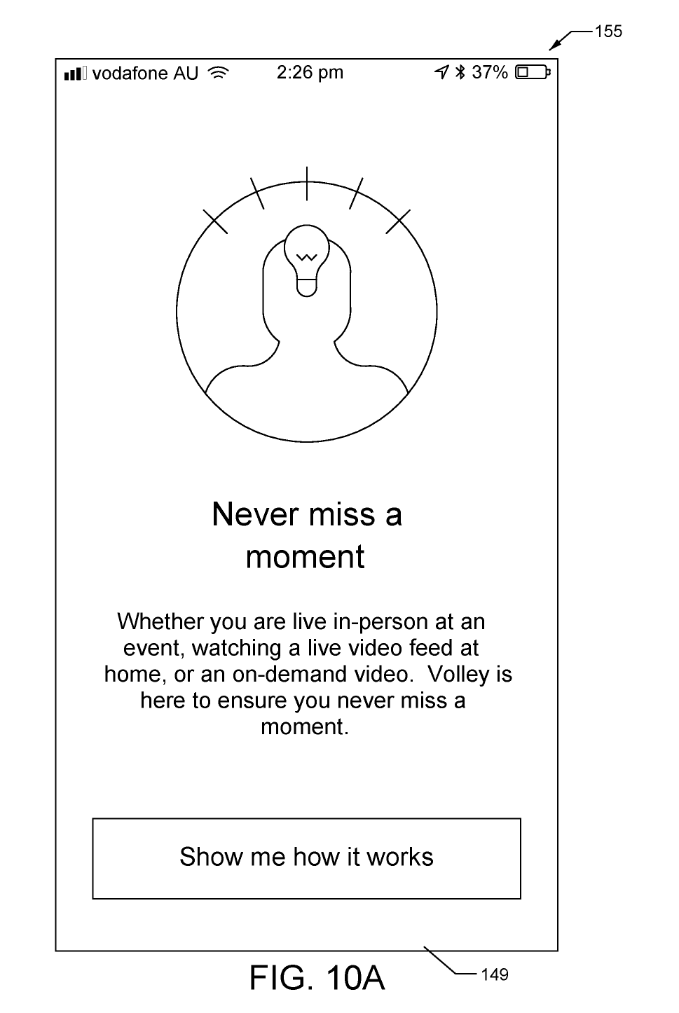

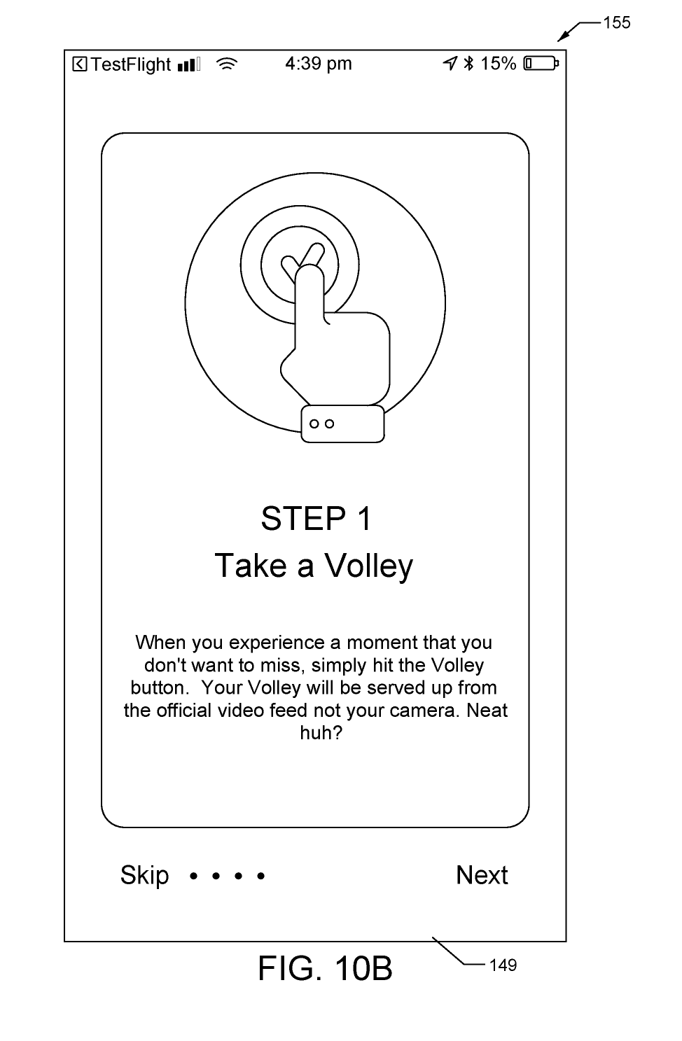

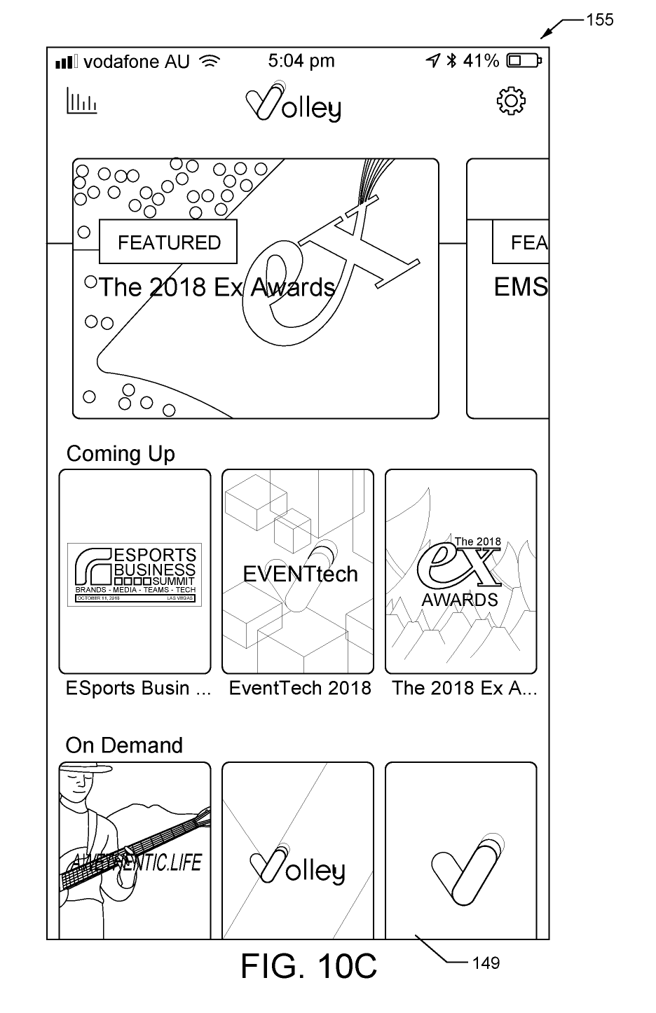

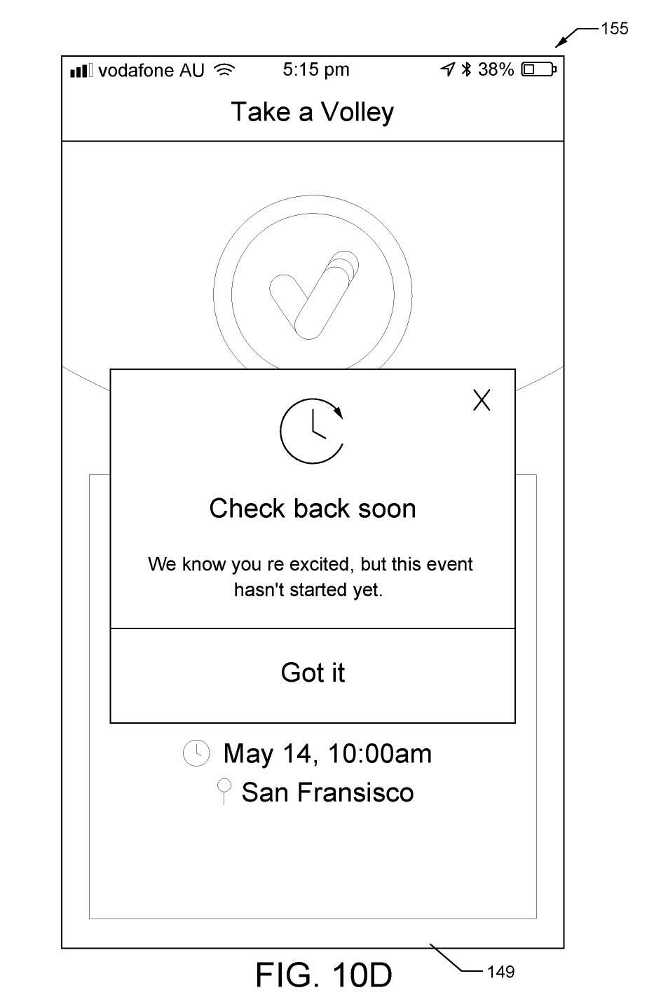

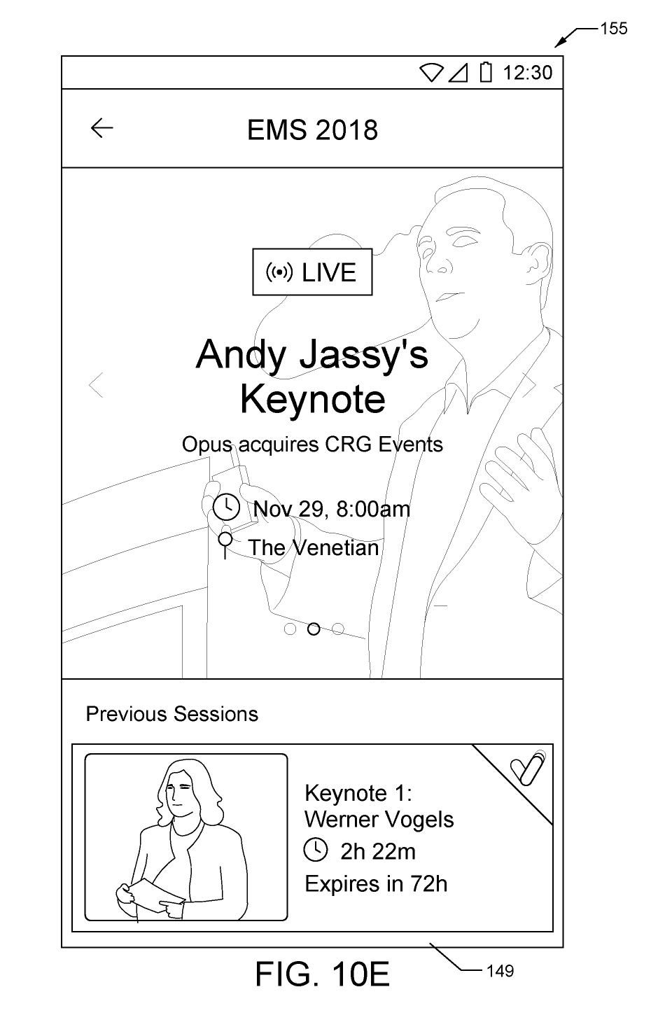

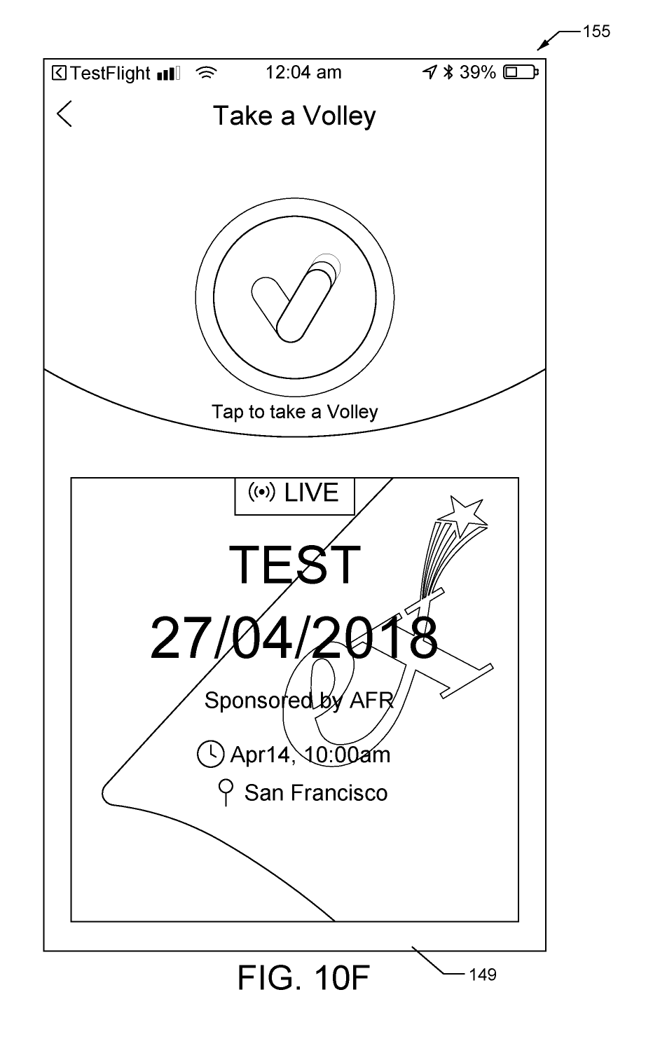

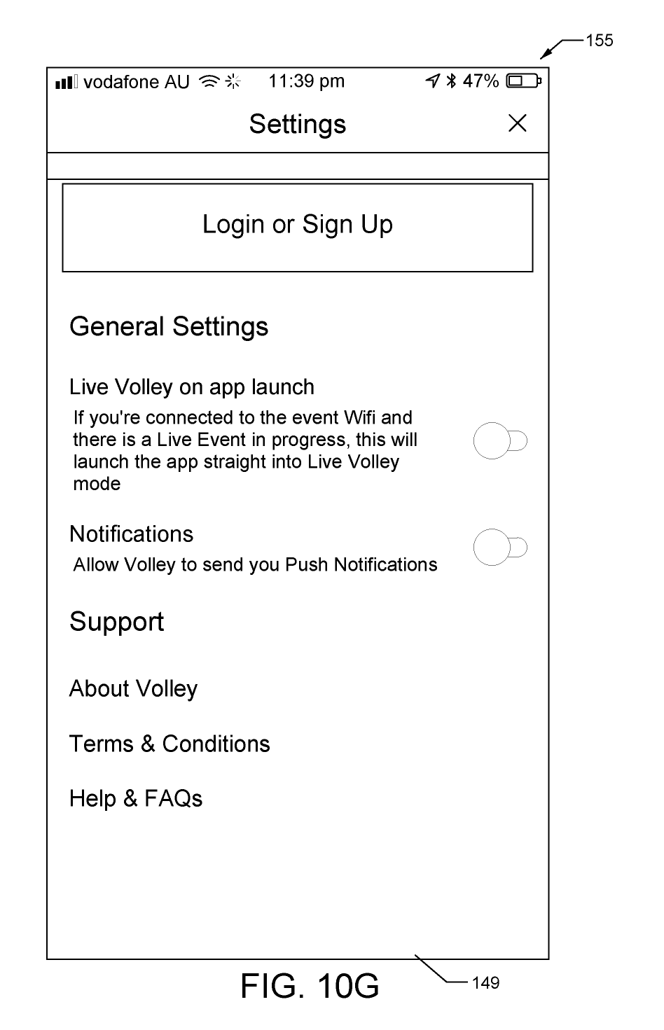

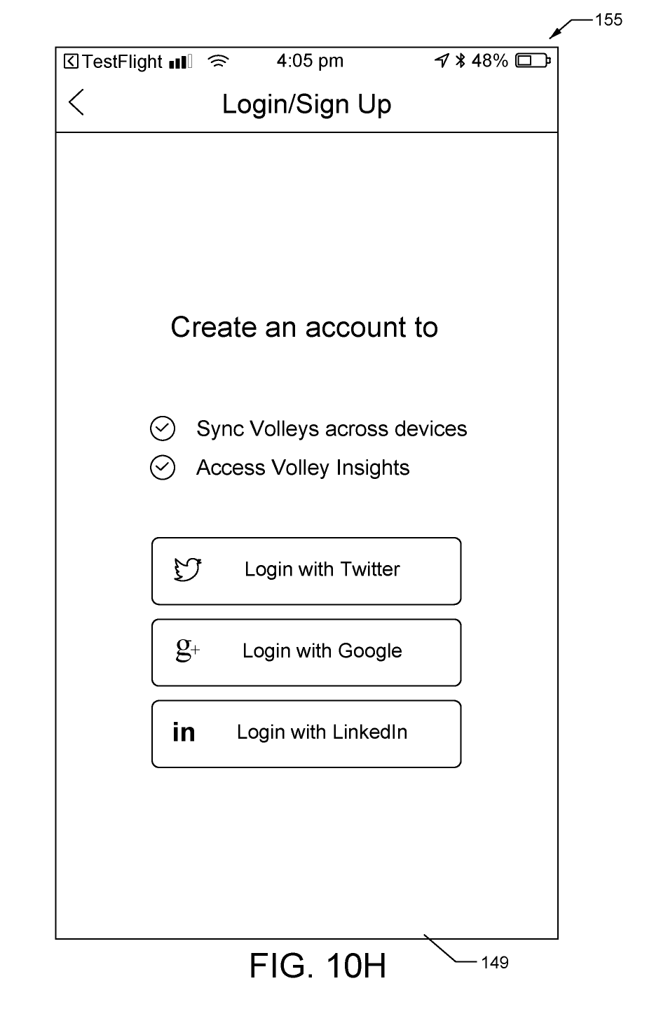

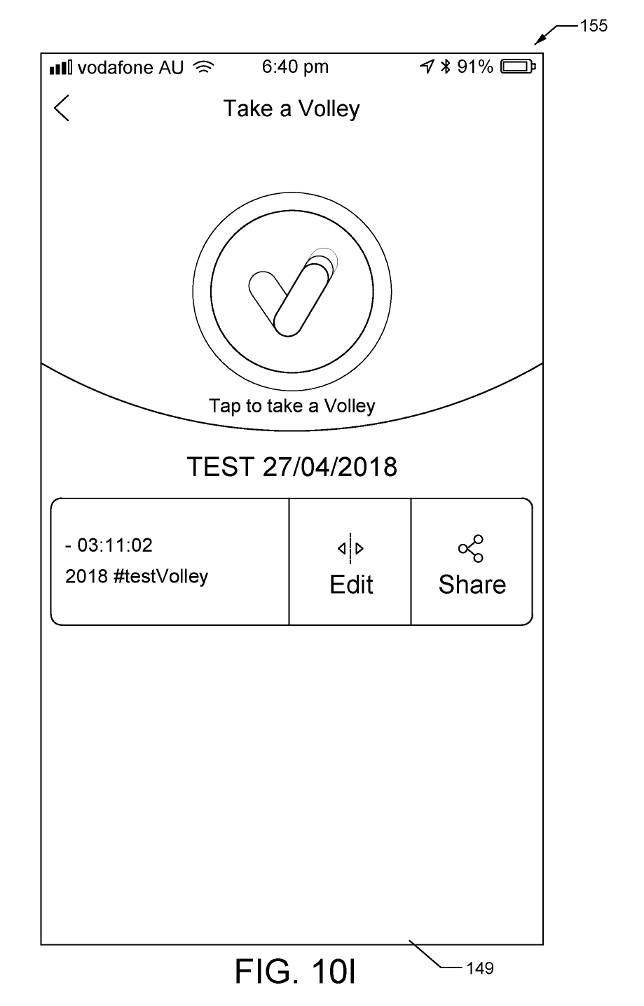

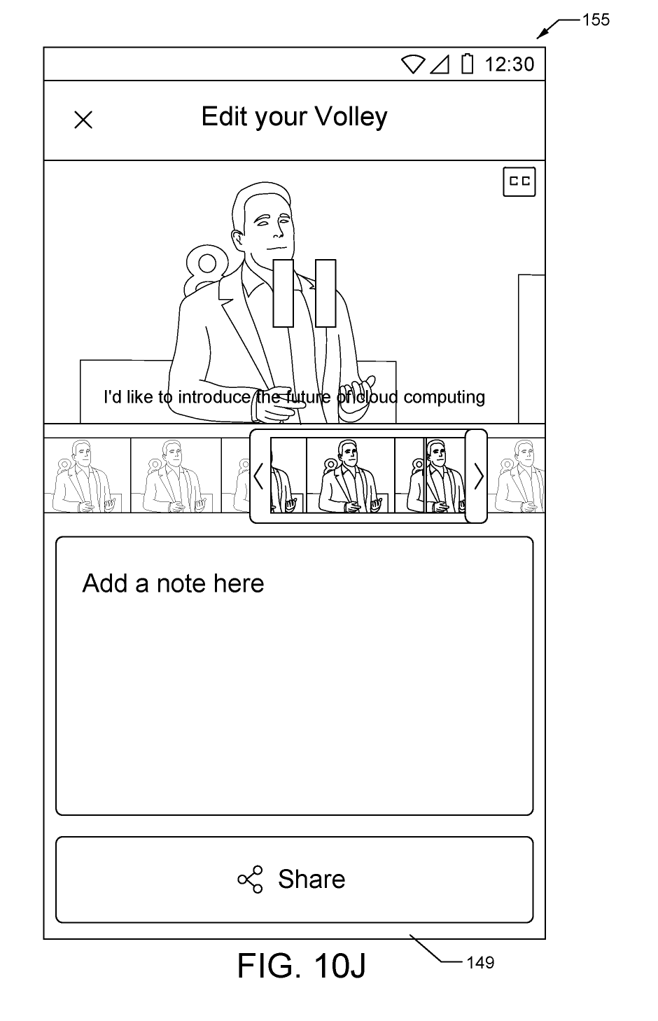

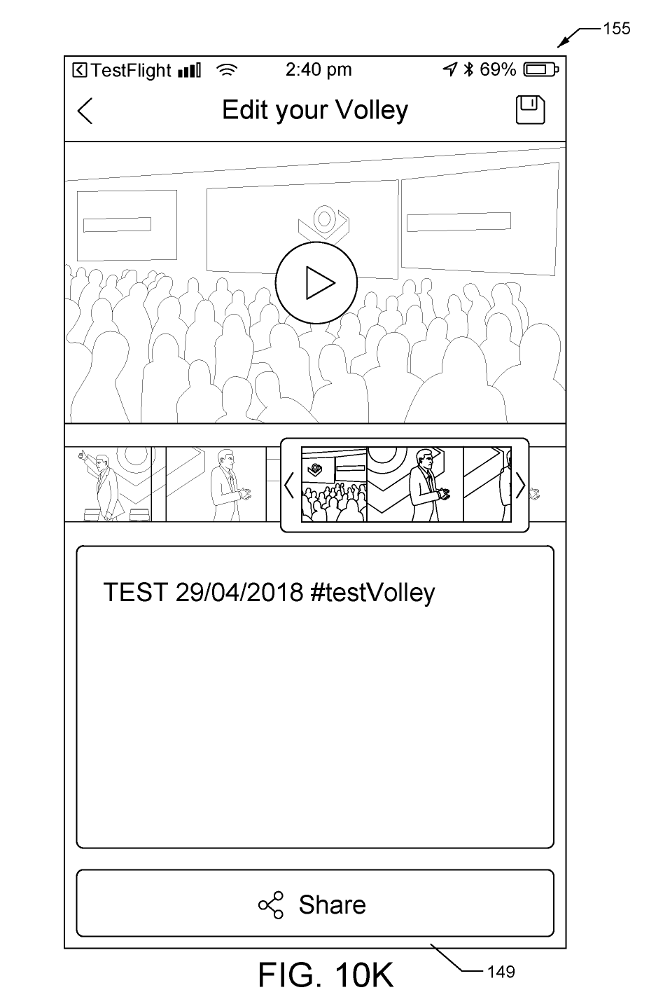

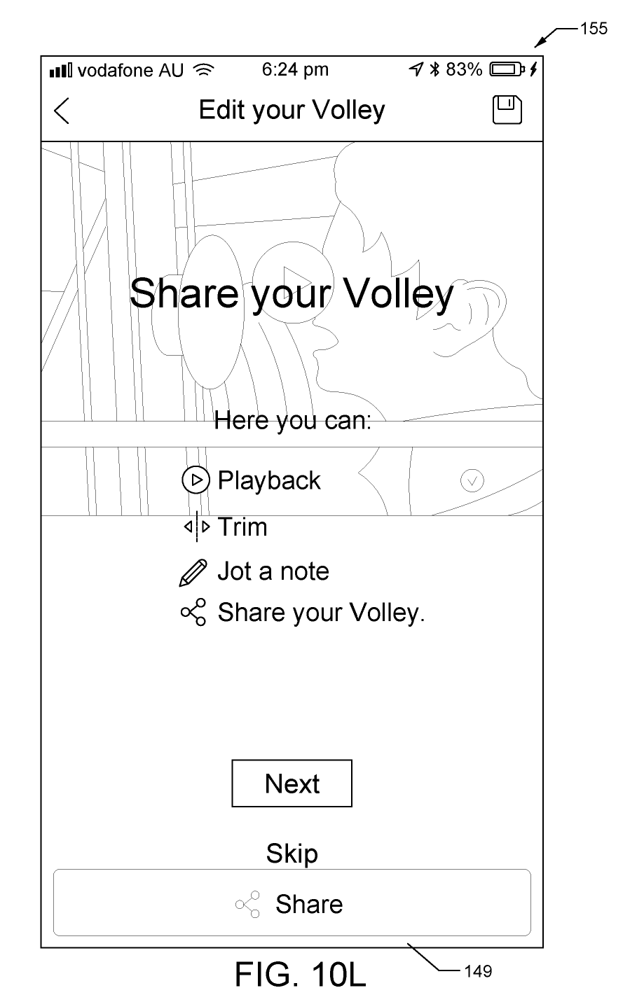

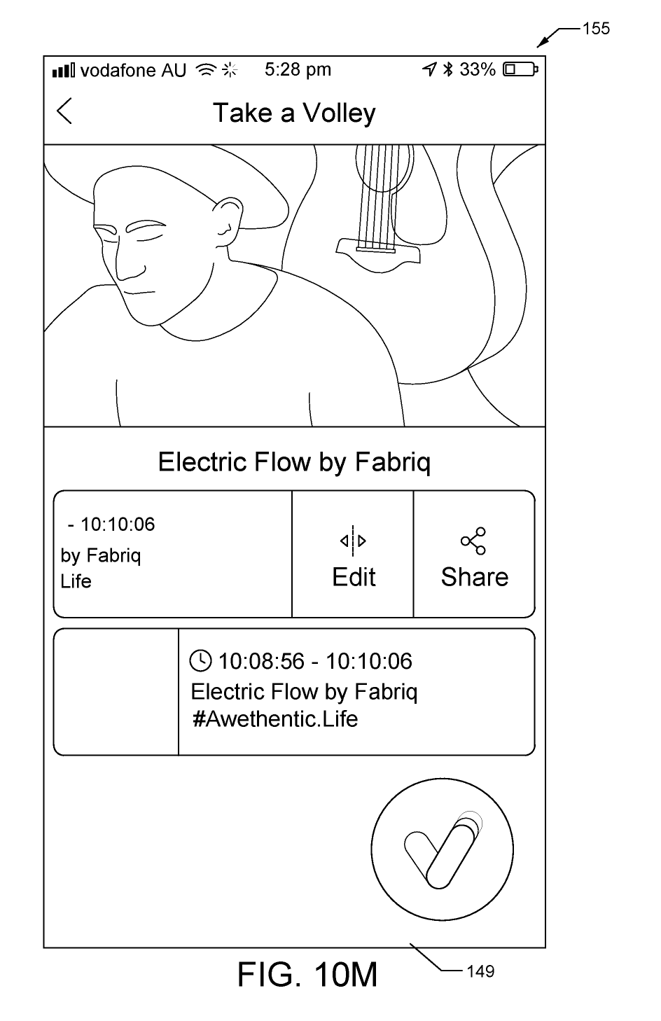

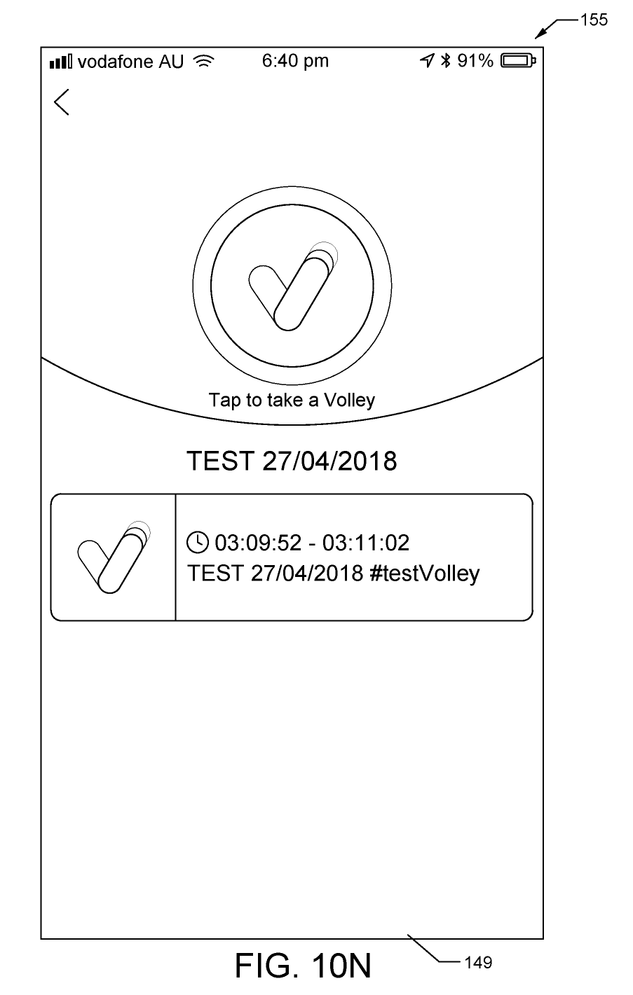

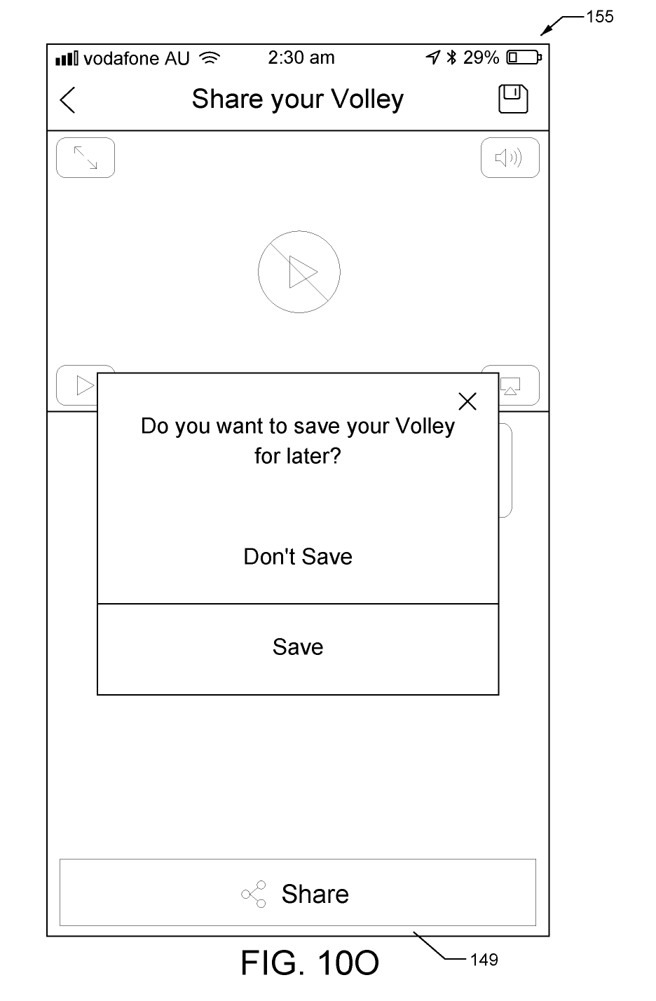

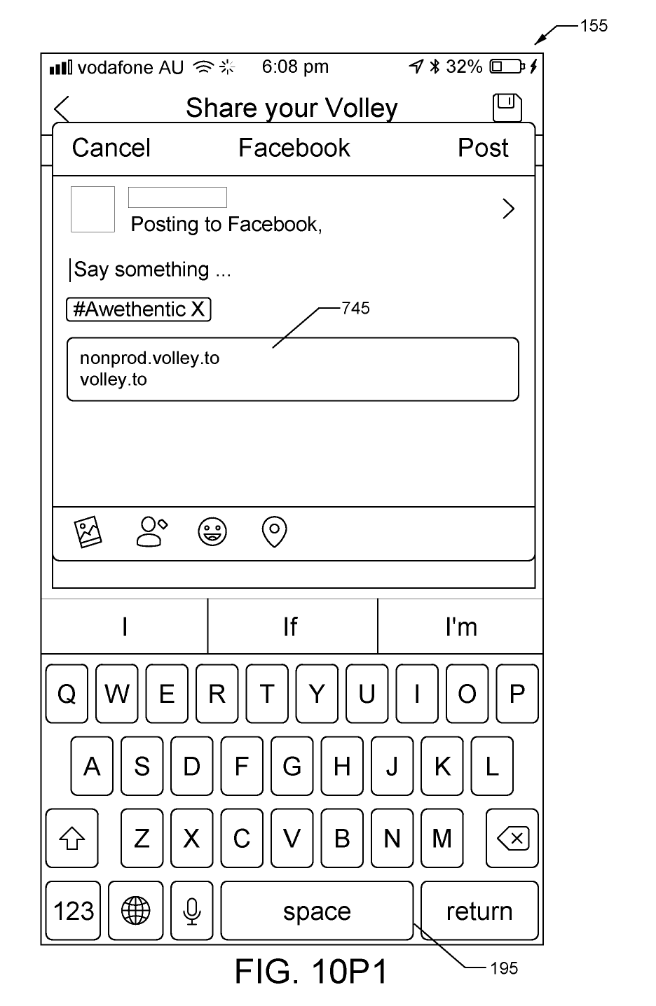

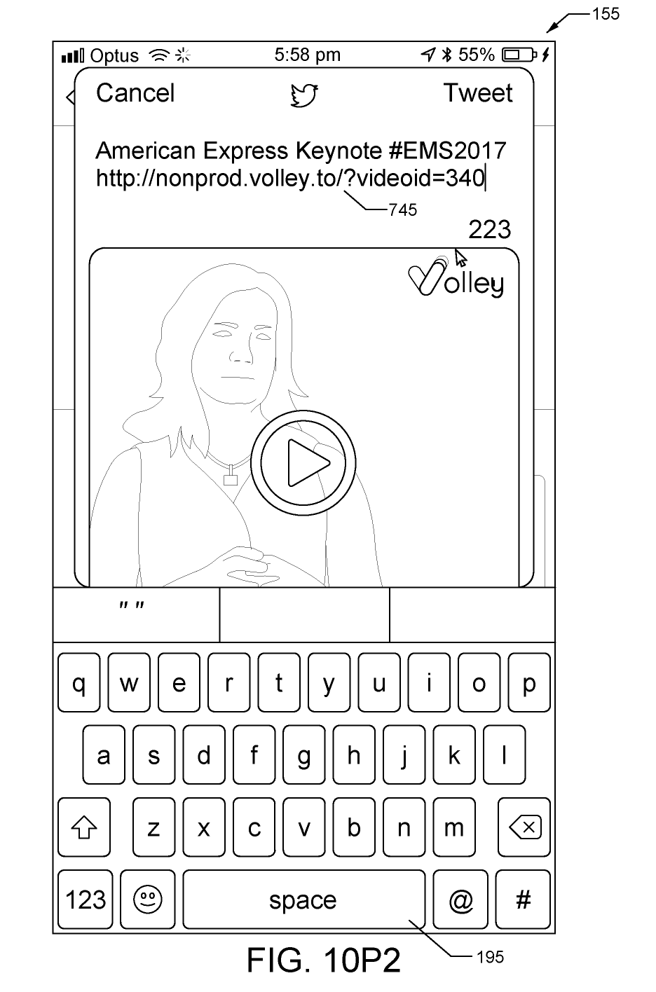

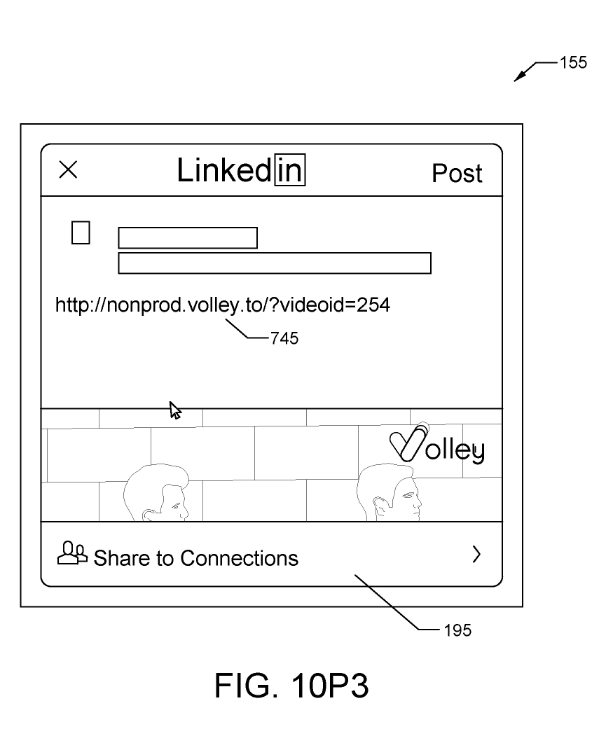

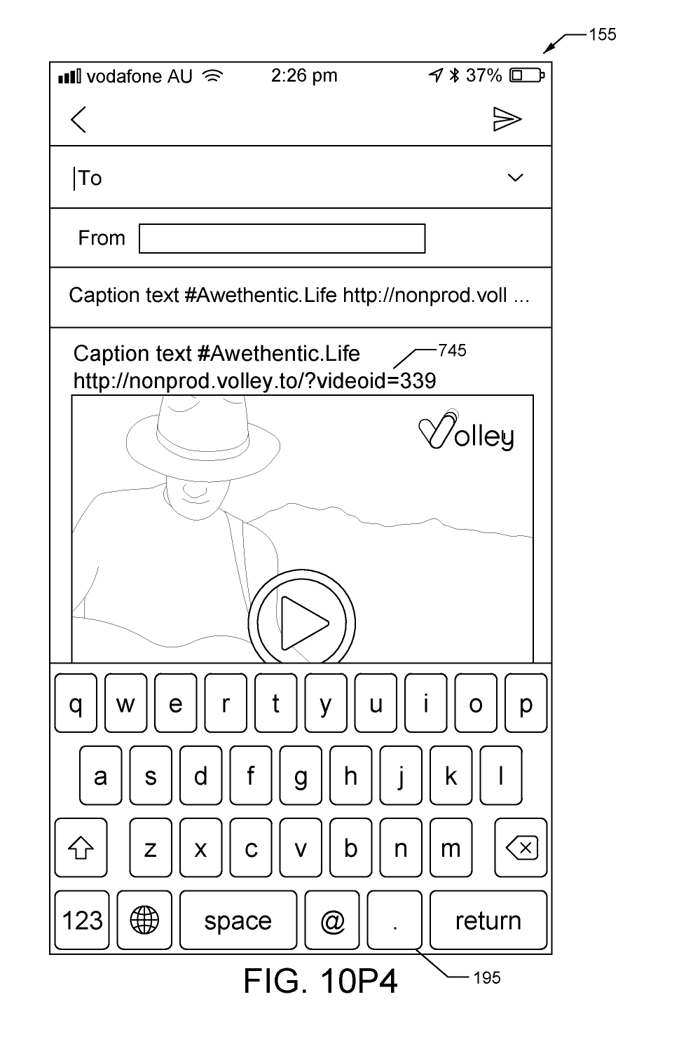

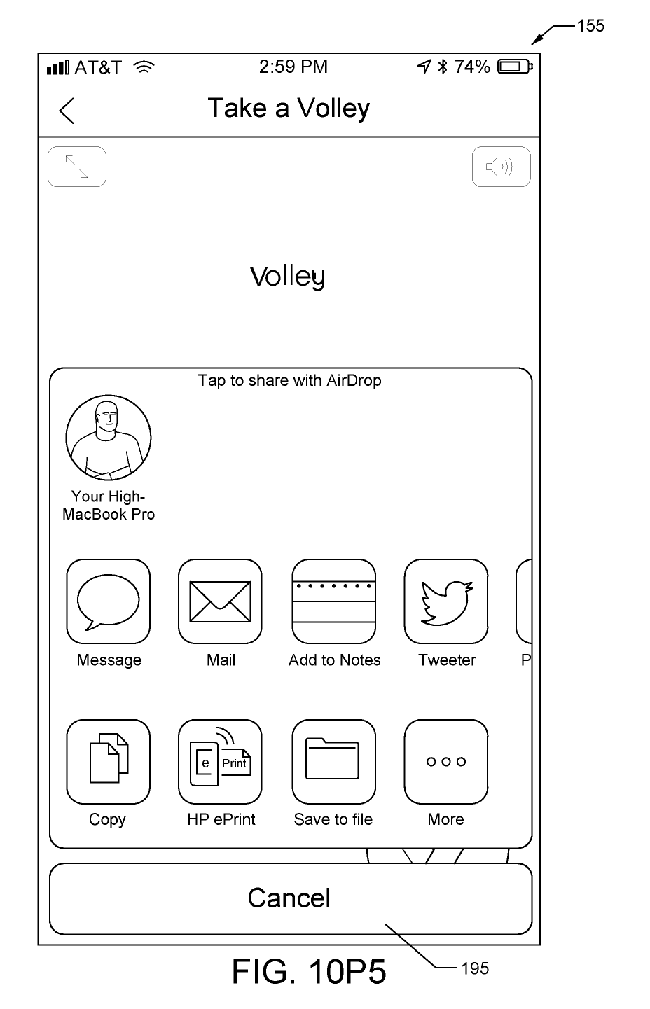

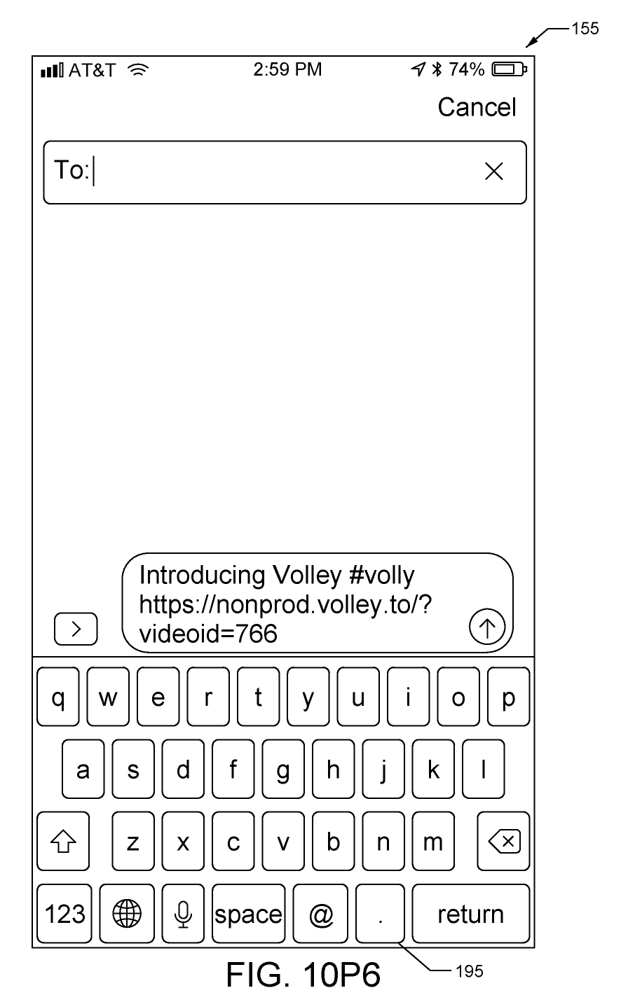

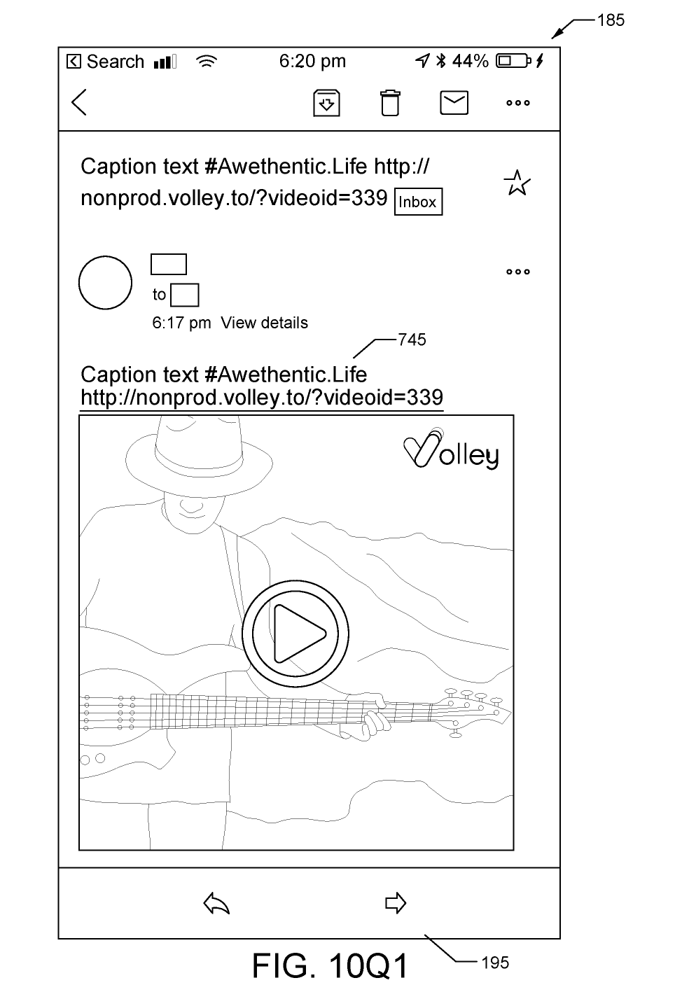

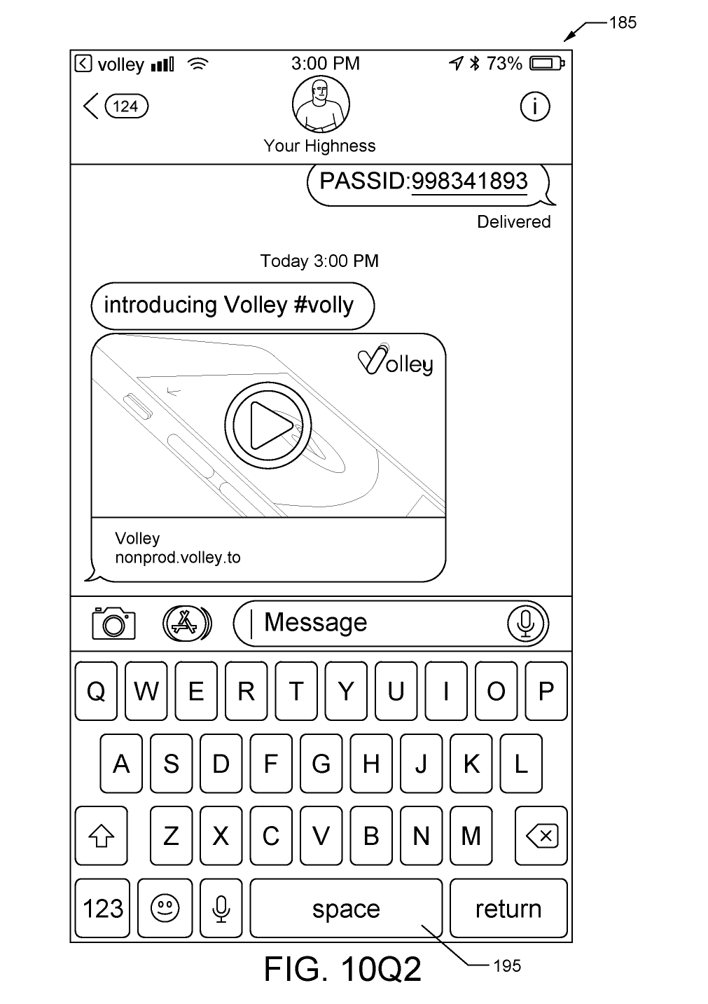

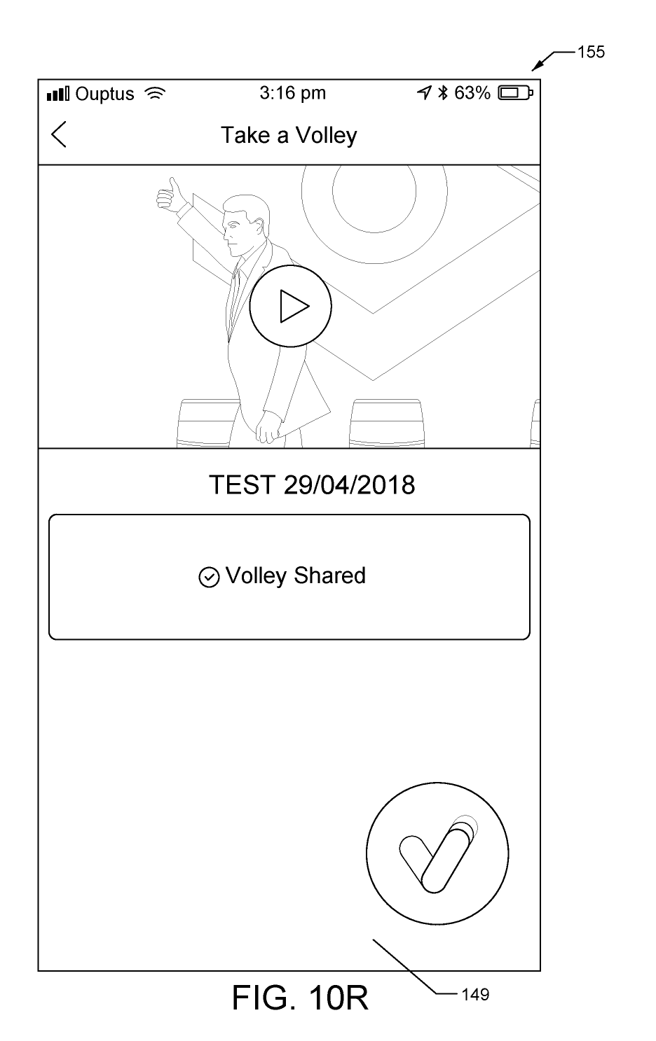

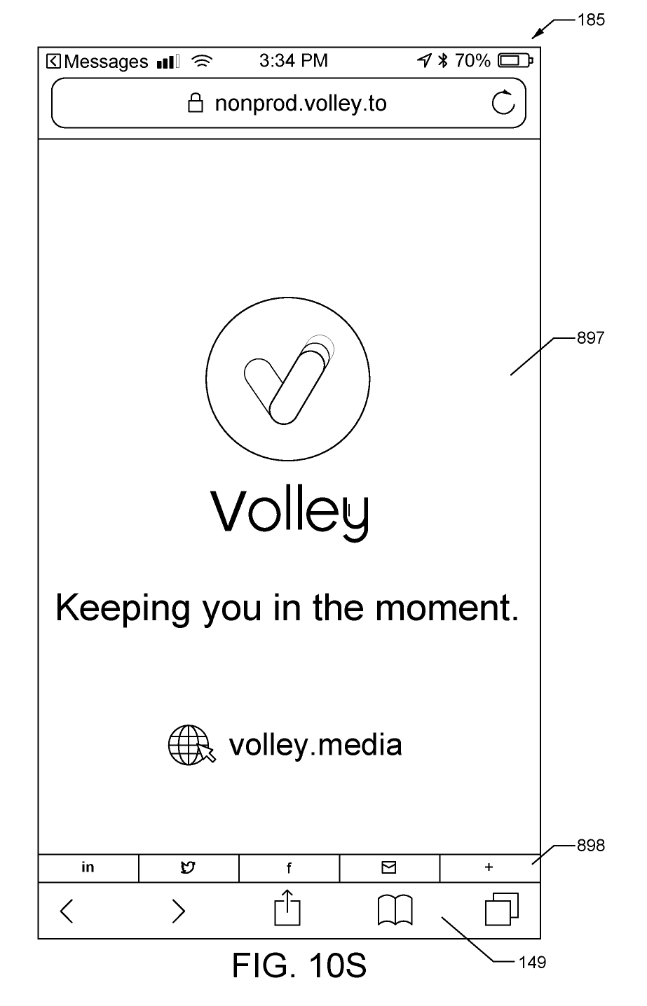

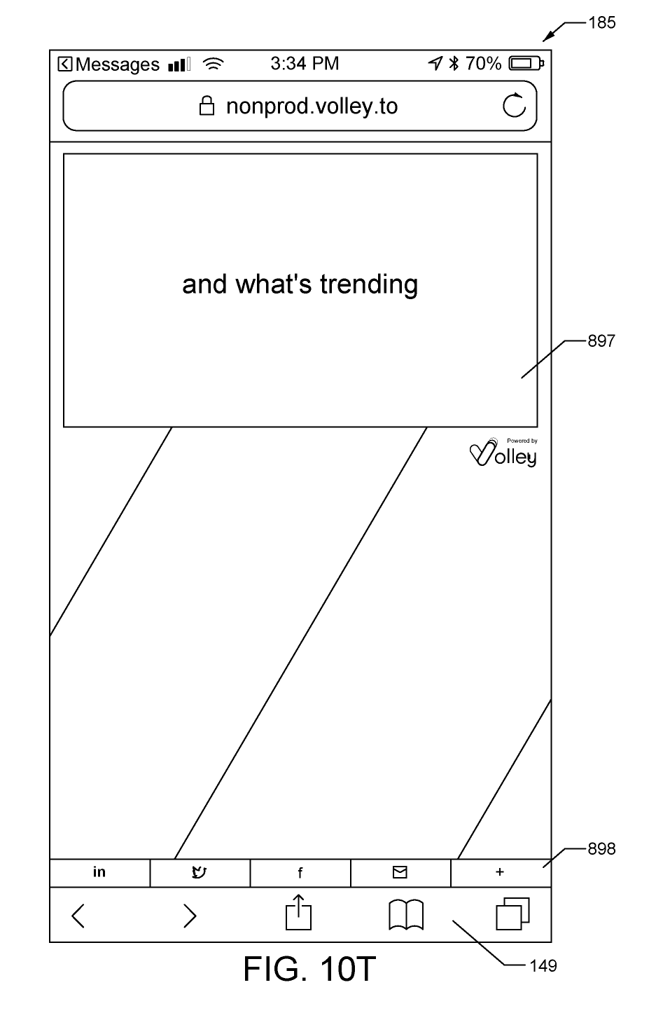

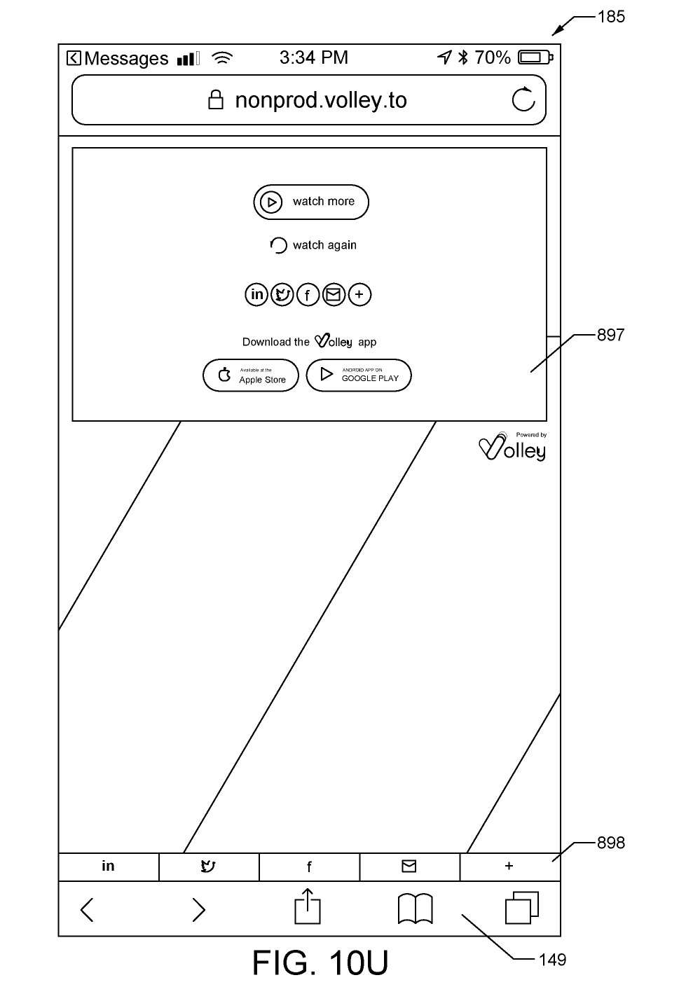

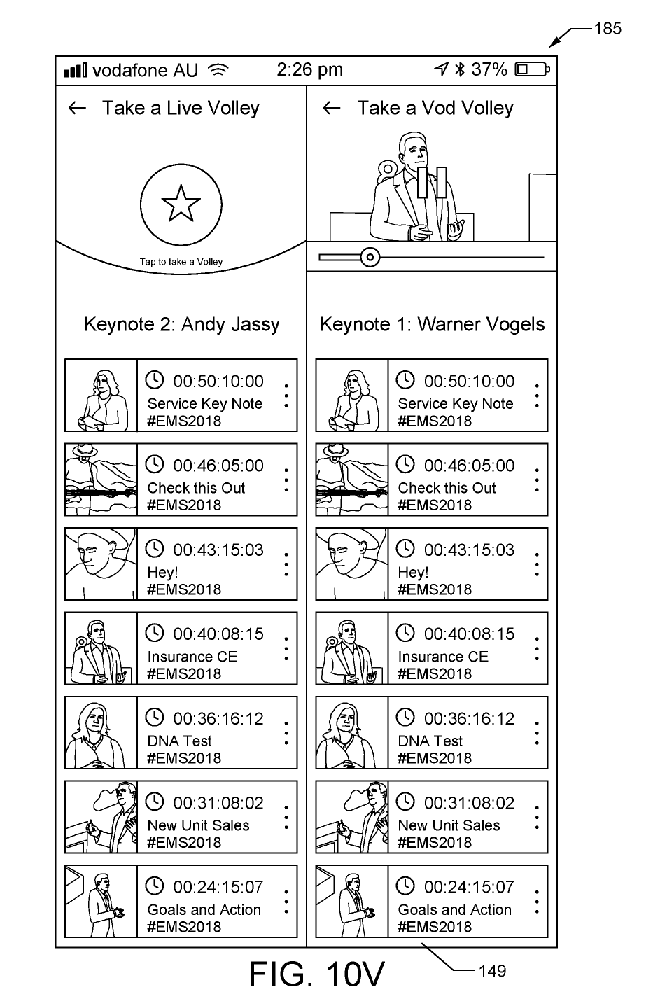

The app 149 can also be configured to allow a user 150 to select multiple portions of timestamped live stream media content (whether from the same stream of timestamped live stream media content or multiple streams of different timestamped live stream media content) and splice those multiple portions into a single stream of selected timestamped live stream media content. The app 149 can also receive a unique uniform resource identifier (URI) from the back-end system 145, where the URI, when selected by the user 150 or a recipient 180, opens a page (e.g., in the app 149, on a browser) that includes the timestamped live stream media content selected by the user 150. Examples of screen shots of the app 149 are shown below with respect to FIGS. 10A-10V.

The app 149 can be configured to identify a specific user 150 and/or a specific recipient 180. The app 149 can make such an identification in one or more of a number of ways. For example, the app 149 can require a user name and password in order for a user 150 and/or a recipient 180 to open the app 149. As another example, the app 149 can be linked with and/or embedded in one or more social media apps (e.g., Facebook, LinkedIn, Twitter) and identify a user 150 and/or a recipient 180 based on the login credentials used to access those social media apps. As yet another example, the app 149 can identify a user 150 and/or a recipient 180 by identifying the user system 155 and/or the recipient system 185 and correlating the user 150/recipient 180 to that system.

In certain example embodiments, the content provider 170 provides media content (e.g., a television show, a movie), hosts a live event (e.g., a concert, a seminar, a conference), or otherwise provides some form of media. This source media content (also called “live media content” or simply “media content” herein) is immediately encoded by the encoder 172 of the content provider system 175. The encoder 172 currently exists in the art and generates a high bit rate stream (called a contribution feed herein) that is sent to the cloud service provider 190. The encoder 172 can put the contribution feed into one or more of any of a number of formats.

The encoder 172 sends the contribution feed, often in real time (i.e., immediately after creating the contribution feed), using one more of a number of communication protocols. For example, the encoder 172 can process and send the contribution feed at regular intervals (e.g., every 10 seconds) on a continuous basis through the duration of the media content. Such protocols can include, but are not limited to, RTMP, UDP, and RTP. In certain example embodiments, such communication protocols have low latency.

One or more encoders 192 of a cloud service provider 190 receive the contribution feed from the encoder 172 of the content provider 170. Upon receiving the contribution feed, which occurs in substantially real time relative to when the encoder 172 creates the content feed, the encoder 192 creates one or more elements of streaming content by varying the resolution, bitrate, and/or other characteristics of the contribution feed. This processing by the encoder 192 allows various devices (e.g., phones, tablets, desktop computers, laptop computers, smart televisions) to receive and present the streaming content to a user for viewing. In some cases, the encoder 192 of the cloud service provider 190 can also create one or more thumbnails for each item or iteration of the streaming content.

Once the encoder 192 of the cloud service provider 190 creates the streaming content, the encoder 192 sends the streaming content to the origin server 197 of the cloud service provider 190. This transfer of the streaming content from the encoder 192 to the origin server 197 can occur in substantially real time (e.g., immediately after the encoder 192 creates the streaming content from contribution feed). For example, the encoder 192 can process and send the streaming content at regular intervals (e.g., every 6 seconds) on a continuous basis through the duration of the media content.

The origin server 197, upon receiving the streaming content from the encoder 192, processes the streaming content to generate the timestamped live stream media content. Specifically, the origin server 197 packages the streaming content into live stream media content in one or more codecs (e.g., HLS, DASH). In certain example embodiments, the origin server 197 inserts one or more timestamps (e.g., UTC, GMT) onto each item of live stream media content, resulting in timestamped live stream media content. As explained below, timestamping performed by the origin server 197 and used for example embodiments described herein is a new technological advancement that is different from traditional time coding, which is performed by encoders (e.g., encoder 192, encoder 172). Once the origin server 197 creates the timestamped live stream media content, the origin server 197 pushes the timestamped live stream media content (in some cases, immediately after the timestamped live stream media content is created) to the controller 144 of the back-end system 145. For example, the origin server 197 can process and send the timestamped live stream media content at regular intervals (e.g., every 5 seconds) on a continuous basis through the duration of the media content, embedding a timestamp into each interval.

The process of converting live media content to contribution feed using the encoder 172, of converting the contribution feed to streaming content using the encoder 192, and of converting the streaming content to the timestamped live stream media content using the origin server 197 can be done in real time and either continuously or substantially continuously (e.g., segments of media content (or encoded/timestamped variations thereof) are processed every 5 seconds). Similarly, the transfer of the timestamped live stream media content from the origin server 197 to the back-end system 145 can be done in real time and either continuously or substantially continuously. For purposes herein, the terms continuously and substantially continuously shall have the same meaning.

Since the live content from the content provider 170 is continually streaming for a period of time, the origin server 197 of the cloud service provider 190 continually and in real time processes the live streaming content from the encoder 192 of the cloud service provider 190 to generate timestamped live stream media content. As discussed below, the capabilities of the origin server 197 working in conjunction with the encoder 192 of the cloud service provider 190 have only been developed in the last year or so. Without this technology, sharing timestamped live stream media content in real time in the manner described herein was not technically possible. As a result, the inventive concepts described herein were developed shortly thereafter to enable a user 150 to customize and share timestamped live stream media content with one or more specifically-identified recipients 180 in real time.

In the event that the server 177 of the content provider 170 includes the encoders 192 of the cloud service providers 190, then the origin server 197 of the cloud service provider 190 can be configured for integration with the remote encoding infrastructure of the encoder 172/encoder 192 combination. In such a case, the encoder 172/encoder 192 combination can serve as a master content encoder, eliminating one step in the process to generate the timestamped live stream media content. In any case, the back-end system 145 does not need to store any timestamped live stream media content. Instead, the back-end system 145 (or, more commonly, the CDN 148) can store, for example, still thumbnails as a reference of the timestamped live stream media content. In this way, if a content provider 170 has concerns about sharing copyrighted material with third parties (e.g., the live media sharing system 140), the content provider 170 can eliminate these concerns by retaining control of their streaming media content. Further, this arrangement leverages the storage capability of the cloud service provider 190 relative to the storage capability of the back-end system 145 and the CDN 148.

The controller 144 of the back-end service 145 includes one or more components that allow the controller 144 to control the operation and communications of the back-end service 145. For example, as discussed above, in this case, the controller 144 of the back-end service 145 includes the control engine 125, the communication module 129, the URI generator 123, the database module 131, the analytics module 135, the page generator 136 (which includes the closed-captioning module 137), the timer 127, the power module 121, the storage repository 130, the hardware processor 120, the memory 122, the transceiver 124, the application interface 126, and, optionally, the security module 128. The storage repository 130 in this case includes protocols 132, algorithms 133, and stored data 134.

The storage repository 130 of the controller 144 can be a persistent storage device (or set of devices) that stores software and data used to allow the controller 144 to operate the back-end service 145 and assist the controller 104 in communicating with the user system 155, the recipient system 185, one or more cloud service providers 190, and one or more content provider systems 175 within the system 100. In one or more example embodiments, the storage repository 130 stores one or more protocols 132, one or more algorithms, and stored data 134. The protocols 132 can be any procedures (e.g., a series of method steps) and/or other similar operational procedures that the control engine 125 of the controller 144 follows based on certain conditions at a point in time.

The protocols 132 can also include any of a number of communication protocols that are used to send and/or receive data between the controller 144 and the user system 155, the one or more recipient systems 185, the one or more content provider systems 175, and one or more of the cloud service providers 190. One or more of the protocols 132 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the communication protocols 132 can provide a layer of security to the data transferred within the system 100.

The algorithms 133 can be any formulas, mathematical models, and/or other similar operational tools that the control engine 125 of the controller 144 uses. An example of an algorithm 133 is a model that tracks and analyzes how many times selected live stream content of a particular live event have been created, forwarded, and viewed. As another example, an algorithm 133 can be a model that tracks and analyzes how many times selected live stream content is generated by a particular user 150. As yet another example, an algorithm 133 can be a model that determines how a unique URI is generated for a particular selection of timestamped live stream media content. An algorithm 133 can be fixed or modified (e.g., by a user 150, by the control engine 125) over time. Modification of an algorithm 133 can be based on one or more of a number of factors, including but not limited to comments from a user 150 or a content provider 170 (e.g., a live event coordinator), an instruction from a user 150, and correction based on actual data.

The stored data 134 can be any data associated with any component or aspect of the system 100. Such stored data 134 can include, but is not limited to, a URI associated with a particular selection of live stream content, default settings, user preferences, settings from the administrative console 150, an identification of a user 150, an identification of a particular live stream content, and the communication capability of another system. Stored data 134 can also include a table or database that stores and organizes all relevant information associated with a selection of timestamped live stream media content, including but not limited to identification of a user 150, identification of the selected timestamped live stream media content, a current start time, a current end time, a current duration, associated advertising, and associated sponsorship.

Examples of a storage repository 130 can include, but are not limited to, a database (or a number of databases), a file system, a hard drive, flash memory, some other form of solid state data storage, a cloud-based server, or any suitable combination thereof. The storage repository 130 can be located on multiple physical machines, each storing all or a portion of the protocols 132, the algorithms 133, and/or the stored data 134 according to some example embodiments. Each storage unit or device can be physically located in the same or in a different geographic location.

The storage repository 130 can be operatively connected to the control engine 125. In one or more example embodiments, the control engine 125 includes functionality to communicate with the user system 155, one or more recipient systems 185, one or more content provider systems 175, one or more cloud service providers 190, and the administrative console 160 in the system 100. More specifically, the control engine 125 sends information to and/or receives information from the storage repository 130 in order to communicate with the user system 155, one or more recipient systems 185, one or more content provider systems 175, one or more cloud service providers 190, and the administrative console 160. As discussed below, the storage repository 130 can also be operatively connected to the communication module 129 in certain example embodiments.

In certain example embodiments, the control engine 125 of the controller 144 controls the operation of one or more components (e.g., the communication module 129, the timer 127, the transceiver 124) of the controller 144. For example, the control engine 125 can put the communication module 129 in “sleep” mode when there are no communications between the controller 144 and another component (e.g., a cloud service provider 190, the user system 155) in the system 100 or when communications between the controller 144 and another component in the system 100 follow a regular pattern. In such a case, power consumed by the controller 144 is conserved by only enabling the communication module 129 when the communication module 129 is needed.

As another example, the control engine 125 can direct the timer 127 as to when to provide a current time, to begin tracking a time period, and/or perform another function within the capability of the timer 127. As yet another example, the control engine 125 can direct the transceiver 124 to send data to and/or receive data from one or more cloud service providers 190 in the system 100.

The control engine 125 of the controller 144 can also control, at least in part, other components of the live media sharing system 140, including but not limited to the app 149 and the CDN 148. For example, the control engine 125 of the controller 144 can direct some or all of the operations (e.g., which requests sent by the user 150 on the app 149 go through the CDN 148 as opposed to being sent directly to the controller 144) of the CDN 148.

The control engine 125 of the controller 144 performs many of the functions required of the controller 144 to operate the back-end system 145 of the live media sharing system 140. For example, the control engine 125 can receive live stream content from the origin server 197 of the cloud service provider 190. In some cases, the origin server 197 is controlled by the controller 194 of the cloud service provider 190, where the controller 194 can include one or more of the components of the controller 144 shown in FIG. 1B. Alternatively, the controller 144 can control the origin server 197. As yet another alternative, the controller 144 can control some aspects of the origin server 197, while other aspects of the origin server 197 can be controlled by the controller 194.

As yet another example, the origin server 197 can send the timestamped live stream media content directly to the CDN 148, which is in communication with and is controlled by the controller 144 of the back-end system 145. In such a case, the CDN 148 stores the timestamped live stream media content, and the controller 144 communicates with the CDN 148 to determine what timestamped live stream media content is available on the CDN 148.

In any case, as discussed above, the timestamped live stream media content received by the control engine 125 and/or the CDN 148 from the origin server 197 is programmed (e.g., packaged, encoded, formatted) in real time based on live media content that is processed into contribution feed and sent in real time by an encoder 172 of a content provider system 175 to an encoder 192 of a cloud service provider 190, which in real time encodes the contribution feed into streaming content, which is sent in real time to the origin server 197. Due to the novel technologies used in the origin server 197 and the encoder 192 of the cloud service provider 190, the delay from when a live event is captured by the content provider 170 to when the control engine 125 receives the timestamped live stream media content generated by the origin server 197 is minimal (e.g., four seconds), making the transfer of timestamped live stream media content using example embodiments in substantially real time.

The timestamped live stream media content received by the control engine 125 can be based on live media content that is automatically and in real time processed and pushed from the content provider system 175 to the encoder 192 of the cloud service provider 190. In addition, or in the alternative, the control engine 125 can send a request, indirectly through the cloud service provider 190 or the administrative console 160, or directly to the content provider system 175, for specific live media content, which undergoes the same processing by the encoder 172, the encoder 192, and the origin server 197 to generate timestamped live stream media content.

In this latter case, such a request can be based on one or more of a number of factors, including but not limited to in response to a request (e.g., using keywords) made by the user 150 through the app 149 on the user system 155, in response to a selection by the user 150 on the app 149 from a list of trending topics listed on the app 149, the geographic location of the user system 155 used to access the app 149, based on timestamped live stream media content viewed by the user 150 in the app 149, based on historical timestamped live stream media content selected by the user 150 in the app 149, based on a content provider selected by the user 150 in the app 149, and based on the user system 155 and the timestamped live stream media content that is formatted for optimal viewing performance on that user system 155.

In certain example embodiments, the control engine 125 of the controller 144 receives (either directly or through the CDN 148) a communication from the app 149 on the user system 155 that the user 150 has opened the app 149. In response, the control engine 125 can send a list to the CDN 148, which then can add thumbnails and provide the list and associated thumbnails of various timestamped live stream media content to the app 149 that the control engine 125 has received, through the origin server 197, from the various content provider systems 175. In other cases, the list and associated thumbnails are automatically pushed by the controller 144 through the CDN 148 to the app 149 on the user system 155. In any case, the user 150 can use the app 149 to preview and select timestamped live stream media content for sharing.

The control engine 125 of the controller 144 can also receive (either directly or through the CDN 148) a selection of timestamped live stream media content from the app 149 on the user system 155 that the user 150 would like to share. Such a selection of timestamped live stream media content can include various information, including but not limited to an ID of the user 150, the particular timestamped live stream media content selected, the start time, the end time, the duration, and any comments from the user 150. When the control engine 125 receives this information associated with the selected timestamped live stream media content from the app 149 on the user system 155, the control engine 125 sends this information to the database module 131.

In certain example embodiments, the database module 131 builds a table or database for each item of selected media content. The table or database is populated with all of the information that is received by the control engine 125 (either directly or through the CDN 148) from the app 149 on the user system 155 and that is associated with the selected timestamped live stream media content. In addition, the database module 131 populates the table or database with other information associated with the selected timestamped live stream media content. Examples of such other information can include, but is not limited to, advertisements, sponsorship, pre-roll trailers, post-roll trailers, changes in user-defined default values, and applicable settings received by the control engine 125 from the administrative console 160.

Any identification numbers (e.g., for the user 150, for a content provider 170, for an event, for selected timestamped live stream media content) that are used in association with selected timestamped live stream media content can be generated by the control engine 125 or the database module 131 using one or more algorithms 133 and/or protocols 132 in the storage repository 130. The table or database populated and maintained by the database module 131 is part of the stored data 134 in the storage repository in certain example embodiments.

The database module 131 can also update a table or database for an existing selection of timestamped live stream media content. For example, a new or added sponsor of an event associated with the selected timestamped live stream media content can be updated or added to the table or database by the database module 131. As another example, if an advertisement associated with the selected timestamped live stream media content is changed, the database module 131 can update the table or database accordingly. As yet another example, if the user 150, through the app 149, alters the start and/or end time of the existing selection of timestamped live stream media content, the database module 131 updates the table or database accordingly.

An example of part of a table or database for selected timestamped live stream media content is shown in the following table:

| | | | | Timestamped | | | | | |
|---|---|---|---|---|---|---|---|---|---|
| | | | | live | | | | | |
| | | | Live | stream | | | | | |
| | Content | Live | Event | media | | Time | | | |
| User | Provider | Event | Session | content | Start | of | End | Sponsor | Advertiser |
| ID | ID | ID | No. | ID | Time | Pin | Time | Content | Content |
| 23J8742M | 142SC | AQUPTS389 | 23 | 98345J | 2:35 | 3:05 | 3:35 | link to | link to |
| | | | | | | | | SNR20874551UXWA | ADV58141358OISCLT |

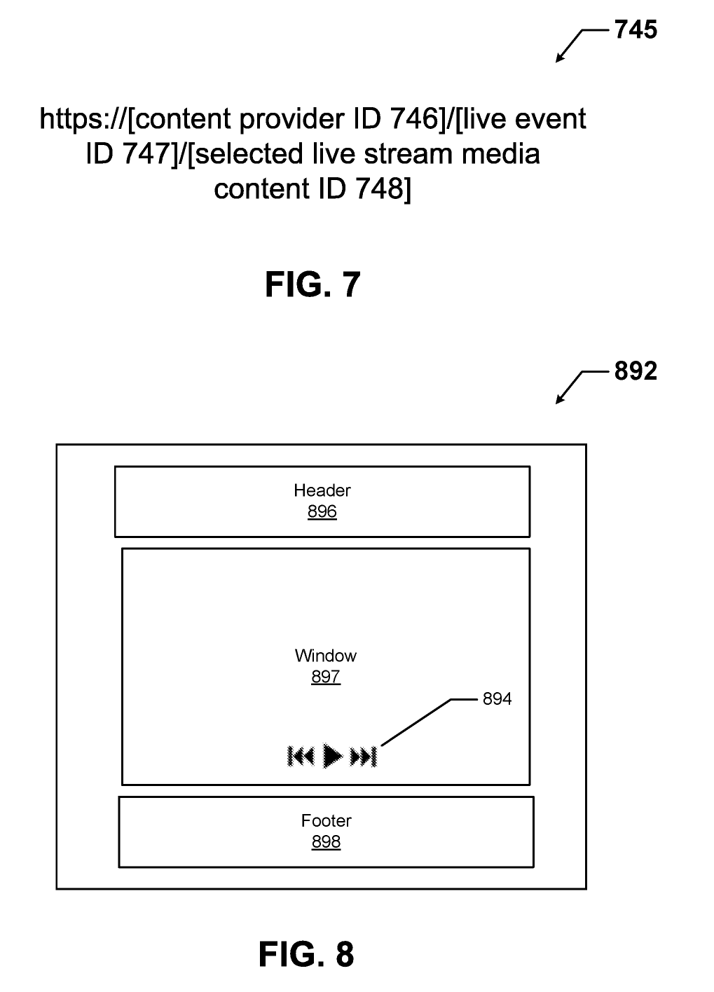

The control engine 125 of the controller 144 of the back-end system 145 can also instruct the URI generator 123 to generate a URI for selected timestamped live stream media content. This instruction from the control engine 125 to the URI generator 123 can occur at any time, such as when the database module 131 generates a table or database for selected timestamped live stream media content. In certain example embodiments, the URI generator 123 follows one or more protocols 132 stored in the storage repository 130 to generate a URI. For example, the URI generator 123 can generate a URI for selected timestamped live stream media content using an ID of the content provider 170, an ID of the live event, and an ID of the selected timestamped live stream media content. The information used to generate the URI by the URI generator 123 can be looked up in the table or database associated with the selected timestamped live stream media content. When the URI generator 123 generates a URI, the URI can be stored in the table or database associated with the selected timestamped live stream media content by the database module 131. An example of a URI is shown below with respect to FIG. 7.

When a URI for selected timestamped live stream media content has been generated by the URI generator 123, the control engine 125 can send the URI (either directly or through the CDN 148) to the app 149 on the user system 155. The amount of time that passes between when the control engine 125 receives the selection of timestamped live stream media content and its associated information from the app 149 on the user system 155 and when the control engine 125 sends the URI associated with the selected timestamped live stream media content is negligible (e.g., less than one second), and so the URI is sent by the control engine 125 (either directly or through the CDN 148) to the app 149 on the user system 155 in real time.

When a URI is selected by a recipient 180 on a recipient system 185 (e.g., on a digital communication platform 195 (e.g., on Facebook, in an email, in a text message, on Twitter), in the app 149), the control engine 125 of the controller 144 of the back-end system 145 is notified of the selection of the specific URI. Upon receiving this notification, the control engine 125 notifies the page generator 136 of the controller 144 of the selected URI. In certain example embodiments, the page generator 136 generates a page that is presented to the recipient 180 on the recipient system 185. In some cases, the page can be presented to the recipient 180 on the app 149 which is loaded on the recipient system 185. Alternatively, the page can be presented to the recipient on a browser loaded on the recipient system 185.

In order to generate the page, the page generator 136, either directly or through the control engine 125, requests the information in the table or database associated with the selected URI from the database module 131. Specifically, the database module 131 receives the selected URI and is able to deconstruct, at least in part, the contents of the URI and use this deconstructed information to retrieve the information from the associated table or database. In alternative embodiments, if the URI is stored in the table or database, no deconstruction of the URI is needed. In any event, when the database module 131 has retrieved all of the information in the table or database associated with the selected URI, this information is sent, either directly or through the control engine 125, to the page generator 136.

The information requested by the page generator 136 can be specific (e.g., only the selected timestamped live stream media content, the start time, the end time, any sponsor information). Alternatively, the page generator 136 can request and receive all information associated with the URI. In this latter case, the page generator 136 can determine which, if any, of that information to discard and which information to use in generating a page (also called a viewing page herein).

Certain information (e.g., start time, end time) associated with the timestamped live stream media content can be directly correlated to the timestamping of the timestamped live stream media content performed by the origin server 197. In this way, when the CDN 148 or the back-end server 145 retrieves the portion of the timestamped live stream media content that corresponds to the selection made by the user 150, the origin server 197 can provide the precise segment of the specific timestamped live stream media content because of the timestamping and packaging previously performed by the origin server 197 to generate the timestamped live stream media content.

When this information associated with the selected URI is received by the page generator 136, the page generator 136 can generate a page using one or more algorithms 133 and/or protocols 132 in the storage repository 130. These algorithms 133 and/or protocols 132 can vary based on one or more of a number of factors, including but not limited to the ID of the user 150, the ID of the content provider 170, the length of the selected timestamped live stream media content, the functionality of the recipient system 185, and the type of live event (e.g., sports, presentation). The page generator 136 generates a page based on the appropriate algorithms 133 and/or protocols 132 using the information provided by the database module 131. An example of a page is shown below with respect to FIG. 8.

For example, the page can include one or more ancillary features (e.g., a header and/or a footer, which can be populated with, for example, links to digital communication platforms 195, advertising content, sponsor information, user comments, navigation tools, viewing tools, sharing options, a link to provide feedback on the selected timestamped live stream media content, and a link to download the app 149. In addition, or in the alternative, the page generator 136 can integrate media trailers (e.g., advertisements, an introduction, credits) before the beginning of (for pre-roll trailers) and/or after the end of (for post-roll trailers) the selected timestamped live stream media content. In certain example embodiments, after the selected timestamped live stream media content has finished, the page generator 136 can offer a link (e.g., a pushbutton on the page) that, when selected by a recipient 180, allows the recipient 180 to transfer to the content provider system 175 to watch the event live (without sharing function).

While headers and footers can occupy physical spaces on the page, pre-roll and/or post-roll material can additionally or alternatively be considered a header and footer, respectively. For example, sponsorship information can part of pre-roll (a type of header, such as a trailer at the beginning of the selected timestamped live stream media content) and post-roll (a type of footer, such as a trailer at the end of the selected timestamped live stream media content) material. The pre-roll and post-roll material can be static and/or dynamic. Sponsorship information can also include dynamic “watch more” links, custom logos, backgrounds for pages within the white label website, and custom sponsorship text. Sponsorships are generally tied to the theme of a specific event, and differ from standard advertising placements. Sponsorship information, like other types of information (e.g., advertising information) can be updated at any time by communicating such updates to the database module 131. When the database module 131 makes a change to a table or database, the data module 131 informs the page generator 136 of the change, at which point the page generator 136 can update any pages affected by the changes.

Sponsorships can also be time-managed, meaning that different points in time in the content could support different sponsors. For example, minutes 0 through 30 of a program could be sponsored by sponsor #1, minutes 31-60 by sponsor #2, and so on. All aspects of that sponsorship can be managed dynamically within the administrative console 160, in conjunction with the database module 131 and the page generator 136. A sponsor or content provider 170 can choose to set up such time-managed placements prior to, during, or after a live event.

The following are non-exclusive examples of sponsor information that can be dynamically changed: A sponsor can upload a logo file in electronic format that will populate a predetermined area within a page design template; a sponsor can upload a full page background graphic to be displayed behind the video player window for both mobile and desktop users viewing shared timestamped live stream media content; a sponsor can enter text into a text field that will populate a pre-determined area within a page to display a headline or featured text; a sponsor can upload a custom “header” or “pre-roll” static image to be displayed prior to shared timestamped live stream media content playing for the recipient 180; a sponsor can upload a custom “header” or “pre-roll” video clip to be played prior to shared timestamped live stream media content playing for the recipient 180; and a sponsor can enter a custom URI to direct a recipient 180 to an archive version of the overall media stream, or to view the live feed at the current live point in time on the content provider system 175.

Advertisers and other entities (e.g., event coordinators) involved in the live event can similarly provide information to the back-end system 145 that is saved to a table or database by the database module 131 and used in the presentation of a page by the page generator 136. For example, advertisements can be dynamically inserted using modern ad serving technologies which target-specific user data points. Utilizing SSAI (Server Side Ad Insertion), advertising can be served based on personal interest, demographics data, geographical location, and/or any other standard ad serving profiling that follows industry standard protocols.

The page generator 136 can also include one or more additional features in certain example embodiments. For example, the page generator 136 can include a closed-captioning module 137 that converts any audio in the selected timestamped live stream media content into visual text that appears on part of the page. The closed-captioning module 137 can in some cases be controlled by the recipient 180 using the app 149. Such a feature can be useful, for example, when the recipient is deaf or hard of hearing, when the ambient noise where the recipient system 185 is located is too loud, or if the recipient 180 wants to view the selected timestamped live stream media content in silence and does not have earphones to use. As another example, the page generator 136 can generate hashtags for trending media topics that are associated with the timestamped live stream media content.

The closed-captioning module 137 can used for timestamped live stream media content that is either live (real time) or on-demand (pre-recorded). For on-demand content, there may not be closed captions on the live version of that content (unless, for example, the closed captioning is provided by the content provider 170 through the content provider system 175), but the closed-captioning module 137 can add closed captioning when the on-demand version of the content is processed for viewing (e.g., on a page by a recipient 180, by a user 150 when creating the selected timestamped live stream media content).

For live content, the closed-captioning module 137 can be used to create the closed captioning. Alternatively, a third party service can be used to create closed captioning via a stenographer or similar service. For such an arrangement to work, the timestamped live stream media content can be sent to the third party, who then returns the timestamped live stream media content along with an embedded caption track. This third party service could be operatively connected between the content provider system 175 and the cloud service provider 190, as an example.

When the page has been generated by the page generator 136, the page generator 136 notifies and provides the page to the control engine 125. Upon receiving the page, the control engine 125 sends the page to the recipient system 185. In some cases, as when the app 149 is optionally loaded on the recipient system 185, the page can be presented on the app 149. In other cases, as when the app 149 is not loaded on the recipient system 185, the page can be presented on a browser, in a separate pop-up window on the recipient system 185, in whatever digital communication platform 195 is being used by the recipient 180 on the recipient system 185, or any of a number of other ways to deliver the page to the recipient 180 on the recipient system 185.

The page can be sent by the control engine 125 through the CDN 148 before arriving on the recipient system 185. In such a case, the page can include instructions for the CDN 148 to retrieve the selected timestamped live stream media content and load that timestamped live stream media content into the page. To the extent that there is also pre-roll and/or post-roll content, the CDN 148 can add this content at the beginning and/or end of the selected timestamped live stream media content for the page.

In some cases, a recipient 180, after viewing the selected timestamped live stream media content on the page, can select new timestamped live stream media content, in which case the recipient is then treated by the control engine 125 as a user 150, and the exchange between the new user 150 and the control engine 125, with support from the database module 131, the URI generator 123, the page generator 136, and the rest of the back-end system 145 repeats itself.

Throughout this exchange between the content provider 170, the cloud service provider 190, the user 150, the recipient 180, and the live media sharing system 140, the analytics module 135 of the controller 144 is performing analytics on any or all aspects of the creation, sharing, and viewing of selected timestamped live stream media content. For example, the analytics module 135 can track and analyze information (also called analytics information) about shared timestamped live stream media content from the perspective of the content provider 170, an event, the user 150, one or more of the recipients 180, potential recipients 180, and/or any other relevant aspect of selected timestamped live stream media content.

The analytics module 135 can consider one or more of a number of parameters from the perspective of one or more entities involved in sharing live streaming media content in real time. Examples of such parameters can include, but are not limited to, the analytics module 135 can analyze the performance of referring networks (e.g., users 150), selected timestamped live stream media content (e.g., number of views), total sessions of a content provider 170, active sessions of a content provider 170, regional activity, time-based activity, average session length of a content provider 170, usage of the app 149 on a user system 155, viewing behavior (e.g., viewing rate, average viewing time) of a recipient 180 using the app 149, average time to forward particular selected timestamped live stream media content, the rate at which a recipient 180 forwards timestamped live stream media content, total number of times that particular timestamped live stream media content is shared, ranking of most shared timestamped live stream media content, top sharing networks, and demographic information (e.g., age, gender) of recipients 180 and/or users 150 for timestamped live stream media content related to a particular event.

The analytics module 135 can also provide analytics for any of a number of parameters with respect to the live media sharing system 140. Examples of such parameters can include, but are not limited to, the total number of selected timestamped live stream media content (e.g., overall, for a particular event), most popular events in terms of shared timestamped live stream media content, most popular sessions overall in terms of shared timestamped live stream media content, most popular sessions at a particular event in terms of shared timestamped live stream media content, most popular moments at an event in terms of shared timestamped live stream media content.

The analytics module 135 can also provide analytics for any of a number of parameters with respect to the app 149, either overall or for a particular user 150 or recipient 180. Examples of such parameters can include, but are not limited to, average session length, average sessions per day, usage of the associated system (e.g., the user system 155), version penetration, popular usage times, retention, active users, deleted items of timestamped live stream media content, deletion rate, average edit time, shared timestamped live stream media content, share rotation, share rotation per session, share rotation per event, top sharing networks, top users 150, top recipients 180, session bounce rate, error log, error rate, and overview of demographics (e.g., age, gender) of users 150 and recipients 180.

The information collected by the analytics module 135 can be stored as stored data 134 in the storage repository 130. The information collected by the analytics module 135 can be any or all information associated with the creation and/or sharing of timestamped live stream media content. Further, the analytics module 135 can use one or more protocols 132 and/or algorithms 133 in the storage repository 130 to analyze the information collected by the analytics module 135 and put the analyzed data into one or more presentation formats (e.g., a graph, a chart, a table). The analyzed data and the presentation formats can also be stored as stored data 134 in the storage repository 130.

The control engine 125 can share any of the information generated and/or analyzed by the analytics module 135 with any other component (e.g., content provider system 175, a user system 155, the administrative console 160) in the system 100. The analytics module 135 can perform its collection and analytics functions automatically (e.g., based on settings by the user 150, based on settings by the administrative console 160) and/or in response to a specific request from a component (e.g., a content provider 170 through the content provider system 175). In some cases, the analytics module 135 is configured to continuously collect and evaluate analytics information. Further, the analytics module 135 can be configured to provide an analytics output in real time.

The control engine 125 can provide control, communication, and/or other similar signals to the user system 155, one or more of the recipient systems 185, the administrative console 160, one or more content provider systems 175, and one or more of the cloud service providers 190. Similarly, the control engine 125 can receive control, communication, and/or other similar signals from the user system 155, one or more of the recipient systems 185, the administrative console 160, one or more content provider systems 175, and one or more of the cloud service providers 190. The control engine 125 can communicate with each component of the system 100 automatically (for example, based on one or more algorithms 133 and/or protocols 132 stored in the storage repository 130) and/or based on control, communication, and/or other similar signals received from another component (e.g., the app 149 on a recipient system 185, the administrative console 160) using the communication links 191. The control engine 125 may include a printed circuit board, upon which the hardware processor 120 and/or one or more discrete components of the controller 144 are positioned.

The control engine 125 (or other components of the controller 144) can also include one or more hardware and/or software architecture components to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication network (using the communication links 105) of the system 100 can have any type of network architecture. For example, the communication network of the system 100 can be a mesh network. As another example, the communication network of the system 100 can be a star network. When the controller 144 includes an energy storage device (e.g., a battery as part of the power module 121), even more power can be conserved in the operation of the system 100. In addition, using time-synchronized communication protocols 132, the data transferred between the controller 144, the user system 155, the recipient system 185, the administrative console 160, the content provider systems 175, and the cloud service providers 190 can be secure.

The communication module 129 of the controller 144 determines and implements the communication protocol (e.g., from the protocols 132 of the storage repository 130) that is used when the control engine 125 communicates with (e.g., sends signals to, receives signals from) the user system 155, a recipient system 185, the administrative console 160, the content provider systems 175, and/or the cloud service providers 190. In some cases, the communication module 129 accesses the stored data 134 to determine which communication protocol 132 is within the capability of the component of the system 100 communicating with the control engine 125. In addition, the communication module 129 can interpret the communication protocol 132 of a communication received by the controller 144 so that the control engine 125 can interpret the communication.

The communication module 129 can send data (e.g., protocols 132, stored data 134) directly to and/or retrieve data directly from the storage repository 130. Alternatively, the control engine 125 can facilitate the transfer of data between the communication module 129 and the storage repository 130. The communication module 129 can also provide encryption to data that is sent by the controller 144 and decryption to data that is received by the controller 144. The communication module 129 can also provide one or more of a number of other services with respect to data sent from and received by the controller 144. Such services can include, but are not limited to, data packet routing information and procedures to follow in the event of data interruption.

The timer 127 of the controller 144 can track clock time, intervals of time, an amount of time, and/or any other measure of time. The timer 127 can also count the number of occurrences of an event, whether with or without respect to time. Alternatively, the control engine 125 can perform the counting function. The timer 127 is able to track multiple time measurements concurrently. The timer 127 can track time periods based on an instruction received from the control engine 125, based on an instruction received from the user system 155, based on an instruction programmed in the software for the controller 144, based on some other condition or from some other component, or from any combination thereof.

The power module 121 of the controller 144 provides power to one or more other components (e.g., timer 127, control engine 125) of the controller 144. The power module 121 can include one or more of a number of single or multiple discrete components (e.g., transistor, diode, resistor), and/or a microprocessor. The power module 121 may include a printed circuit board, upon which the microprocessor and/or one or more discrete components are positioned.

The power module 121 can include one or more components (e.g., a transformer, a diode bridge, an inverter, a converter) that receives power (for example, through an electrical cable) from a source external to the media sharing system 140 and generates power of a type (e.g., alternating current, direct current) and level (e.g., 12V, 24V, 120V) that can be used by the other components of the controller 144. In addition, or in the alternative, the power module 121 can be a source of power in itself to provide power to one or more of the other components of the controller 144. For example, the power module 121 can be or include a battery. As another example, the power module 121 can be or include a localized photovoltaic power system.

The hardware processor 120 of the controller 144 executes software in accordance with one or more example embodiments. Specifically, the hardware processor 120 can execute software on the control engine 125 or any other portion of the controller 144, as well as, in some cases, software used by the app 149 and/or the CDN 148. The hardware processor 120 can be an integrated circuit, a central processing unit, a multi-core processing chip, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 is discretely located within the controller 144 relative to the hardware processor 120 according to some example embodiments. In certain configurations, the memory 122 can be integrated with the hardware processor 120.

In certain example embodiments, the controller 144 does not include a hardware processor 120. In such a case, the controller 144 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 144 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 144 can send and/or receive data, control, and/or communication signals. Specifically, the transceiver 124 can be used to transfer data between the controller 144 and the user system 155, a recipient system 185, the administrative console 160, the content provider systems 175, and/or the cloud service providers 190. The transceiver 124 can use wired and/or wireless technology. The transceiver 124 can be configured in such a way that the data, control, and/or communication signals sent and/or received by the transceiver 124 can be received and/or sent by another transceiver that is part of the user system 155, a recipient system 185, the administrative console 160, the content provider systems 175, and/or the cloud service providers 190.

When the transceiver 124 uses wireless technology, any type of wireless technology can be used by the transceiver 124 in sending and receiving signals. Such wireless technology can include, but is not limited to, Wi-Fi, visible light communication, cellular networking, Zigbee, Bluetooth Low Energy, and Bluetooth. The transceiver 124 can use one or more of any number of suitable communication protocols (e.g., ISA100, HART, wirelessHART) when sending and/or receiving signals. Such communication protocols can be stored in the protocols 132 of the storage repository 130. Further, any transceiver information for the user system 155, a recipient system 185, the administrative console 160, the content provider systems 175, and/or the cloud service providers 190 can be part of the stored data 134 (or similar areas) of the storage repository 130.

The application interface 126 (also called an application programming interface 126) includes a set of programming instructions and standards for accessing the app 149, the CDN 148, the user system 155, a recipient system 185, the administrative console 160, the content provider systems 175, and/or the cloud service providers 190. The application interface 126 facilitates communication between the controller 144 and these other components of the system 100. Some or all of the protocols and standards used by the application interface 126 can reside in the storage repository 130 and can be accessible to the application interface 126, via the control engine 125, on an as-needed basis.

Optionally, in one or more example embodiments, the security module 128 secures interactions between the controller 144, the user system 155, the recipient systems 185, the administrative console 160, and/or the cloud service providers 190. More specifically, the security module 128 authenticates communication from software based on security keys verifying the identity of the source of the communication. For example, user software may be associated with a security key enabling the software of the user system 155 to interact with the controller 144 of the back-end system 145 of the live media sharing system 140. Further, the security module 128 can restrict receipt of information, requests for information, and/or access to information in some example embodiments.

The CDN 148 is a geographically distributed network of proxy servers and their data centers. The CDN 148 distributes service spatially relative to the user 150 and recipients 180 to provide high availability and high performance with respect to establishing and delivering selected timestamped live stream media content. In this particular case, the CDN cases the timestamped live stream media content as media packets. With a large number of users 150 and recipients 180 simultaneously participating in the system 100, casing is important to maintain real-time delivery of the timestamped live stream media content. The CDN 148 can save timestamped live stream media content to minimize the number of hits going from the users 150 and recipients 180 to the back-end system 145 and/or the cloud service provider 190. Examples of a CDN 148 can include, but are not limited to, CloudFront and ACAMI.

In some cases, the CDN 148 is in direction communication with the origin server 197 of the cloud service provider 190 using one or more communication links 191. In such a case, the origin server 197 can maintain a large number of timestamped timestamped live stream media content, and when a user 150 or recipient 180, through a user system 155 or a recipient system 185, makes a selection to view the timestamped live stream media content, the CDN 148 can retrieve the timestamped live stream media content directly from the origin server 197 in real time.

In some cases, the origin server 197, as part of its packaging of timestamped live stream media content, can create a text description of the timestamped live stream media content and/or generate one or more thumbnails of timestamped live stream media content. In such a case, the origin server 197 can send the text description and/or the thumbnails directly to the back-end system 145 and/or the CDN 148.

The user 150 may be any person, a group, or an entity that interacts with the user system 155 to communicate with any other portion of the system 100. Examples of a user may include, but are not limited to, an attendee of a live event, a coordinator of an event, a participant in an event, a performer, and a person interested in a live event but not present at the live event, or a viewer of archived media content.

The user 150 can use the user system 155, which may include a display (e.g., a GUI). The user system 155 can also include a controller 154, one or more digital communication platforms 195, and the app 149 of the live media sharing system 140. Examples of a user system 155 can include, but are not limited to, a smart phone, a smart watch, an electronic pad, a PDA, a laptop computer, a smart television, and a desktop computer, The controller 154 of the user system 155 controls the operation of the user system 155. For example, the controller 154 of the user system 155 can facilitate operation of the app 149 with the back-end system 145. As another example, the controller 154 of the user system 155 can facilitate the operation of any of the digital communication platforms 195 loaded on the user system 155.

The controller 154 of the user system 155 can include one or more components described above with respect to the controller 144 of the back-end system 145 of the live media sharing system 140. For example, the controller 154 of the user system 155 can include a control engine (at least in some ways similar to control engine 125), a communication module (e.g., communication module 129), a timer (e.g., timer 127), a power module (e.g., power module 121), a storage repository (e.g., storage repository 130), a hardware processor (e.g., hardware processor 120), a memory (e.g., memory 122), a transceiver (e.g., transceiver 124), an application interface (e.g., application interface 126), and an optional security module (e.g., security module 128).

The app 149 loaded on the user system 155 can provide, using the display on the user system 155, a list of timestamped live stream media content to the user 150. The list of timestamped live stream media content can be automatically pushed to the app 149 by the controller 144 of the back-end system 145 or in response to any of a number of factors (e.g., a request by the user 150 through the app 149). The list of timestamped live stream media content can include thumbnails (e.g., still images, video clips, audio file clips) and/or text to provide sufficient information to the user 150 to identify and/or preview the timestamped live stream media content.

The control engine 125 of the controller 144, working in conjunction with the CDN 148, ensure that the timestamped live stream media content is in the proper format for the user system 155. If the timestamped live stream media content is a live event, the user 150 can use the app 149 to watch the livestream as a preview before making a selection. In some cases, an item in the list can be like a folder, with multiple items within the folder that can be chosen. For example, for a multi-day or multi-session conference, the event can be a folder in the list, and within the folder are a list of each individual session (each timestamped live stream media content) of the conference.

The user 150 can then use the app 149 to select one or more of the timestamped live stream media content items. For example, the app 149 on the user system 155 can allow the user 150, while previewing timestamped live stream media content, to “pin” or select a specific point in the timestamped live stream media content to select. This pin or selection in the timestamped live stream media content automatically marks a start and end time or point in the selected timestamped live stream media content. The pin can be with reference to some aspect of the timestamped live stream media content, such as the start time of the segment or the time of day when the pin is set. The settings around a pin made by a user 150 in the selected timestamped live stream media content can be changed. For example, a user 150, using the app 149, can change the settings associated with a pin. The setting parameters can also vary or be changed. For example, a pin can be designated to mark a mid-point in a 30 second segment of the selected timestamped live stream media content. As another example, a pin can be designated to mark 20 seconds after the start of the selected segment of timestamped live stream media content and 30 seconds before the end of the selected segment of timestamped live stream media content.

The settings associated with a pin can also vary based on the timestamped live stream media content. For example, a pin can have certain settings for a live event that are different than the settings for a pin of pre-recorded media content. As another example, the settings for a pin of a sporting event can be different than the settings for a pin of a speech or presentation. Also, rather than change default settings of a pin, a user 150 can use the app 149 to manually change the start time, end time, and/or duration of particular segment of selected timestamped live stream media content.

If the user 150 selects multiple timestamped live stream media content, the app 149 can allow the user 150 to view and pin each segment of timestamped live stream media content individually, and then give the user 150 the option to splice all of the selected segments of timestamped live stream media content into a single selected segment of timestamped live stream media content. Similarly, if the user 150 only selects one segment of timestamped live stream media content in the app 149, the user 150 can pin the selected timestamped live stream media content multiple times on the app 149. In such a case, the app 149 can allow the user to splice together the multiple segments of the selected timestamped live stream media content.

The user 150 can also use the app 149 to insert written comments, emojis, and/or other commentary in the selected timestamped live stream media content. When the user 150 has finished creating the selected timestamped live stream media content, the user 150 can direct the app 149 to send the information associated with each selected timestamped live stream media content (including any annotations) to the back-end system 145 and/or the CDN 148. This information can include the selected timestamped live stream media content, the location of the pin in the selected timestamped live stream media content, the ID of the user 150, the start time, the end time, and the duration. Some of this information can be based on default values, while at least some of the information is based on user selections on the app 149.

The app 149 loaded on the user system 155 is also able to receive a URI, generated by the URI generator 123 and sent by the control engine 125 of the controller 144 of the back-end system 145, for each selected timestamped live stream media content created by the user 150 on the app 149. The user 150, using the user system 155, can copy the URI from the app 149 and forward the URI to one or more recipients 180 on one or more recipient systems 185 by pasting the URI into one or more digital communication platforms 195 loaded on the user system 155. In addition, or in the alternative, the user 150 can use the app 149 to forward the URI directly to a recipient 180 in the app 149.

When the user 150 receives the URI in the app 149, the user 150 can view the selected timestamped live stream media content by selecting the URI in the app 149 before sharing the URI. In some cases, when the user selects the URI in the app 149, the CDN 148 delivers the selected timestamped live stream media content to the app 149 on the user system 155. If the user 150 wants to change any aspect (e.g., start time, end time, annotations) of the selected timestamped live stream media content, the user 150 can make those changes using the app 149. Such changes can then be sent by the app 149 to the back-end system 145, where the database module 131 updates and saves the new information in the table or database associated with that selected timestamped live stream media content.

The recipient 180 may be any person, group of people, and/or entity that interacts with the recipient system 185 to communicate with any other portion of the system 100. Examples of a user may include, but are not limited to, an attendee of a live event, a coordinator of an event, a participant in an event, a performer, an audience member, and a person interested in a live event but not present at the live event.

The recipient 180 can use the recipient system 185, which may include a display (e.g., a GUI). The recipient system 185 can also include a controller 184, one or more digital communication platforms 195, and (optionally) the app 149 of the live media sharing system 140. Examples of a recipient system 185 can include, but are not limited to, a smart phone, a smart watch, an electronic pad, a PDA, a laptop computer, a smart television, and a desktop computer, The controller 184 of the recipient system 185 controls the operation of the recipient system 185. For example, the controller 184 of the recipient system 185 can facilitate operation of the app 149 with the back-end system 145. As another example, the controller 184 of the recipient system 185 can facilitate the operation of any of the digital communication platforms 195 loaded on the recipient system 185.

The controller 184 of the recipient system 185 can include one or more components described above with respect to the controller 144 of the back-end system 145 of the live media sharing system 140. For example, the controller 184 of the recipient system 185 can include a control engine (at least in some ways similar to control engine 125), a communication module (e.g., communication module 129), a timer (e.g., timer 127), a power module (e.g., power module 121), a storage repository (e.g., storage repository 130), a hardware processor (e.g., hardware processor 120), a memory (e.g., memory 122), a transceiver (e.g., transceiver 124), an application interface (e.g., application interface 126), and an optional security module (e.g., security module 128).

When the recipient 180 receives the URI sent by the user 150, whether through the app 149 or through one of the digital communication platforms 195 loaded on the recipient system 185, the recipient 180 can receive the page generated by the page generator 136 of the controller 144 and sent by the control engine 125 of the controller 144 of the back-end system 145 by selecting the URI. For example, the recipient 180 can receive and open the URI in the app 149, in a web browser, in an email, in a text message, or from a Facebook post. The combination of the controller 144 and the CDN 148 ensure that the page and its contents (e.g., the selected timestamped live stream media content) is formatted in such a way as to be compatible with the recipient system 185 and the software that is being used to view the page.

The app 149, when optionally loaded on the recipient system 185, can also be configured to allow a recipient 180 to become a user 150, either by selecting new timestamped live stream media content on the app 149 and/or by altering (e.g., changing the settings, adding commentary) the just-viewed selected timestamped live stream media content to the point of creating new selected timestamped live stream media content. Also, the app 149, a web browser, or some other software loaded on the recipient system 185 can allow the recipient 180 to forward the URI corresponding to the page that the recipient 180 had just viewed. In such a case, the recipient 180 can forward the URI using the app 149 and/or by copying the URI into one or more of the digital communication platforms 195 loaded on the recipient system 185 and communicating through the digital communication platform 195. The recipient 180 can also become a user 150 using a web browser.

Each content provider 170 can have one or more content provider systems 175, where each content provider system 175 can include a controller 174, an encoder 172, and a server 177. In some cases, if there are multiple content provider systems 175, one or more of these components (e.g., the controller 174) or portions thereof (e.g., a storage repository) can be shared between two or more content provider systems 175. A content provider 170 is any person or entity that provides media content, which is eventually converted into timestamped live stream media content for use by the live media sharing system 140. Examples of a content provider 170 can include, but are not limited to, a media network (e.g., ABC, CNN), a sports franchise, an event organizer, a promoter, a church or evangelist, a production company, and a video streaming service.

Examples of a live event that can be provided as live media content by a content provider 170 can include, but are not limited to, a conference, a trade show, a sporting event, a theater production, a sermon, a meeting, The content provider 170 provides live media content of a live event to generate interest in the live event. By using example embodiments, the live media content, being converted into timestamped live stream media content of the live event, can be shared in real time. The content provider system 175 can be any type of computer system, which can include one or more of a number of smart phones, smart watches, electronic pads, PDAs, laptop computers, smart televisions, and desktop computers,

Because of the massive amount of memory required to stream the contribution feed to the cloud service providers 190, the servers 177 of the content provider system 175 can be used to help send, buffer, and/or store the contribution feed. In some cases, the cloud service providers 190 are part of the servers 177 of the content provider system 175. The controller 174 of the content provider system 175 can include one or more components described above with respect to the controller 144 of the back-end system 145 of the live media sharing system 140. For example, the controller 174 of the content provider system 175 can include a control engine (at least in some ways similar to control engine 125), a communication module (e.g., communication module 129), a timer (e.g., timer 127), a power module (e.g., power module 121), a storage repository (e.g., storage repository 130), a hardware processor (e.g., hardware processor 120), a memory (e.g., memory 122), a transceiver (e.g., transceiver 124), an application interface (e.g., application interface 126), and an optional security module (e.g., security module 128).

The controller 174 of the content provider system 175 can automatically push contribution feed, which is generated from the live media content by the encoders 172, to the cloud service providers 190 as the live media content occurs. Alternatively, the controller 174 of the content provider system 175 can receive a request, directly or indirectly, for contribution feed of a specific live event from the controller 144 of the back-end system 145 of the live media sharing system 140.

The one or more cloud service providers 190 are configured to receive contribution feed from the content provider systems 175 of the content providers 170. The encoder 192 of the cloud service provider 190 can encode the contribution feed received from a content provider 170 into streaming content, which is then processed by the origin server 197 to create the timestamped live stream media content using cloud-based technology that has only been developed within the past year. Example embodiments enhance this technology using the CDN 148, the controller 144, and the app 149 of the live media sharing system 140 so that the timestamped live stream media content can be shared in real time in an audience (user 150)-driven system 100.

Live events can currently be streamed in an enterprise environment (e.g., an enterprise dumps a live stream into a platform (e.g., YouTube) in real time for mass viewing by individuals). Examples of companies (a type of cloud service provider 190) that have developed such encoding technology for an enterprise platform include Amazon Web Services, Microsoft, and Google. However, the technology utilized by the origin server 197 to share time-coded selections of live streaming events driven by individual users in real time has not previously existed. In other words, prior to the end of 2017, the technology captured in the origin server 197 to generate timestamped live stream media content for slightly delayed (essentially real time) use with apps on personal devices was not available. Example embodiments enhance the new timestamping technology for enterprise use to enable individual users 150 to share timestamped live stream media content with identified recipients 180 in real time using the app 149.

The controller 194 of the cloud service providers 190 can include one or more components described above with respect to the controller 144 of the back-end system 145 of the live media sharing system 140. For example, the controller 194 of the cloud service providers 190 can include a control engine (at least in some ways similar to control engine 125), a communication module (e.g., communication module 129), a timer (e.g., timer 127), a power module (e.g., power module 121), a storage repository (e.g., storage repository 130), a hardware processor (e.g., hardware processor 120), a memory (e.g., memory 122), a transceiver (e.g., transceiver 124), an application interface (e.g., application interface 126), and an optional security module (e.g., security module 128).

The administrative console 160 of the system 100 can be used to control operation parameters of the live media sharing system 140 and/or to control analytics analyzed by the analytics module 135 of the controller 144 of the live media sharing system 140. The administrative console 160 can be controlled by a user 150, a content provider 170, an administrator, and/or any other entity that has an interest in some or all timestamped live stream media content being shared on the system 100. Changes made by the administrative console 160 to the live media sharing system 140 can be permanent, temporary (e.g., valid for only a period of time), superior (e.g., cannot be overridden by another entity participating in the system 100), or default (e.g., can be overridden).

While not shown in FIG. 1A, the administrative console 160 can include a controller. Such a controller can include one or more components described above with respect to the controller 144 of the back-end system 145 of the live media sharing system 140. For example, the controller of the administrative console 160 can include a control engine (at least in some ways similar to control engine 125), a communication module (e.g., communication module 129), a timer (e.g., timer 127), a power module (e.g., power module 121), a storage repository (e.g., storage repository 130), a hardware processor (e.g., hardware processor 120), a memory (e.g., memory 122), a transceiver (e.g., transceiver 124), an application interface (e.g., application interface 126), and an optional security module (e.g., security module 128).

As discussed above, the user system 155, each recipient system 185, each content provider system 175, the cloud service providers 190, and the administrative console 160 can interact with the controller 144 of the live media sharing system 140 using the application interface 126 in accordance with one or more example embodiments. Specifically, the application interface 126 of the controller 144 receives data (e.g., information, communications, instructions) from and sends data (e.g., information, communications, instructions) to the user system 155, each recipient system 185, each content provider system 175, the cloud service providers 190, and the administrative console 160.

The user system 155, each recipient system 185, each content provider system 175, the cloud service providers 190, and/or the administrative console 160 can include an interface to receive data from and send data to the controller 144 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

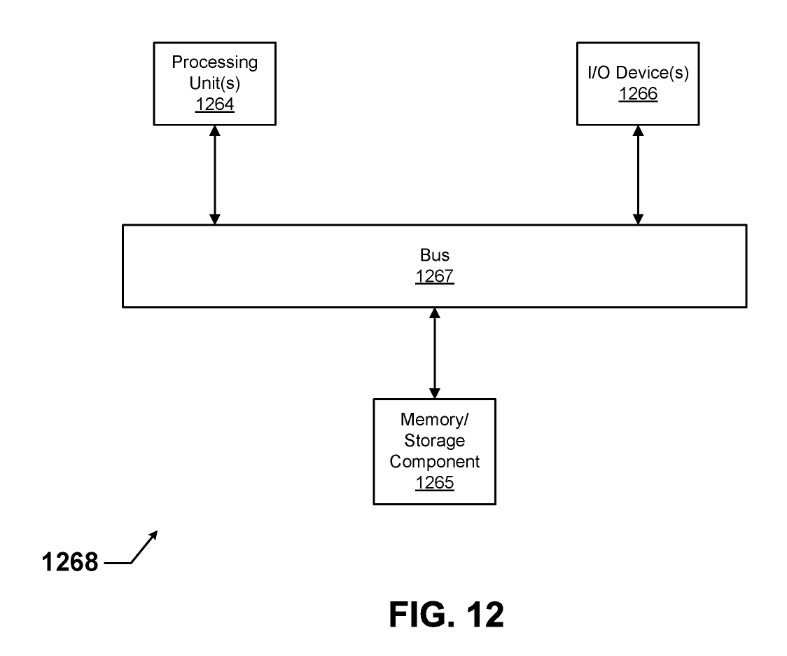

The controller 144, the user system 155, each recipient system 185, each content provider system 175, the cloud service providers 190, and/or the administrative console 160 can use their own system or share a system in certain example embodiments. For example, the administrative console 160 can be integrated with the content provider system 175. Such a system can be, or contain a form of, an Internet-based or an intranet-based computer system that is capable of communicating with various software. A computer system includes any type of computing device and/or communication device, including but not limited to the controller 144. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, a smartphone, and a PDA. Such a system can correspond to a computer system as described below with regard to FIG. 12.

Further, as discussed above, such a system can have corresponding software (e.g., user system software, live media sharing system software, content provider system software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments.

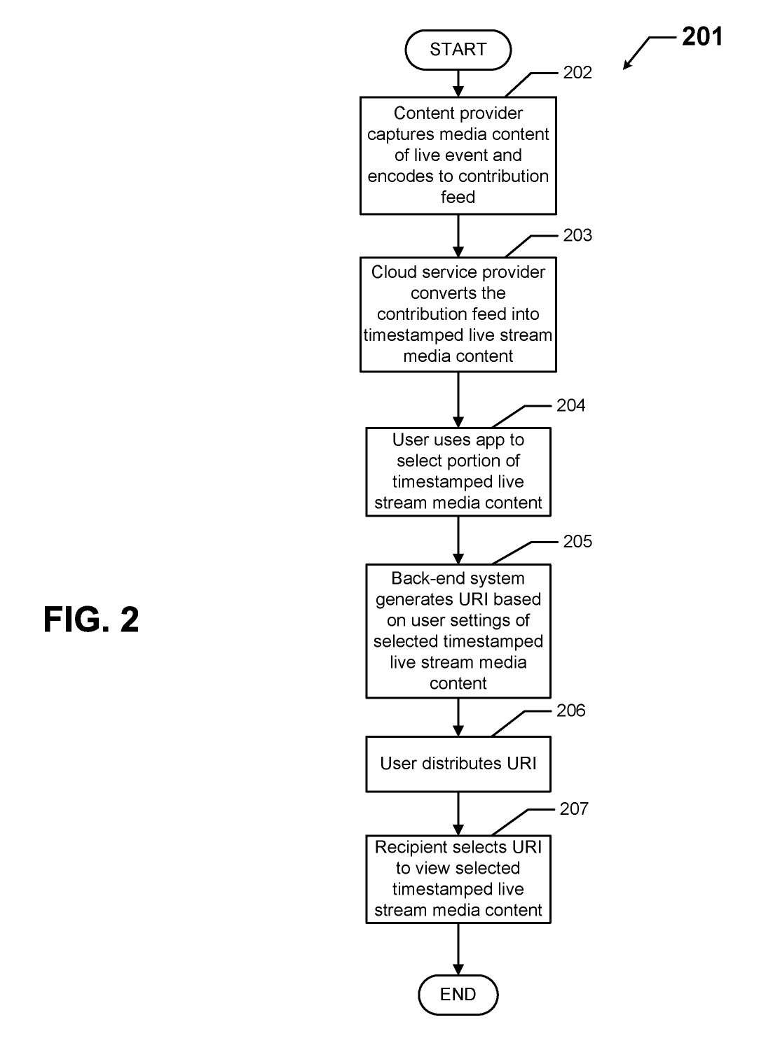

FIGS. 2-6, 9A, and 9B below show flow diagrams of various methods involved in sharing live media timestamped live stream media content in real time in accordance with certain example embodiments. While the various steps in these flowcharts are presented sequentially, one of ordinary skill will appreciate that some or all of the steps may be executed in different orders, may be combined or omitted, and some or all of the steps may be executed in parallel. Further, in one or more of the example embodiments, one or more of the steps shown in these example methods may be omitted, repeated, and/or performed in a different order.

In addition, a person of ordinary skill in the art will appreciate that additional steps not shown in FIGS. 2-6, 9A, and 9B may be included in performing these methods. Accordingly, the specific arrangement of steps should not be construed as limiting the scope. Further, a particular computing device, such as the computing device discussed below with respect to FIG. 12, can be used to perform one or more of the steps for the methods shown in FIGS. 2-6, 9A, and 9B in certain example embodiments. The methods discussed in FIGS. 2-6, 9A, and 9B are not exclusive, meaning that sharing live media timestamped live stream media content in real time can be possible using alternative example embodiments. In certain example embodiments, any of the steps in the methods shown in FIGS. 2-6, 9A, and 9B can be performed in real time as it is defined herein.

The methods shown in FIGS. 2-6, 9A, and 9B are merely examples that can be performed by using an example system described herein. In other words, example systems for sharing live media timestamped live stream media content in real time can perform other functions in addition to and/or aside from those shown in FIGS. 2-6, 9A, and 9B. The methods shown in FIGS. 2-6, 9A, and 9B can be performed using the system 100 of FIGS. 1A and 1B. Also, all communications described in the methods of FIGS. 2-6, 9A, and 9B are facilitated by the communication links 191.

FIG. 2 shows a high-level flow diagram of a method 201 for sharing timestamped live stream media content in real time in accordance with certain example embodiments. Referring to FIGS. 1A through 2, the method 201 begins at the START step and proceeds to step 202, where the content provider 170 captures media content of a live event to generate contribution feed. The content provider 170 can use any of a number of devices (e.g., digital video cameras, microphones, teleprompters, production boards, production studios, booms) to capture the media content of the live or pre-recorded event in one or more digital media.

One or more encoders 172 of the content provider system 175 of the content provider 170 can be used to convert the media content into contribution feed. The encoders 172 can convert the media content into contribution feed on a substantially continuous and real-time basis. The live media content and/or contribution feed can be stored, at least temporarily, on one or more servers 177 of one or more content provider systems 175.

In step 203, the cloud service provider 190 converts the contribution feed from the content provider system 175 into timestamped live stream media content. Specifically, the encoder 192 of the cloud service provider 190 converts the contribution feed into streaming content, and the origin server 197 of the cloud service provider 190 converts the streaming content into timestamped live stream media content. The encoder 192 and the origin server 197 can each operate continuously and in real time. As discussed above, the encoder 192 of the cloud service provider 190 converts the contribution feed into different renditions needed for being displayed on various devices and media, and the origin server 197 timestamps the streaming content generated by the encoder 192 to create the timestamped live stream media content that is sharable in real time by and between individuals (e.g., users 150, recipients 180).

In step 204, the user 150 uses the app 149 to select a portion of the timestamped live stream media content. The user 150 is using the user system 155, on which the app 149 is loaded. The user 150 receives the timestamped live stream media content on the app 149 from the CDN 148 after the back-end system 145 sends the timestamped live stream media content to the CDN 148. The user 150 uses the app 149 to preview the timestamped live stream media content, and then makes selections (e.g., place a pin, adjust a start and end time) to generate selected timestamped live stream media content. These selections can be part of the information associated with the selected timestamped live stream media content. Such information can also include a user ID and user comments. When these selections are made by the user 150 on the app 149, the various selections (user settings) are sent by the app 149 to the back-end system 145.

In step 205, the back-end system 145 generates a URI based on the user settings of the selected live stream content. Specifically, the URI is generated by the URI generator 123 in conjunction with the table or database built by the database module 131 using the information (e.g., user selections, user ID, ID of live media content, ID of content provider, ID of event, comments) associated with the selected timestamped live stream media content. The control engine 125 of the controller 144 of the back-end system 145 sends (either directly or through the CDN 148) the URI to the app 149 on the user system 155 for the user 150.

In step 206, the user 150 distributes the URI. Specifically, the user 150 uses the user system 155 to send the URI to one or more specifically-identified recipients 180, which can be individuals and/or groups of individuals. The user 150, using the user system 155, can copy the URI from the app 149 and forward the URI to one or more recipients 180 on one or more recipient systems 185 by pasting the URI into one or more digital communication platforms 195 loaded on the user system 155. In addition, or in the alternative, the user 150 can use the app 149 to forward the URI directly to a recipient 180 in the app 149.

Of note, the user 150 does not send an actual video clip or other similar file to an intended recipient 180 via this communication on the app 149 or a digital communication platform 195. Instead, the URI is a mechanism that is used in example embodiments to retrieve the selected timestamped live stream media content for play-back to the recipient 180. This reduced file size increases the speed in which the selected timestamped live stream media content can be shared, which makes sharing the selected timestamped live stream media content using example embodiments more real time (e.g., a five second delay relative to the actual live event, a two second delay relative to the actual live event, a ten second delay relative to the actual live event).

In step 207, the recipient 180 selects the URI to view the selected timestamped live stream media content. When the recipient 180 receives the URI sent by the user 150, whether through the app 149 or through one of the digital communication platforms 195 loaded on the recipient system 185, the recipient 180 can receive the page generated by the page generator 136 of the controller 144 and sent (either directly or through the CDN 148) by the control engine 125 of the controller 144 of the back-end system 145 by selecting the URI. For example, the recipient 180 can receive and open the URI in the app 149, in a web browser, in an email, in a text message, or from a Facebook post. The combination of the controller 144 and the CDN 148 ensure that the page and its contents (e.g., the selected timestamped live stream media content) is formatted in such a way as to be compatible with the recipient system 185 and the software that is being used to view the page, which includes the selected timestamped live stream media content. At the end of step 207, the method 201 ends at the END step.

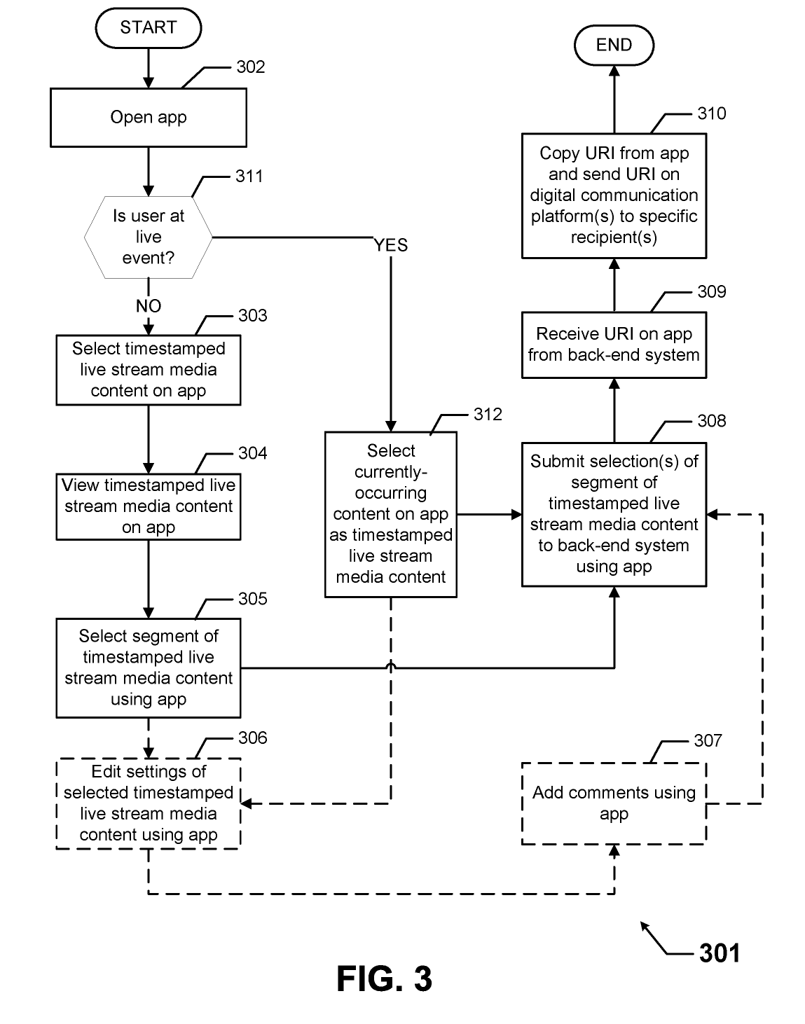

FIG. 3 shows a flow diagram of a method 301 for sharing timestamped live stream media content in real time from the perspective of a user 150 in accordance with certain example embodiments. Referring to FIGS. 1A through 3, the method 301 starts at the START step and proceeds to step 302, where the user 150 opens the app 149. The user 150 opens the app 149 on the user system 155. In some cases, the app 149 is offered as a link within a different application (e.g., Facebook, LinkedIn) being used by the user 150.

In some cases, the user 150 is specifically identified by the app 149 when the user 150 opens app 149. For example, the user 150 may need to provide a user name and password or enter a PIN to access an account on the app 149. As another example, the user 150 may already be logged into a different application (e.g., Facebook, LinkedIn), and those login credentials can be used to allow the user 150 to open the app 149. An example of a login screen on the app 149 is shown in FIG. 10H below. Once the user 150 is logged in, the home screen of the app 149 can have a number of appearances. For example, the home screen of the app 149 can look like what is shown in FIG. 10C below.

In step 311, a determination is made as to whether the user 150 (or more specifically the user system 155) is at a live event. This determination can be made by the controller 144 of the back-end system 145, sometimes in coordination with the CDN 148. For example, the controller 144 can determine if the user 150 is at a live event based on GPS information received from the user system 155 and comparing this GPS information to locations of live events that are currently streaming and available for selection and sharing on the live media sharing system 140.

As another example, the app 149 can present a query to the user 150 asking if the user 150 is at a live event and, if so, which particular live event. If the user 150 is at a live event, then the process proceeds to step 312. Alternatively, for example if the user 150 is interested in a live event different than the one that the user 150 is currently attending, then the process can proceed to step 303 based, for example, on a selection on the app 149 by the user 150. If the user 150 is not at a live event, then the process proceeds to step 303.

In step 312, the user 150 selects, on the app 149, the timestamped live stream media content that corresponds to the currently-occurring live event that the user 150 is attending. The timestamped live stream media content of that particular live event can be delivered to the app 149 by the CDN 148. If the user 150 wants to expedite sharing the timestamped live stream media content, then the process can proceed to step 308 when step 312 is complete. In fact, in some cases, when the user 150 is at the live event, the user 150 an make a single selection on the app 149 to prompt the back-end system 145 to generate a URI for the selected timestamped live stream media content. Alternatively, if the user 150 wants to add annotations, change the pin location, change the start/stop times of the selected timestamped live stream media content, and/or otherwise change or modify default settings, then the process can proceed to step 306 when step 312 is complete.

In step 303, the user 150 selects timestamped live stream media content on the app 149. The app 149 loaded on the user system 155 can provide, using the display on the user system 155, a list of timestamped live stream media content to the user 150. The list of timestamped live stream media content can be automatically pushed to the app 149 by the controller 144 of the back-end system 145 or in response to any of a number of factors (e.g., a request by the user 150 through the app 149). In some cases, the list of timestamped live stream media content is delivered by the CDN 148 to the app 149. The list of timestamped live stream media content can include thumbnails (e.g., still images, video clips, audio file clips) and/or text to provide sufficient information to the user 150 to identify and/or preview the timestamped live stream media content. An example of a screen shot of the app 149 allowing the user 150 to select timestamped live stream media content is shown in FIG. 10E below.

In step 304, the user 150 views the timestamped live stream media content on the app 149. The control engine 125 of the controller 144, working in conjunction with the CDN 148, ensures that the timestamped live stream media content is in the proper format for the user system 155. If the timestamped live stream media content is for a live event, the user 150 can use the app 149 to watch the livestream as a preview before making a selection. In some cases, an item in the list can be like a folder, with multiple items within the folder that can be chosen. For example, for a multi-day or multi-session conference, the event can be a folder in the list, and within the folder are a list of each individual session (each timestamped live stream media content) of the conference.

In step 305, the user 150 selects the segment of timestamped live stream media content using the app 149. For example, the app 149 on the user system 155 can allow the user 150, while previewing timestamped live stream media content, to “pin” or select a specific point in the timestamped live stream media content to select. This pin or selection in the timestamped live stream media content automatically marks a start and end time or point in the selected timestamped live stream media content. In this way, in certain example embodiments, the selected timestamped live stream media content can be selected by a user 150 with a single “click” on the app 149.

The settings associated with a pin can also vary based on the timestamped live stream media content. For example, a pin can have certain settings for a live event that are different than the settings for a pin of pre-recorded media content. As another example, the settings for a pin of a sporting event can be different than the settings for a pin of a speech or presentation. Also, rather than change default settings of a pin, a user 150 can use the app 149 to manually change the start time, end time, and/or duration of particular segment of selected timestamped live stream media content.

In optional step 306, the user 150 can edit the settings of the selected timestamped live stream media content using the app 149. In other words, the settings around a pin made by a user 150 in the selected timestamped live stream media content can be changed. For example, a user 150, using the app 149, can change the settings associated with a pin. The setting parameters can also vary or be changed. For example, a pin can be designated to mark a mid-point in a 30 second segment of the selected timestamped live stream media content. As another example, a pin can be designated to mark 20 seconds after the start of the selected segment of timestamped live stream media content and 30 seconds before the end of the selected segment of timestamped live stream media content. The settings and/or setting parameters that are changed by the user 150 on the app 149 can be default settings/parameters or settings/parameters that had previously been set by the user 150 and are again being modified.

In optional step 307, the user 150 can add comments (annotations) to the selected timestamped live stream media content using the app 149. For example, the user 150 can use the app 149 to insert written comments, emojis, and/or other commentary in the selected timestamped live stream media content. These commentaries can appear in the selected timestamped live stream media content and/or at a location on the page (generated by the page generator 136 of the controller 144). Two examples of a user 150 adding annotations to selected timestamped live stream media content is shown in FIGS. 10J and 10K below, where the user 150 can add a comment to the selected timestamped live stream media content using the app 149, and where the user 150 can add a hashtag to the selected timestamped live stream media content using the app 149, respectively.

In step 308, which can follow step 305 or optional step 307, the user 150 can submit the one or more selections of one or more segments of timestamped live stream media content to the back-end system 145 using the app 149. If the user 150 selects multiple timestamped live stream media content, the app 149 can allow the user 150 to view and pin each segment of timestamped live stream media content individually, and then give the user 150 the option to splice all of the selected segments of timestamped live stream media content into a single selected segment of timestamped live stream media content. Similarly, if the user 150 only selects one segment of timestamped live stream media content in the app 149, the user 150 can pin the selected timestamped live stream media content multiple times on the app 149. In such a case, the app 149 can allow the user to splice together the multiple segments of the selected timestamped live stream media content. In any case, all of the information (e.g., user selections, annotations) associated with the selected timestamped live stream media content is sent from the app 149 to the controller 144 of the back-end system 145.

In step 309, the user 150 receives a URI on the app 149 from the back-end system 145. In some cases, the CDN 148 can act as an intermediary in sending the URI to the app 149. Specifically, the app 149 loaded on the user system 155 is configured to receive a URI, generated by the URI generator 123 and sent by the control engine 125 of the controller 144 of the back-end system 145, for each selected timestamped live stream media content created by the user 150 on the app 149. When the user 150 receives the URI in the app 149, the user 150 can view the selected timestamped live stream media content (delivered by the app 149 by the CDN 148) by selecting the URI in the app 149 before sharing the URI. If the user 150 wants to change any aspect (e.g., alter start time, alter end time, add annotations) of the selected timestamped live stream media content, the user 150 can make those changes using the app 149. Such changes can then be sent by the app 149 to the controller 144 of the back-end system 145, where the database module 131 updates and saves the new information in the table or database associated with that selected timestamped live stream media content. In such a case, the URI associated with the modified selected timestamped live stream media content does not change.

In step 310, the user 150 copies the URI from the app 149 and sends the URI on a digital communication platform 195 to one or more recipients 180. The user 150, using the user system 155, can copy the URI from the app 149 and forward the URI to one or more recipients 180 on one or more recipient systems 185 by pasting the URI into one or more digital communication platforms 195 loaded on the user system 155. In addition, or in the alternative, the user 150 can use the app 149 to forward the URI directly to a recipient 180 in the app 149. The recipients 180 can be specifically identified. In addition, or in the alternative, the URI can be posted on a social media site for any of a number of unidentified recipients 180 to select the URI. After step 310 is complete, the method 301 ends at the END step. Several examples of a screen shot showing the user 150 sharing the selected timestamped live stream media content using various digital communication platforms 195 is shown in FIGS. 10P1-10P-6 below.

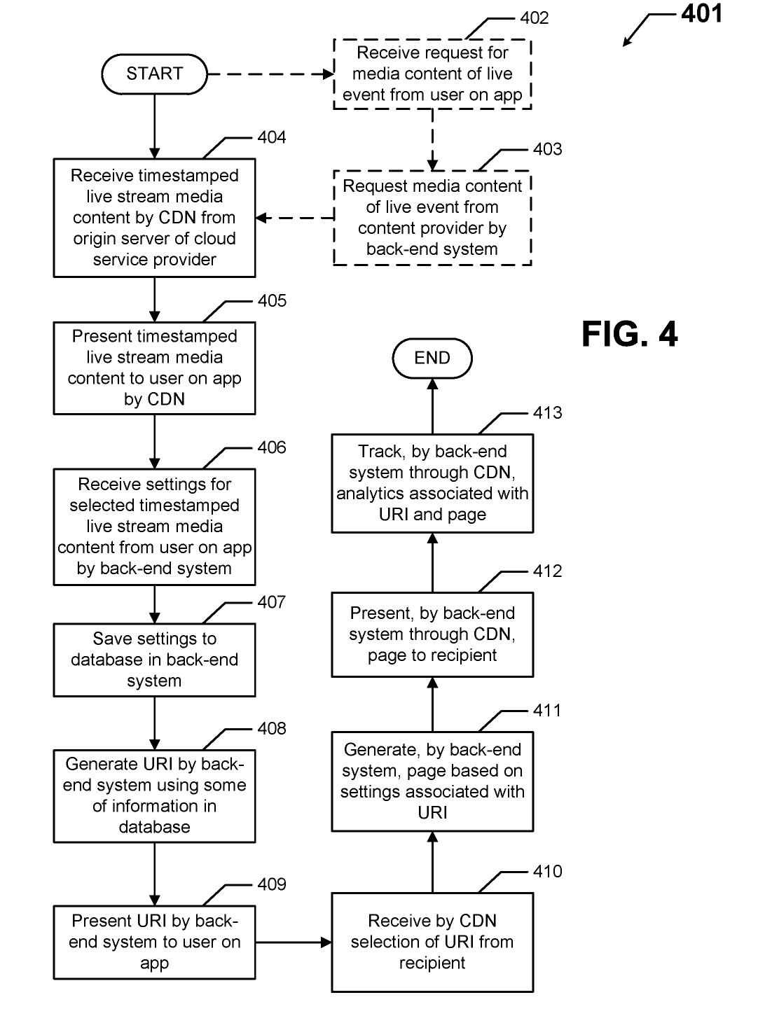

FIG. 4 shows a flow diagram of a method 401 for sharing timestamped live stream media content in real time from the perspective of a live media sharing system 140 in accordance with certain example embodiments. As a reminder, the live media sharing system 140 includes the app 149, the CDN 148, and the back-end system 145, where the back-end system 145 includes the controller 144.

Referring to FIGS. 1A through 4, the method 401 starts at the START step and proceeds to optional step 402, where the controller 144 of the back-end system 145 of the live media sharing system 140 receives a request for timestamped live stream media content of a live event in real time from the user 150 on the app 149. The request can be for timestamped live stream media content of a particular live event, a category of live events, a geographic area of currently-broadcast live events, or some other live event or group of live events. In some cases, rather than a live event, the request can be for on-demand content.

In optional step 403, the controller 144 of the back-end system 145 of the live media sharing system 140 requests timestamped live stream media content of the one or more live events from the content provider 170. This request can be communicated directly from the controller 144 to the content provider system 175, or indirectly (e.g., through the administrative module 160, through the cloud service providers 190). Also, the request can be broadcast to all content providers 170 communicably coupled to the controller 144, or to one or more specific content providers 170. In some cases, rather than making the request to a content provider 170, the controller 144 can request the timestamped live stream media content from the origin server 197 of a cloud service provider 190.

In step 404, which can be performed after the START step or after optional step 403 is completed, the CDN 148 receives the timestamped live stream media content from the origin server 197 of a cloud service provider 190. In some cases, controller 144 of the back-end system 145 receives the stamps stream media content from the origin server 197 of a cloud service provider 190, and then sends the timestamped live stream media content to the CDN 148. The origin server 197 timestamps and packages, in real time, the streaming content received from the encoder 192 of the cloud service provider 190 to generate the timestamped live stream media content, and the encoder 192 of the cloud service provider 190 encodes, in real time, the contribution feed received from the encoders 172 of a content provider 170 to generate the streaming content.

In certain example embodiments, the origin server 197 of the cloud service provider 190, in conjunction with the encoders 192 of the cloud service provider 190, essentially copies (mirrors) the contribution feed that is generated by the encoders 172 of the content provider system 175 from the media content of a live or on-demand event. This step can be viewed as a form of parallel processing. Since the contribution feed is continually streaming for a period of time, the origin server 197 in real time and continually timestamps and packages the live content from the encoder 192 of the cloud service provider 190.

As discussed above, this encoding technology provided by the origin server 197 of the cloud service provider 190 is one aspect of the present invention that is specifically designed to enable the capture and sharing of timestamped live stream media content in real time in example embodiments described herein. The origin server 197 can timestamp and package multiple items of streaming content at one time. The origin server 197 can be communicably coupled to one or more encoders 192 of one or more cloud service providers 190. The origin server 197 can be located in a single location or in multiple locations. For example, the origin server 197 can include multiple servers that are co-located with each encoder 192 of a cloud service provider 190. In any case, the origin server 197 can be coupled to the controller 144 of the back-end system 145 using one or more communication links 191.

When steps 402 and 403 are optional steps in the method 401, the timestamped live stream media content received by the control engine 125 of the controller 144 can be based on contribution feed that is automatically pushed from the content provider system 175 to the encoder 192 of the cloud service provider 190, the output (streaming content) of which can be automatically timestamped and packaged by the origin server 197 to generate the timestamped live stream media content.

In step 405, the controller 144 of the back-end system 145 presents, through the CDN 148, the timestamped live stream media content to the user 150 on the app 149 loaded on the user system 155. This presentation can be generated and delivered by the CDN 148 to the app 149. In some cases, this presentation can be generated by the control engine 125 of the controller 144 and delivered by the CDN 148. The presentation can be a list, with or without thumbnails, of the various timestamped live stream media content that the control engine 125 or CDN 148 has received, through the origin server 197, from the various content provider systems 175. In this way, the user 150 can use the app 149 to preview and select timestamped live stream media content for sharing.

In step 406, the controller 144 of the by back-end system 145 receives settings for and other information associated with selected timestamped live stream media content from the user system 155 on the app 149. The various information associated with the selection of timestamped live stream media content can include, but is not limited to, an ID of the user 150, the particular timestamped live stream media content selected, the start time, the end time, the duration, and any comments (annotations) from the user 150. When the control engine 125 of the controller 144 receives this information associated with the selected timestamped live stream media content from the app 149 on the user system 155, the control engine 125 sends this information to the database module 131.

In step 407, the settings and other information associated with the timestamped live stream media content is saved to a table or database in the back-end system 145 by the database module 131. Specifically, the database module 131 builds a table or database for each item of selected timestamped live stream media content. The table or database is populated with all of the information that is received by the control engine 125 from the app 149 on the user system 155 and that is associated with the selected timestamped live stream media content. In addition, the database module 131 populates the table or database with other information associated with the selected timestamped live stream media content. Examples of such other information can include, but is not limited to, advertisements, sponsorship, changes in user-defined default values, pre-roll and post-roll content, and applicable settings received by the control engine 125 from the administrative console 160.

Any identification numbers (e.g., for the user 150, for a content provider 170, for an event, for selected timestamped live stream media content) that are used in association with selected timestamped live stream media content can be generated by the control engine 125 or the database module 131 using one or more algorithms 133 and/or protocols 132 in the storage repository 130. The table or database populated and maintained by the database module 131 is part of the stored data 134 in the storage repository 130 in certain example embodiments.

The database module 131 can also update a table or database for an existing selection of timestamped live stream media content. For example, a new or added sponsor of an event associated with the selected timestamped live stream media content can be updated or added to the table or database by the database module 131. As another example, if an advertisement associated with the selected timestamped live stream media content is changed, the database module 131 can update the table or database accordingly. As yet another example, if the user 150, through the app 149, alters the start and/or end time of the existing selection of timestamped live stream media content, the database module 131 updates the table or database accordingly.

In step 408, the URI generator 123 of the controller 144 of the back-end system 145 generates a URI using some of the information stored in the table or database. Specifically, the control engine 125 of the controller 144 of the back-end system 145 can instruct the URI generator 123 to generate a URI for selected timestamped live stream media content. This instruction from the control engine 125 to the URI generator 123 can occur at any time, such as when the database module 131 generates a table or database for selected timestamped live stream media content. In certain example embodiments, the URI generator 123 follows one or more protocols 132 stored in the storage repository 130 to generate a URI. For example, the URI generator 123 can generate a URI for selected timestamped live stream media content using an ID of the content provider 170, an ID of the live event, and an ID of the selected timestamped live stream media content. The information used to generate the URI by the URI generator 123 can be looked up in the table or database associated with the selected timestamped live stream media content. When the URI generator 123 generates a URI, the URI can be stored in the table or database associated with the selected timestamped live stream media content by the database module 131

In step 409, the controller 144 of the back-end system 145 presents the URI to the user 150 on the app 149. The amount of time that passes between when the control engine 125 receives the selection of timestamped live stream media content and its associated information from the app 149 on the user system 155 and when the control engine 125 sends the URI associated with the selected timestamped live stream media content is negligible (e.g., less than one second), and so the URI is sent by the control engine 125 to the app 149 on the user system 155 in real time.

In step 410, the controller 144 of the back-end system 145 receives the selection of the URI from the recipient 180 on the recipient system 185. When a URI is selected by a recipient 180 on a recipient system 185 (e.g., on a digital communication platform 195 (e.g., on Facebook, in an email, in a text message, on Twitter), in the app 149, in a web browser), the control engine 125 of the controller 144 of the back-end system 145 is notified of the selection of the specific URI. Upon receiving this notification, the control engine 125 notifies the page generator 136 of the controller 144 of the selected URI. In some cases, the CDN 148 can additionally receive the selection of the URI from the recipient system 185.

In step 411, the page generator 136 of the controller 144 of the back-end system 145 generates a page based on settings associated with URI. In order to generate the page, the page generator 136, either directly or through the control engine 125, requests the information in the table or database associated with the selected URI from the database module 131. Specifically, the database module 131 receives the selected URI and is able to deconstruct, at least in part, the contents of the URI and use this deconstructed information to retrieve the information from the associated entry in the table or database. In alternative embodiments, if the URI is stored in the table or database, no deconstruction of the URI is needed. In any event, when the database module 131 has retrieved all of the information in the table or database associated with the selected URI, this information is sent, either directly or through the control engine 125, to the page generator 136.

The information requested by the page generator 136 can be specific (e.g., only the selected timestamped live stream media content, the start time, the end time, any sponsor information). Alternatively, the page generator 136 can request and receive all information in the table or database that is associated with the URI. In this latter case, the page generator 136 can determine which, if any, of that information to discard and which information to use in generating a page once the information is received from the database module 131.

When this information associated with the selected URI is received by the page generator 136, the page generator 136 can generate a page using one or more algorithms 133 and/or protocols 132 in the storage repository 130. These algorithms 133 and/or protocols 132 can vary based on one or more of a number of factors, including but not limited to the ID of the user 150, the ID of the content provider 170, the length of the selected timestamped live stream media content, the functionality of the recipient system 185, requirements of the content provider 170, and the type of live event (e.g., sports, presentation). The page generator 136 generates a page based on the appropriate algorithms 133 and/or protocols 132 using the information provided by the database module 131. An example of a page is shown below with respect to FIG. 8.

For example, the page can include one or more ancillary features (e.g., a header, a footer), which can be populated with, for example, advertising content, sponsor information, user comments, navigation tools, viewing tools, sharing options, a link to provide feedback on the selected timestamped live stream media content, and a link to download the app 149. In addition, or in the alternative, the page generator 136 can integrate pre-roll and/or post-roll media trailers (e.g., advertisements, an introduction, credits) before the beginning of and/or after the end of, respectively, the selected timestamped live stream media content. For example, after the selected timestamped live stream media content has finished, the page generator 136 can offer a link (e.g., a pushbutton on the page) that, when selected by a recipient 180, allows the recipient system 185 to transfer to the content provider system 175 to watch the contribution feed, generated by the encoders 172 of the content provider system 175, of the event live (without sharing function).

The page generator 136 can also include one or more additional features in certain example embodiments. For example, the page generator 136 can include the closed-captioning module 137 to convert any audio in the selected timestamped live stream media content into visual text that appears on part of the page. Such a feature can be controlled by the recipient 180 using the app 149. Such a feature can be useful, for example, when the recipient is deaf or otherwise hearing impaired, when the ambient noise where the recipient system 185 is located is too loud, or if the recipient wants to view the selected timestamped live stream media content in silence and does not have earphones to use. As another example, the page generator 136 can generate hashtags for trending media topics that are associated with the timestamped live stream media content.

In step 412, the CDN 148 presents the page to the recipient 180. Specifically, the control engine 125 of the controller 144 of the back-end system 145 sends the page to the CDN 148, which sends the page to the recipient system 185. In some cases, if the app 149 is loaded on the recipient system 185, the page can be presented to the recipient 180 on the app 149. In other cases, when the app 149 is not loaded on the recipient system 185, the page can be presented to the recipient 180 in another way (e.g., open a separate pop-up window on the recipient system 185, open a new window in whatever digital communication platform 195 is being used by the recipient 180 on the recipient system 185, open a web browser) to on the recipient system 185.

In step 413, the analytics module 135 of the controller 144 of the back-end system 145 tracks analytics associated with the URI and the page. In some cases, the analytics are also tracked through the CDN 148. Throughout the exchanges between the content provider 170, the cloud service provider 190, the user 150, the recipient 180, the administrative console 160, and the live media sharing system 140, the analytics module 135 of the controller 144 is performing analytics on any or all aspects of the creation, sharing, and viewing of selected timestamped live stream media content. For example, the analytics module 135 can track and analyze information about shared timestamped live stream media content from the perspective of the content provider 170, an event, the user 150, one or more of the recipients 180, potential recipients 180, and/or any other relevant aspect of selected timestamped live stream media content.

The information collected by the analytics module 135 can be stored as stored data 134 in the storage repository 130. Further, the analytics module 135 can use one or more protocols 132 and/or algorithms 133 in the storage repository 130 to analyze the information collected by the analytics module 135 and put the analyzed data into one or more presentation formats (e.g., a graph, a chart, a table). The analyzed data and the presentation formats can also be stored as stored data 134 in the storage repository 130.

The control engine 125 can share any of the information generated by the analytics module 135 with any other component (e.g., content provider system 175, a user system 155) in the system 100. The analytics module 135 can perform its collection and analytics functions automatically (e.g., based on settings by the user 150, based on settings by the administrative console 160) or in response to a specific request from a component (e.g., a content provider 170 through the content provider system 175).

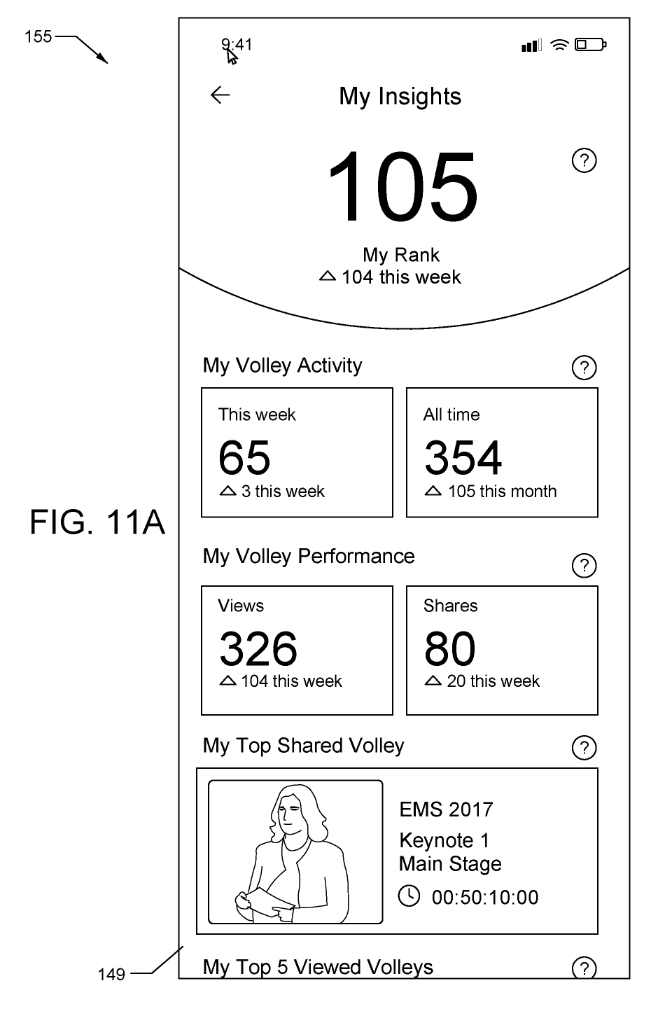

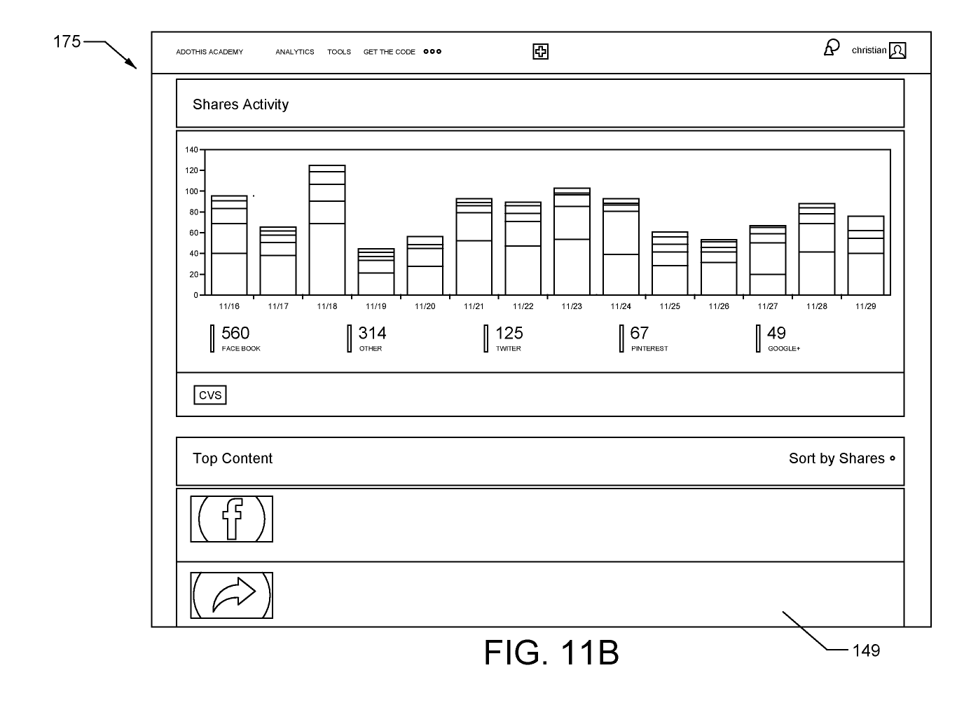

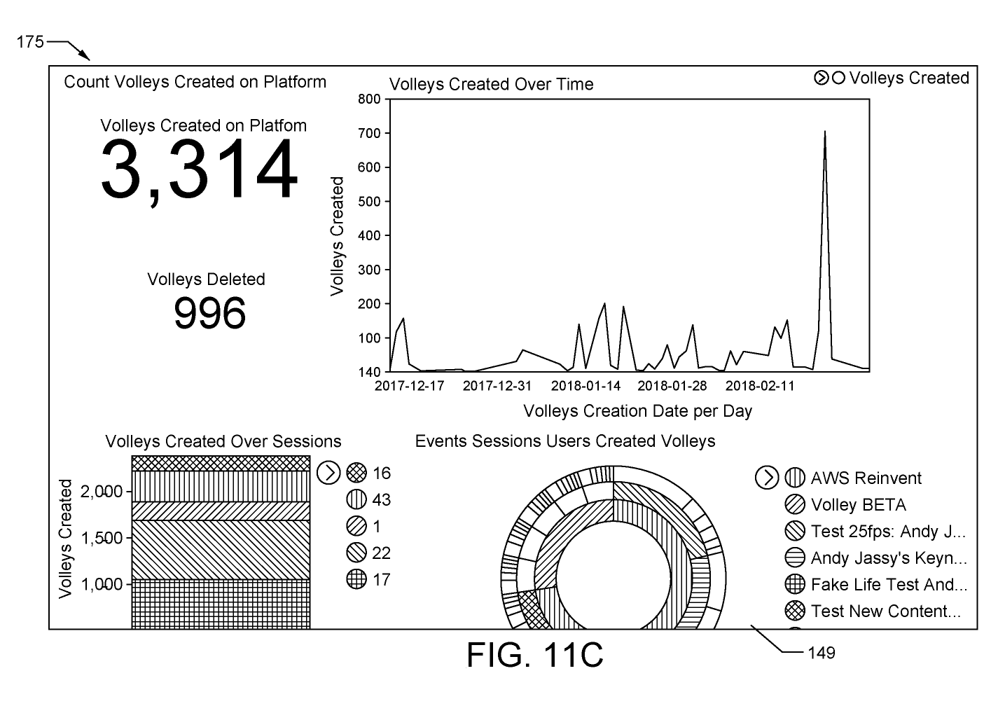

The analyses performed by the analytics module 135 can be continuous and/or in response to a specific request. The types of analyses and the format in which the analyses are presented can be pre-determined and/or based on a specific request. For example, for a particular live event (e.g., a conference), the event coordinator (a type of content provider 170) can request real-time feedback as to which presentations at the conference have the most shared timestamped live stream media content. The analytics module 135 can track and provide these analytics in real time to the content provider system 175 in any of a number of formats (e.g., dynamically updated graphics). Examples of some of these formats are shown below with respect to FIGS. 11A-11D. After step 413, the method 401 ends at the END step.

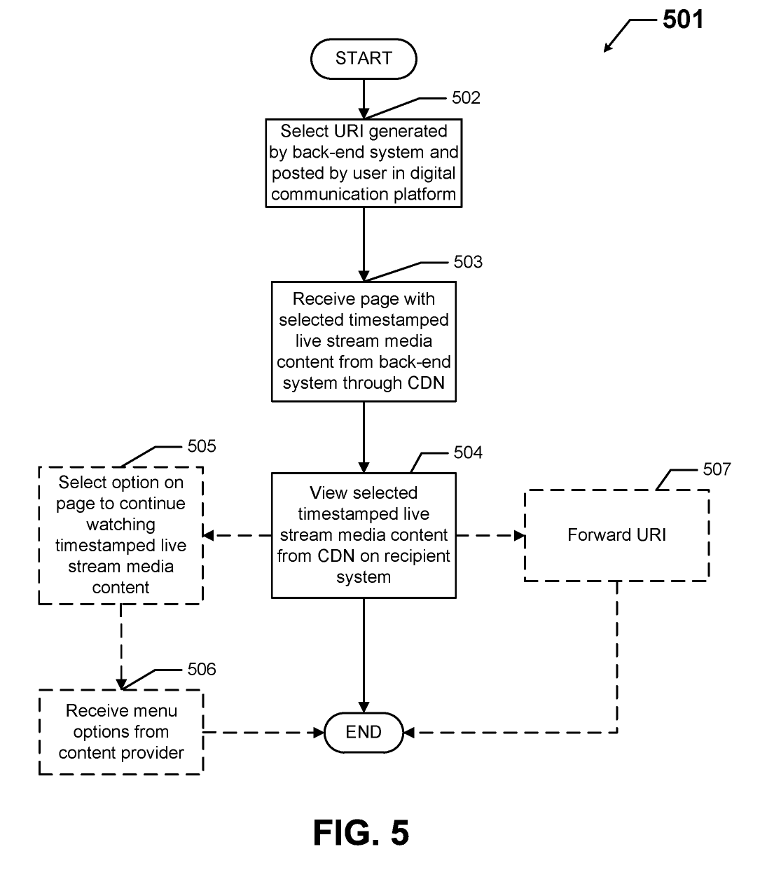

FIG. 5 shows a flow diagram of a method 501 for sharing timestamped live stream media content in real time from the perspective of a recipient 180 in accordance with certain example embodiments. Referring to FIGS. 1A through 5, the method 501 starts at the START step and proceeds to step 502, where the recipient 180 selects a URI generated by the back-end system 145 and posted by the user 150 in a digital communication platform. In alternative embodiments, the recipient 180 selects the URI in the app 149 on the recipient system 185.

When the recipient 180 receives the URI sent by the user 150, whether through the app 149 or through one of the digital communication platforms 195 loaded on the recipient system 185, the recipient 180 can receive the page generated by the page generator 136 of the controller 144 and sent by the control engine 125 of the controller 144 of the back-end system 145 through the CDN 148 by selecting the URI. For example, the recipient 180 can receive and open the URI in the app 149, in a web browser, in an email, in a text message, or from a Facebook post. The combination of the controller 144 and the CDN 148 ensure that the page and its contents (e.g., the selected timestamped live stream media content) is formatted in such a way as to be compatible with the recipient system 185 and the software that is being used to view the page.

In step 503, the recipient system 185 receives the page with the selected live stream content from the controller 144 of the back-end system 145 through the CDN 148. The page is generated by the page generator 136 of the controller 144. The control engine 125 can send the page to the CDN 148, which performs any necessary formatting to the page before sending the page to the recipient system 185. In some cases, if the app 149 is loaded on the recipient system 185, the page can be presented on the app 149. In other cases, if the app 149 is not loaded on the recipient system 185, the page can be presented in another way (e.g., open a separate pop-up window on the recipient system 185, open a new window in whatever digital communication platform 195 is being used by the recipient 180 on the recipient system 185, open a web browser) to the recipient 180 on the recipient system 185.

In step 504, the recipient 180 views the timestamped live stream media content on the page received from the CDN 148 on the recipient system 185. The page can have various controls (e.g., pause, rewind, fast forward, closed-captioning) that allow the recipient to navigate the timestamped live stream media content in the way that maximizes the experience of the recipient 180. Without the additional optional steps in this method 501, the method 501 proceeds to the END step when step 504 is complete.

In optional step 505, the recipient 180 can select an option on the page to continue watching the live event from which the timestamped live stream media content is taken. This option can be automatic once the timestamped live stream media content is finished. Alternatively, this option can be a choice (e.g., a pushbutton) that is actively selected by the recipient 180 on the page. In either case, the recipient 180 can be transported directly to the content provider system 175 to view the contribution feed of the live event in real time.

In optional step 506, the recipient 180 can receive menu options from the content provider 170. For example, the page can be active on the content provider system 175 to allow the recipient 180 to select contribution feed of the live content of the event. As another example, the content provider system 175 can seek comments on the page from the recipient 180 about the live event. As yet another example, if the live event is a pay-per-view or other type of subscription service, the controller 174 of the content service system 175 can ask the recipient 180, using a menu item on the page, whether the recipient 180 already has credentials (e.g., membership) to watch the contribution feed of the live event or, if not, whether the recipient 180 would like to pay to watch the contribution feed of the live event. When optional step 506 is complete, the process proceeds to the END step.

In optional step 507, the recipient 180 can forward the URI to another one or more recipients 180. In such a case, the recipient 180 can forward the URI using the app 149 and/or one or more of the digital communication platforms 195 loaded on the recipient system 185. As an alternative to step 507, the recipient 180 can become a user 150. For example, if the app 149 loaded on the recipient system 185, the app 149 can be configured to allow a recipient 180 to become a user 150, either by selecting new timestamped live stream media content on the app 149 and/or by altering (e.g., changing the settings, adding commentary) the just-viewed selected timestamped live stream media content to the point of creating new selected timestamped live stream media content. Also, the app 149 can allow the recipient 180 to forward the URI corresponding to the page that the recipient 180 had just viewed. In such a case, the recipient 180 can forward the URI using the app 149 and/or by copying the URI into one or more of the digital communication platforms 195 loaded on the recipient system 185 and communicating through the digital communication platform 195. The recipient 180 can also become a user 150 using a web browser. When optional step 507 is complete, the process proceeds to the END step.

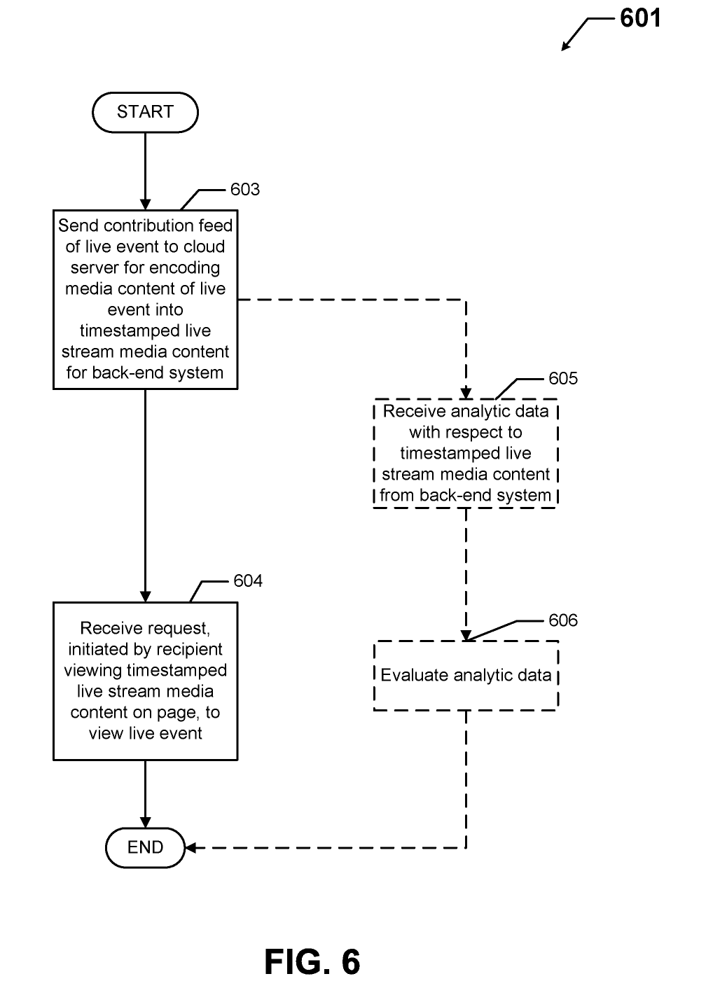

FIG. 6 shows a flow diagram of a method 601 for sharing timestamped live stream media content in real time from the perspective of a content provider 170 in accordance with certain example embodiments. Referring to FIGS. 1A through 6, the method 601 starts at the START step and proceeds to step 603, where the content provider system 175 of the content provider 170 sends, in real time, contribution feed of a live event to the cloud service provider 190 so that the contribution feed can be encoded, timestamped, and packaged into timestamped live stream media content by the encoder 192 working in conjunction with the origin server 197 for the back-end system 145. In some cases, the content provider system 175 of the content provider 170 receives a request for media content of a live event from the back-end system 145 of the live media sharing system 140. This request can be received directly from the back-end system 145 of the live media sharing system 140 or indirectly, as through the cloud service providers 190. Alternatively, the controller 174 of the content provider system 175 can automatically push the contribution feed to the cloud service providers 190 as the live media content is generated.

In step 604, the content provider system 175 of the content provider 170 receives a request, initiated by the recipient 180 viewing timestamped live stream media content on a page, to view the live event. In such a case, the recipient 180, either through the app 149 residing on the content provider system 175 or through some other app or software, is watching the live event on the content provider system 175 of the content provider 170. The page from which the request is made can be generated by the page generator 136 of the controller 144 of the back-end system 145. After step 604 is complete, the method 601 can proceed to the END step.

In optional step 605, the content provider system 175 of the content provider 170 receives analytic data with respect to the timestamped live stream media content. The analytic data can be received from the back-end system 145. Specifically, the analytics module 135 conducts various analysis relative to the generated, shared, and viewed timestamped live stream media content that is associated with a live event held by the content provider 170. The analytics module 135 can perform its collection and analytics functions automatically (e.g., based on settings by the administrative console 160) or in response to a specific request from the content provider 170 through the content provider system 175. In performing its analytics function, the analytics module 135 can request and/or receive information from the CDN 148, from the app 149, and/or from any other component in the system 100 that has access to information associated with the timestamped live stream media content.

In optional step 606, the content provider 170 can evaluate the analytic data provided by the analytics module 135. This evaluation of the analytic data provides real-time information to the content provider 170 as to popular and/or unpopular occurrences at the live event and make adjustments, in real time, to improve the experience of the live event. The analytic data can be evaluated using tools provided by the analytics module 135. In addition, or in the alternative, the analytic data can be evaluated using software on the content provider system 175.

FIG. 7 shows a format of a URI 745 in accordance with certain example embodiments. Referring to FIGS. 1A through 7, the URI 745 is generated by the URI generator 123 according to one or more protocols 132 and/or algorithms 133. In this example, the URI 745 is generated using the ID 746 (e.g., an alpha-numeric code) of the content provider 170, followed by the ID 747 of the live event, followed by the ID 748 of the selected timestamped live stream media content. All of these IDs can be assigned by the database module 131 and/or the control engine 125 of the controller 144 of the back-end system 145. The information used by the URI generator 123 to generate the URI 745 can be retrieved from the table or database associated with the timestamped live stream media content and maintained by the database module 131. The protocols 132 and/or algorithms 133 followed by the URI generator 123 ensure that the resulting URI 745 generated for each selected timestamped live stream media content is unique among all of the URIs that currently exist or will exist in the future.

FIG. 8 shows a format of a page 892 with selected timestamped live stream media content 897 in accordance with certain example embodiments. Referring to FIGS. 1A through 8, the page 892 is generated by the page generator 136 using one or more protocols 132 and/or algorithms 133. In this example, the page 892 generated by the page generator 136 includes a window 897 for showing the selected timestamped live stream media content, where the window 897 is disposed between a header 896 and a footer 898 (both ancillary features). The window 897 can include controls 894 (e.g., pause/play, fast forward, rewind) for viewing the selected timestamped live stream media content.

The header 896 and the footer 898 are each optional. Each of the header 896 and the footer 898 can include one or more items from the table or database associated with the selected timestamped live stream media content. Such items can include, but are not limited to, an advertisement, a user comment, closed-captioning preference, and headline information about the associated event provided by the content provider 170. The header 896 and/or the footer 898 can be or include a banner, an icon, text, or any other suitable content. An item in the heater 896 or the footer 898 can be selectable by a recipient 180 using a recipient system 185 or can be inactive (for information only).

As discussed above, the page generator 136 can also add content immediately before, during, and/or immediately after showing the selected timestamped live stream media content in the window 897 to the recipient 180 on the app 149 of the recipient system 185. For example, the page generator 136 can attach a brief (e.g. five second) leading (pre-roll) trailer with information about the live event from which the selected timestamped live stream media content is obtained. As another example, the page generator 136 can attach a screen as an ending (post-roll) trailer that allows the recipient 180 to transfer to the content provider system 175 to view the live event in real time. In such a case, the pre-roll trailer of the timestamped live stream media content can be considered a type of header (e.g., header, and the post-roll trailer of the timestamped live stream media content can be considered a type of footer (e.g., footer 898). The pre-roll and post-roll content can be optional.

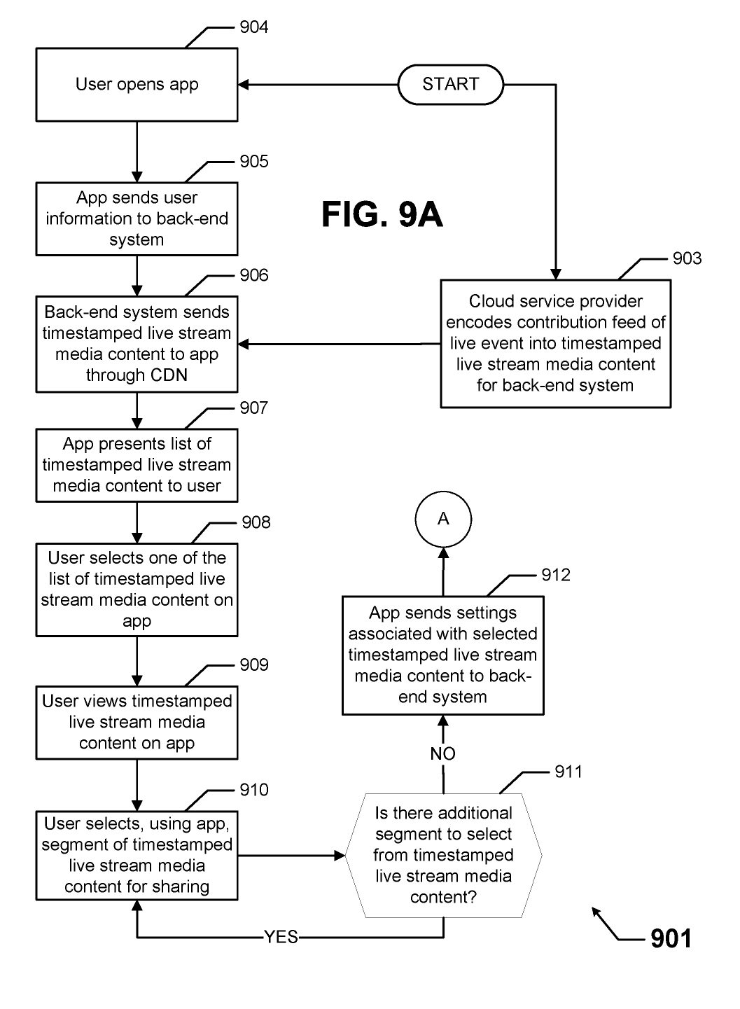

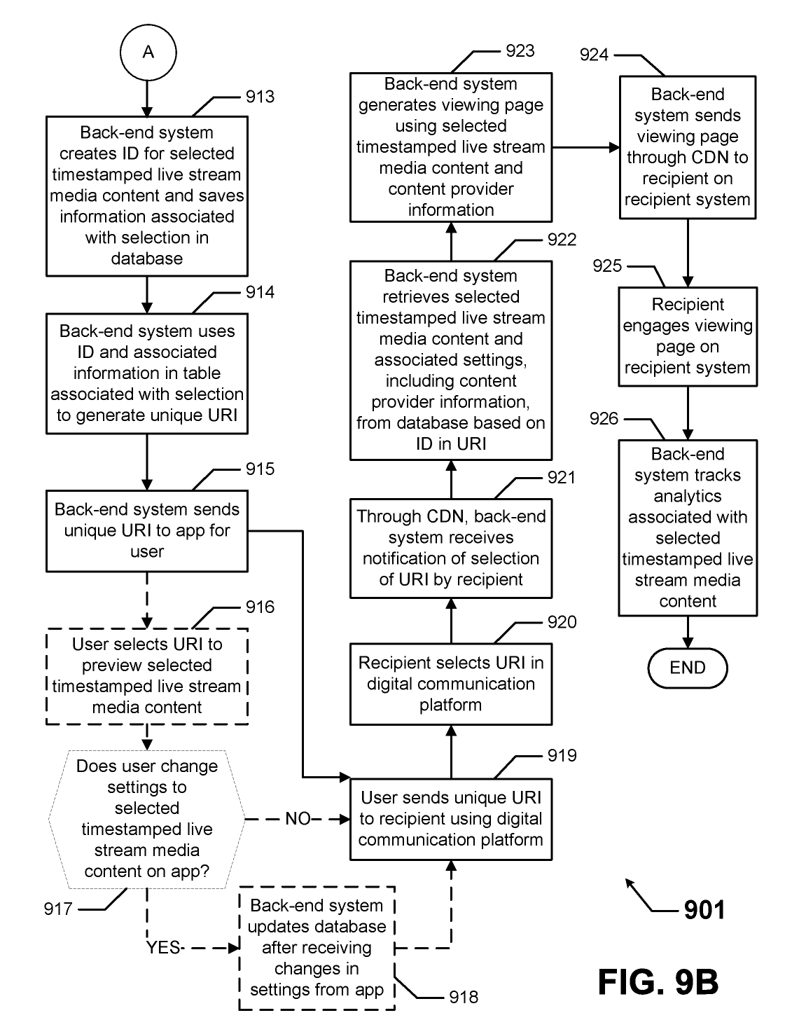

FIGS. 9A and 9B show a detailed flow diagram of the entire process 901 for creating and sharing selected timestamped live stream media content in real time in accordance with certain example embodiments. Referring to FIGS. 1A through 9B, the method 901 starts at the START step and proceeds to step 903, where the cloud service provider 190 receives contribution feed of a live event from the content provider system 175 to generate timestamped live stream media content for the back-end system 145. Specifically, the encoder 192 of the cloud service provider 190 of the cloud service provider 190 can encode, in real time, the contribution feed from the encoder 172 of a content provider system 175 of the content provider 170, and then the origin server 197 of the cloud service provider 190 time codes and packages, in real time, the streaming content generated by the encoder 192 to generate the timestamped live stream media content. The encoder 172 of the content provider system 175 generates the contribution feed in real time by encoding the live media content.

The origin server 197 of the cloud service provider 190 uses cloud-based technology that has only been developed within the past year. In other words, as stated above, prior to the end of 2017, the technology to timestamp and package streaming content into timestamped live stream media content for slightly delayed use was not available, and so the example systems for sharing timestamped live stream media content in real time between individual users 150 and individual recipients 180, as described herein, did not previously exist. In other words, this timestamping and packaging technology provided by the origin server 197 of the cloud service provider 190 is one aspect of the present invention that is specifically designed to enable the capture and sharing of timestamped live stream media content in real time in example embodiments described herein.

The origin server 197 can include a single server or multiple servers that operate simultaneously. The origin server 197 can timestamp and package multiple items of streaming content at one time. The origin server 197 can be communicably coupled to one or more origin servers 197 of one or more other cloud service providers 190. Similarly, an origin server 197 can be coupled to multiple encoders 192 of one or more cloud service providers 190. The origin server 197 can be located in a single location or in multiple locations. For example, the origin server 197 can include multiple servers that are co-located with each encoder 192 of a cloud service provider 190.

In any case, the origin server 197 can be coupled to the controller 144 of the back-end system 145 using one or more communication links 191. Example embodiments enhance the technology of the encoder 192 of the content service providers 190 using the origin server 197, the controller 144, and the app 149 of the live media sharing system 140 so that the resulting timestamped live stream media content, generated by the origin server 197, can be shared in real time in an audience (user 150)-driven system 100.

In step 904, which can be conducted in parallel with step 903, the user 150 opens the app 149. The user 150 opens the app 149 on the user system 155. In some cases, the user 150 is specifically identified by the app 149 when the user 150 opens app 149. For example, the user 150 may need to provide a user name and password or enter a PIN to access an account on the app 149.

In step 905, which can also be conducted in parallel with step 903, the app 149 on the user system 155 sends user information to the back-end system 145. The user information can be with respect to the user 150 (e.g., a name, a user ID) and/or to the user system 155 (e.g., a location of the user system 155). The information can be obtained directly from the user 150 (e.g., login credentials) and/or based on circumstances (e.g., GPS coordinates).

In step 906, which can be conducted in parallel with steps 902 and 903, the back-end system 145 sends timestamped live stream media content to the app 149 on the user system 155 through the CDN 148. The timestamped live stream media content sent by the back-end system 145 to the CDN 148, which then sends the timestamped live stream media content to the app 149, can include a descriptive name and, in some cases, a thumbnail. In step 907, the app 149 presents a list of timestamped live stream media content to the user 150. Specifically, this timestamped live stream media content presented by the app 149 on the user system 155 can be a list, with or without thumbnails, of the various timestamped live stream media content that the control engine 125 has received, through the origin server 197 and encoder 192 of a cloud service provider 190, from the various content provider systems 175. In this way, the user 150 can use the app 149 to preview and select timestamped live stream media content for sharing.

In step 908, the user 150 selects one of the list of timestamped live stream media content on the app 149. As discussed above, the list of timestamped live stream media content can include thumbnails (e.g., still images, video clips, audio file clips) and/or text to provide sufficient information to the user 150 to identify and/or preview the timestamped live stream media content.

In step 909, the user 150 views the timestamped live stream media content on the app 149. The control engine 125 of the controller 144, working in conjunction with the CDN 148, can ensure that the timestamped live stream media content is in the proper format for the user system 155. In some cases, on the CDN 148, and not the controller 144, interacts with the app 149 to present the timestamped live stream media content to the user 150 on the app 149. If the timestamped live stream media content is for a live event, the user 150 can use the app 149 to watch the timestamped live stream media content in substantially real time with the actual live event as a preview before making a selection. In some cases, an item in the list can be like a folder, with multiple timestamped live stream media content items within the folder that can be chosen. For example, for a multi-day or multi-session conference, the event can be a folder in the list, and within the folder are a list of each individual session (each having timestamped live stream media content) of the conference.

In step 910, the user 150 selects the segment of timestamped live stream media content using the app 149. For example, the app 149 on the user system 155 can allow the user 150, while previewing timestamped live stream media content, to “pin” or select a specific point in the timestamped live stream media content to select. This pin or selection in the timestamped live stream media content automatically marks a start and end time or point in the selected timestamped live stream media content. In this way, in certain example embodiments, the selected timestamped live stream media content can be selected by a user 150 with a single “click” on the app 149.

The settings associated with a pin can also vary based on the content and/or context of the timestamped live stream media content. For example, a pin can have certain settings for a live event that are different than the settings for a pin of pre-recorded media content. As another example, the settings for a pin of a sporting event can be different than the settings for a pin of a speech or presentation. Also, rather than change default settings of a pin, a user 150 can use the app 149 to manually change the start time, end time, and/or duration of a particular segment of selected timestamped live stream media content.

In step 911, a determination is made as to whether there are additional segments to select by the user 150 from the timestamped live stream media content. As discussed above, the user 150 can make multiple selections (or select multiple segments) of timestamped live stream media content and combine them into a single timestamped live stream media content. Specifically, the app 149 can allow the user 150 to view and pin each segment of timestamped live stream media content individually, and then give the user 150 the option to splice all of the selected segments of timestamped live stream media content into a single selected segment of timestamped live stream media content. Similarly, if the user 150 only selects one segment of timestamped live stream media content in the app 149, the user 150 can pin the selected timestamped live stream media content multiple times on the app 149. In such a case, the app 149 can allow the user to splice together the multiple segments of the selected timestamped live stream media content. If there are additional segments to select by the user 150 from the timestamped live stream media content, the process reverts to step 910. If there are no additional segments to select by the user 150 from the timestamped live stream media content, the process proceeds to step 912.

In step 912, the app 149 sends the selected timestamped live stream media content to the back-end system 145. In addition to the selected timestamped live stream media content, the app 149 can send any other relevant information associated with the selected timestamped live stream media content. Such other information can include, but is not limited to, the settings (e.g., start time, end time) of the selected timestamped live stream media content and any comments (annotations) provided by the user. The app 149 can send the selected timestamped live stream media content to the back-end system 145 based on an affirmative command given by the user 150 through the app 149. For example, the app 149 can include a “SEND” pushbutton that allows the user 150 to simply and efficiently instruct the controller 144 to process the selected timestamped live stream media content. In some cases, the selected timestamped live stream media content and/or the other associated information is sent by the app 149 to the CDN 148, which then sends the selected timestamped live stream media content and/or the other associated information to the back-end system 145.

In some cases, because the live media sharing system 140 operates in real time (e.g., less than 5 second delay) relative to the actual live event, it is possible that timestamped live stream media content can be selected and sent by the user 150 on the app 149 before the trail end of the content captured in the selected timestamped live stream media content has actually occurred at the live event. For example, if the user 150 receives timestamped live stream media content on the app 149 five seconds after the actual live event occurred, and if the user immediately pins, with a first click, the end of the timestamped live stream media content on the app 149, and then immediately sends, with a second click, the selected timestamped live stream media content from the app 149 to the controller 144 of the back-end system 145, it is likely that the settings have the end time (e.g., 30 seconds after the time of the pin in the selected timestamped live stream media content) capture live content that has not occurred. The CDN 148, the database module 131, and the control engine 125 work together to ensure that the yet-to-occur live content that falls within the range of the selected timestamped live stream media content is captured so that the recipient 180 sees all of the selected timestamped live stream media content when played for the recipient 180 on the app 149, as discussed below.

In step 913, the back-end system 145 creates an ID for the selected timestamped live stream media content and saves the information associated with the selected timestamped live stream media content in a table or database. Specifically, the database module 131, working in conjunction with the control engine 125 of the controller 144 of the back-end system 145, builds a table or database for each item of selected media content. The table or database is populated with all of the information that is received by the control engine 125 from the app 149 on the user system 155 and that is associated with the selected timestamped live stream media content. In addition, the database module 131 populates the table or database with other information associated with the selected timestamped live stream media content. Examples of such other information can include, but is not limited to, advertisements, sponsorship, pre-roll content, post-roll content, changes in user-defined default values, and applicable settings received by the control engine 125 from the administrative console 160. Such other information can be provided by a non-user (e.g., the content provider 170).

Any identification numbers (e.g., for the user 150, for a content provider 170, for an event, for selected timestamped live stream media content) that are used in association with selected timestamped live stream media content can be generated by the control engine 125 or the database module 131 using one or more algorithms 133 and/or protocols 132 in the storage repository 130. The table or database populated and maintained by the database module 131 is part of the stored data 134 in the storage repository in certain example embodiments.

The database module 131 can also update a table or database for an existing selection of timestamped live stream media content. For example, a new or added sponsor of an event associated with the selected timestamped live stream media content can be updated or added to the table or database by the database module 131. As another example, if an advertisement associated with the selected timestamped live stream media content is changed, the database module 131 can update the table or database accordingly. As yet another example, if the user 150, through the app 149, alters the start and/or end time of the existing selection of timestamped live stream media content, the database module 131 updates the table or database accordingly.

In step 914, the back-end system 145 uses the ID and other information associated with the selected timestamped live stream media content in the table or database to generate a unique URI 745. Specifically, the URI generator 123 of the controller 144 of the back-end system 145 generates the URI 745 for the selected timestamped live stream media content. In certain example embodiments, the URI generator 123 follows one or more protocols 132 stored in the storage repository 130 to generate a URI 745. For example, the URI generator 123 can generate a URI 745 for selected timestamped live stream media content using an ID of the content provider 170, an ID of the live event, and an ID of the selected timestamped live stream media content. The information used to generate the URI 745 by the URI generator 123 can be looked up in the table or database associated with the selected timestamped live stream media content. When the URI generator 123 generates a URI 745, the URI 745 can be stored in the table or database associated with the selected timestamped live stream media content by the database module 131.

In step 915, the back-end system 145 sends the URI 745 to the app 149 for the user 150. Specifically, the app 149 loaded on the user system 155 receives the URI 745, generated by the URI generator 123 and sent by the control engine 125 of the controller 144 of the back-end system 145, for the selected timestamped live stream media content created by the user 150 on the app 149. In some cases, the URI 745 is sent by the back-end system 145 to the CDN 148, which then sends the URI 745 to the app 149. After step 915 is complete, the process can proceed to step 919 or, optionally, to step 916.

In step 916, the user 150 selects the URI 745 to preview the selected timestamped live stream media content. When the user 150 receives the URI 745 in the app 149, the user 150 can view the selected timestamped live stream media content by selecting the URI 745 in the app 149 before sharing the URI 745. This step 916 can be an optional step. When the user 150 selects the URI 745 in the app 149, the CDN 148 can send the timestamped live stream media content to the app 149 for presentation to the user 150.

In step 917, a determination is made as to whether the user 150 has changed any settings to the selected timestamped live stream media content on the app 149. If the user 150 wants to change any aspect (e.g., start time, end time, annotations) of the selected timestamped live stream media content, the user 150 can make those changes using the app 149. In such a case, the URI 745 associated with the modified selected timestamped live stream media content does not change. If any such changes have been made by the user 150 on the app 149, then those changes are sent (either directly or through the CDN 148) to the back-end system 145. This step 917 can be an optional step. If the user 150 has changed any settings to the selected timestamped live stream media content on the app 149, then the process proceeds to step 918. If the user 150 has not changed any settings to the selected timestamped live stream media content on the app 149, then the process proceeds to step 919.

In step 918, the back-end system 145 updates the table or database after receiving the changes in the information associated with the selected timestamped live stream media content from the app 149. Specifically, the database module 131 updates and saves the new information in the table or database associated with that selected timestamped live stream media content. Similarly, the database module 131 can receive, update, and save new information in the table or database associated with that selected timestamped live stream media content based on changes provided by other components of the system 100. For example, the content provider 170 can add or change a sponsor to certain selected timestamped live stream media content. This step 918 can be an optional step.

In step 919, the user 150 sends the unique URI 745 to one or more recipients 180 using one or more digital communication platforms 195. Specifically, the user 150, using the user system 155, can copy the URI 745 from the app 149 and forward the URI 745 to one or more recipients 180 on one or more recipient systems 185 by pasting the URI 745 into one or more digital communication platforms 195 loaded on the user system 155. In addition, or in the alternative, the user 150 can use the app 149 to forward the URI 745 directly to one or more recipients 180 in the app 149. In any case, the recipients 180 can be specifically identified. In addition, or in the alternative, the URI 745 can be posted on a social media site or in the app 149 for any of a number of unidentified recipients 180 to select the URI 745.

In step 920, the recipient 180 selects the URI 745 in the digital communication platform 195 as posted by the user 150. In alternative embodiments, the recipient 180 selects the URI 745 in the app 149 on the recipient system 185. When the recipient 180 receives the URI 745 sent by the user 150, whether through the app 149 or through one of the digital communication platforms 195 loaded on the recipient system 185, the recipient 180 can receive the page 892 generated by the page generator 136 of the controller 144 and sent by the control engine 125 of the controller 144 of the back-end system 145, through the CDN 148, by selecting the URI 745. For example, the recipient 180 can receive and open the URI 745 from the CDN 148 in the app 149, in a web browser, in an email, in a text message, or from a Facebook post. The combination of the controller 144 and the CDN 148 ensure that the page 892 and its contents (e.g., the selected timestamped live stream media content) is formatted in such a way as to be compatible with the recipient system 185 and the software that is being used to view the page 892.

In step 921, the back-end system 145, at times through the CDN 148, receives notification of the selection of the URI 745 by the recipient 180 on the recipient system 185. Specifically, when a URI 745 is selected by a recipient 180 on a recipient system 185 (e.g., on a digital communication platform 195 (e.g., on Facebook, in an email, in a text message, on Twitter), in the app 149), the control engine 125 of the controller 144 of the back-end system 145 is notified (sometimes indirectly through the CDN 148) of the selection of the specific URI 745. Upon receiving this notification, the control engine 125 notifies the page generator 136 of the controller 144 of the selected URI 745.

In step 922, the back-end system 145 retrieves the selected timestamped live stream media content and associated settings, including content provider information, from the table or database based on the ID in the URI 745. Specifically, the page generator 136, either directly or through the control engine 125, requests the information in the table or database associated with the selected URI 745 from the database module 131. The database module 131 receives the selected URI 745 and is able to deconstruct, at least in part, the contents of the URI 745 and use this deconstructed information to retrieve the information from the associated table or database. In alternative embodiments, if the URI 745 is stored in the table or database, no deconstruction of the URI 745 may be needed. In any event, when the database module 131 has retrieved all of the information in the table or database associated with the selected URI 745, this information is sent, either directly or through the control engine 125, to the page generator 136.

The information requested by the page generator 136 can be specific (e.g., only the selected timestamped live stream media content, the start time, the end time, any sponsor information). Alternatively, the page generator 136 can request and receive all information associated with the URI 745. In this latter case, the page generator 136 can determine which, if any, of that information to discard and which information to use in generating a page 892. In yet another embodiment, the page generator 136 does not make a request. Instead, the database module 131 simply sends all information associated with the URI that is stored in the table or database to the page generator 136.

In step 923, the back-end system 145 generates a viewing page 892 using the selected timestamped live stream media content and the associated information, including content provider information. Specifically, when the information associated with the selected URI 745 is received by the page generator 136, the page generator 136 can generate a page 892 using one or more algorithms 133 and/or protocols 132 in the storage repository 130. These algorithms 133 and/or protocols 132 can vary based on one or more of a number of factors, including but not limited to the ID of the user 150, the ID of the content provider 170, the length of the selected timestamped live stream media content, the functionality of the recipient system 185, and the type of live event (e.g., sports, presentation). The page generator 136 generates a page 892 based on the appropriate algorithms 133 and/or protocols 132 using the information provided by the database module 131, including content provider information.

For example, the page 892 can include one or more ancillary features (e.g., a header 896, a footer 898), which can be populated with, for example, advertising content, sponsor information, user comments, navigation tools, viewing tools, sharing options, a link to provide feedback on the selected timestamped live stream media content, and a link to download the app 149. In addition, or in the alternative, the page generator 136 can integrate media trailers (e.g., advertisements, an introduction, credits) before the beginning of (pre-roll) and/or after the end of (post-roll) the selected timestamped live stream media content. For example, after the selected timestamped live stream media content has finished, the page generator 136 can offer a link (e.g., a pushbutton on the page 892) that, when selected by a recipient 180, allows the recipient 180 to transfer to the content provider system 175 to watch the event live (without sharing function).

The page generator 136 can also include one or more additional features in certain example embodiments. For example, the page generator 136 can include a closed-captioning feature (generated by the closed-captioning module 137) that converts any audio in the selected timestamped live stream media content into visual text that appears on part of the page 892. Such a feature can be controlled by the recipient 180 using the app 149. Such a feature can be useful, for example, when the recipient is deaf or hard of hearing, when the ambient noise where the recipient system 185 is located is too loud, or if the recipient wants to view the selected timestamped live stream media content in silence and does not have earphones to use.

As discussed above, the closed-captioning module 137 can be used for live content or on-demand content. Also, some or all of the functionality of the closed-captioning module 137 can be performed by a third party (e.g., the content provider system 175, an independent closed-captioning service) that is in communication with the controller 144. For example, the closed captioning can be provided by the content provider 170 through the content provider system 175 substantially concurrent with when the media content is generated and transformed into contribution feed. In some cases, the page generator 136 can generate hashtags for trending media topics that are associated with the timestamped live stream media content.

In step 924, the back-end system 145 sends the viewing page 892 through the CDN 148 to the recipient 180 on the recipient system 185. Specifically, the control engine 125 of the controller 144 sends the page 892 to the CDN 148, which then sends the page 892 to the recipient system 185. In some cases, if the app 149 is loaded on the recipient system 185, then the CDN 148 can send the page 892 to the app 149. In other cases, the CDN 148 can use some other means (e.g., open a separate pop-up window on the recipient system 185, open a new window in whatever digital communication platform 195 is being used by the recipient 180 on the recipient system 185, open a browser) to present the page 892 to the recipient 180 on the recipient system 185.

In step 925, the recipient 180 engages (interacts with) the page 892 on the recipient system 185. The page 892 can have various controls (e.g., pause, rewind, fast forward, closed-captioning) that allow the recipient to navigate the timestamped live stream media content in the way that maximizes the experience of the recipient 180. In addition to merely watching the selected timestamped live stream media content, the recipient 180 can take other actions. For example, the recipient 180 can select an option to continue watching the live event from which the timestamped live stream media content is taken. This option can be automatic once the timestamped live stream media content is finished. Alternatively, this option can be a choice (e.g., a pushbutton) that is actively selected by the recipient 180. In either case, the recipient 180 can be transported directly to the content provider system 175 to view the live event in real time.

As another example, the recipient 180 can receive menu options from the content provider 170. For example, the app 149 can be active on the content provider system 175 to allow the recipient 180 to select live content of the event. As another example, the content provider system 175 can seek comments from the recipient 180 about the live event. As yet another example, if the live event is a pay-per-view or other type of subscription service, the controller 174 of the content service system 175 can ask the recipient 180, using a menu item on the page 892, whether the recipient 180 already has credentials (e.g., membership) to watch the live streaming content or, if not, whether the recipient 180 would like to pay to watch the live streaming content.

As yet another example, the recipient 180 can forward the URI 745 to another one or more recipients 180, using the app 149 and/or one or more of the digital communication platforms 195 loaded on the recipient system 185. As an alternative to step 507, the recipient 180 can become a user 150. Specifically, the app 149 loaded on the recipient system 185 or the content provider system 175 can also be configured to allow a recipient 180 to become a user 150, either by selecting new timestamped live stream media content on the app 149 and/or by altering (e.g., changing the settings, adding commentary) the just-viewed selected timestamped live stream media content to the point of creating new selected timestamped live stream media content.

In some cases, the recipient 180 can copy the URI 745 associated with the just-viewed timestamped live stream media content from the page 892, the app 149, a digital communication platform 195, or any other software on which the URI 745 is presented, and then forward the URI 745 corresponding to the page 892 that the recipient 180 had just viewed to one or more other recipients 180. In such a case, the recipient 180 can forward the URI 745 using the app 149 and/or by copying the URI 745 into one or more of the digital communication platforms 195 loaded on the recipient system 185 and communicating through the digital communication platform 195.

In step 926, the back-end system 145 tracks analytics associated with the selected timestamped live stream media content. Throughout the exchanges between the content provider 170, the cloud service provider 190, the user 150, the recipient 180, the administrative console 160, and the live media sharing system 140, the analytics module 135 of the controller 144 is capturing and processing analytic data related to any or all aspects of the creation, sharing, and viewing of selected timestamped live stream media content. For example, the analytics module 135 can track and analyze information about shared timestamped live stream media content from the perspective of the content provider 170, an event, the user 150, one or more of the recipients 180, potential recipients 180, and/or any other relevant aspect of selected timestamped live stream media content.

The information collected by the analytics module 135 can be stored as stored data 134 in the storage repository 130. Further, the analytics module 135 can use one or more protocols 132 and/or algorithms 133 in the storage repository 130 to analyze the information collected by the analytics module 135 and put the analyzed data into one or more presentation formats (e.g., a graph, a chart, a table). The analyzed data and the presentation formats can also be stored as stored data 134 in the storage repository 130.

The control engine 125 can share any of the information generated by the analytics module 135 with any other component (e.g., content provider system 175, a user system 155) in the system 100. The analytics module 135 can perform its collection and analytics functions automatically (e.g., based on settings by the user 150, based on settings by the administrative console 160) or in response to a specific request from a component (e.g., a content provider 170 through the content provider system 175).

The analyses performed by the analytics module 135 can be continuous and/or in response to a specific request. The types of analyses and the format in which the analyses are presented can be pre-determined and/or based on a specific request. For example, for a particular live event (e.g., a conference), the event coordinator can request real-time feedback as to which presentations at the conference have the most shared timestamped live stream media content. The analytics module 135 can track and provide these analytics in real time to the content provider system 175 in any of a number of formats (e.g., dynamically updated graphics). After step 926, the method 901 concludes at the END step.

FIGS. 10A-10V show a series of images illustrating an example of sharing video content in accordance with certain example embodiments. Referring to FIGS. 1A through 10V, a user system 155 (e.g., a smart phone) is used to display an example of tutorial session of the app 149 in FIGS. 10A and 10B. FIG. 10C shows an example of a home screen for the app 149 on a user system 155. The home screen in FIG. 10C shows a number of featured live events, live events occurring in the near future, live events available on demand, and archived or historical footage.

FIG. 10D shows a screen on the app 149 on the user system 155 that appears after a user selects a live event that is scheduled but has not yet occurred. FIG. 10E shows the app 149 on a user system 155 with a live event landing screen with a previous session of the live event listed as a reference. In FIG. 10F, the app 149 on the user system 155 instructs the user how to create timestamped live stream media content of the live event showing in the app 149. FIG. 10G shows a screen on the app 149 of the user system 155 that allows a user to login to change user settings for the app 149.

FIG. 10H shows a screen on the app 149 of the user system 155 that allows a user to login to a social media site (in this case, Twitter, Google, and LinkedIn) through the app 149 to make sharing the resulting URI 745 more efficient for the user. FIG. 10I shows the app 149 on the user system 155 prompting the user to create/edit timestamped live stream media content captured using the app 149. FIG. 10J shows a screen on the app 149 of the user system 155 that allows a user to add a comment to the timestamped live stream media content captured using the app 149. FIG. 10K shows a screen on the app 149 of the user system 155 that allows a user to add hashtags, annotations, comments, etc. to the timestamped live stream media content captured using the app 149.

FIG. 10L shows a screen on the app 149 of the user system 155 that allows a user to take a tutorial. FIG. 10M shows a screen on the app 149 of the user system 155 that allows a user to edit or share the timestamped live stream media content captured using the app 149. FIG. 10N shows a screen on the app 149 of the user system 155 that allows a user to capture timestamped live stream media content of a previous session of the live event using the app 149. FIG. 10O shows a screen on the app 149 of the user system 155 that allows a user to save the timestamped live stream media content captured using the app 149.

FIG. 10P-1 shows a screen on a digital communication platform 195 (in this case, Facebook) of the user system 155 that allows a user to share the URI 745 associated with the timestamped live stream media content captured using the app 149. FIG. 10P-2 shows a screen on a digital communication platform 195 (in this case, Twitter) of the user system 155 that allows a user to share the URI 745 associated with the timestamped live stream media content captured using the app 149. FIG. 10P-3 shows a screen on a digital communication platform 195 (in this case, LinkedIn) of the user system 155 that allows a user to share the URI 745 associated with the timestamped live stream media content captured using the app 149.

FIG. 10P-4 shows a screen on a digital communication platform 195 (in this case, email) of the user system 155 that allows a user to share the URI 745 associated with the timestamped live stream media content captured using the app 149. FIG. 10Q-1 shows a screen on a digital communication platform 195 (in this case, email) of a recipient system 185 that shows the URI 745 associated with the timestamped live stream media content captured and sent by the user, as shown in FIG. 10P-4. FIG. 10P-5 shows a screen on a digital communication platform 195 (in this case, available native services (e.g., AirDrop)) of the user system 155 (in this case, an iPhone) that allows a user to share a URI associated with the timestamped live stream media content captured using the app 149.

FIG. 10P-6 shows a screen on a digital communication platform 195 (in this case, text message) of the user system 155 that allows a user to share the URI 745 associated with the timestamped live stream media content captured using the app 149. FIG. 10Q-2 shows a screen on a digital communication platform 195 (in this case, text message) of a recipient system 185 that shows the URI 745 associated with the timestamped live stream media content captured and sent by the user, as shown in FIG. 10P-6. FIG. 10R shows a screen on the app 149 of the user system 155 that gives the user confirmation that the selected timestamped live stream media content has been received by the recipient.

FIG. 10S shows a screen on the app 149 of the recipient system 185 that provides a trailer in the window 897 at the start of the selected timestamped live stream media content, as well as navigation elements in the footer 898 for various digital communication platforms 195 (in this case, LinkedIn, Twitter, Facebook, and email). FIG. 10T shows a screen on the app 149 of the recipient system 185 that provides the selected timestamped live stream media content in the window 897, as well as navigation elements in the footer 898 for various digital communication platforms 195 (in this case, LinkedIn, Twitter, Facebook, and email).

FIG. 10U shows a screen on the app 149 of the recipient system 185 that provides a trailer in the window 897 at the end of the selected timestamped live stream media content, as well as navigation elements in the footer 898 for various digital communication platforms 195 (in this case, LinkedIn, Twitter, Facebook, and email). In this case, the trailer in the window 897 invites the user to be transported to the content provider to view more of the live event. FIG. 10V shows a screen on the app 149 of the recipient system 185 that displays a listing the shared timestamped live stream media content for an event and providing information (e.g., thumbnail, description, duration) associated with each item of shared timestamped live stream media content.

FIGS. 11A-11C each shows an analytics output in accordance with certain example embodiments. Referring to FIGS. 1A through 11C, the outputs shown in FIGS. 11A-11C are generated by the analytics module 135 of the controller 144 of the live media sharing system 140. Most, if not all, of this analytic data or information can be collected, analyzed, and/or provided in real time. The output of the analytics module 135 can be presented in a number of different ways using any of a number of different media. For example, the output of the analytics module 135 can be a menu option on the app 149. As another example, the output of the analytics module 135 can be accessed to a separate password-protected, web-based administrative console 160. The output of the analytics module 135 can be uniquely configurable and customizable for any entity (e.g., a user 150, a recipient 180, a content provider 170, a sponsor, an advertiser) to allow that entity to control key aspects of their content. In some cases, rather than being part of the controller 144 of the back-end system 145, the analytics module 135 can be part of the administrative console 160.

FIG. 11A shows a screen on the app 149 on the user system 155 that displays analytics of the user's activity in sharing timestamped live stream media content on the app 149. Specifically, the screen of FIG. 11A shows the user's activity on the app 149 for the week and all time in terms of shared timestamped live stream media content, as well as the number of times for the week that the shared timestamped live stream media content of the user has been viewed and shared.

FIG. 11B shows a screen presented, for example, on the content provider system 175, where the screen displays analytics of shared timestamped live stream media content for an event. In this case, the analytics are for the number of times the timestamped live stream media content for the event have been shared shown in a bar graph. FIG. 11C shows a screen presented, for example, on the content provider system 175, where the screen displays analytics of shared timestamped live stream media content for an event. In this case, the analytics are for the number of times the timestamped live stream media content for the event have been shared shown in a variety of formats.

FIG. 12 illustrates one embodiment of a computing device 1268 that implements one or more of the various techniques described herein, and which is representative, in whole or in part, of the elements described herein pursuant to certain exemplary embodiments. For example, computing device 1268 can be implemented in the back-end system 145 of FIGS. 1A and 1B in the form of the hardware processor 120, the memory 122, and the storage repository 130, among other components. Computing device 1268 is one example of a computing device and is not intended to suggest any limitation as to scope of use or functionality of the computing device and/or its possible architectures. Neither should computing device 1268 be interpreted as having any dependency or requirement relating to any one or combination of components illustrated in the example computing device 1268.

Computing device 1268 includes one or more processors or processing units 1264, one or more memory/storage components 1265, one or more input/output (I/O) devices 1266, and a bus 1267 that allows the various components and devices to communicate with one another. Bus 1267 represents one or more of any of several types of bus structures, including a memory bus or memory controller, a peripheral bus, an accelerated graphics port, and a processor or local bus using any of a variety of bus architectures. Bus 1267 includes wired and/or wireless buses.

Memory/storage component 1265 represents one or more computer storage media. Memory/storage component 1265 includes volatile media (such as random access memory (RAM)) and/or nonvolatile media (such as read only memory (ROM), flash memory, optical disks, magnetic disks, and so forth). Memory/storage component 1265 includes fixed media (e.g., RAM, ROM, a fixed hard drive, etc.) as well as removable media (e.g., a Flash memory drive, a removable hard drive, an optical disk, and so forth).

One or more I/O devices 1266 allow a customer, utility, or other user to enter commands and information to computing device 1268, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, cloud-based storage, or any other medium which is used to store the desired information and which is accessible by a computer.

The computer device 1268 is connected to a network (not shown) (e.g., a LAN, a WAN such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 1268 includes at least the minimal processing, input, and/or output means necessary to practice one or more embodiments.

Further, those skilled in the art will appreciate that one or more elements of the aforementioned computer device 1268 is located at a remote location and connected to the other elements over a network in certain exemplary embodiments. Further, one or more embodiments is implemented on a distributed system having one or more nodes, where each portion of the implementation (e.g., control engine 125) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

In one or more example embodiments, live media content of a live event can be shared in real time between people. Example embodiments allow flexibility and efficiency for a user to create selected timestamped live stream media content substantially in real time from when the event occurs. Example embodiments also allow a user to share a uniquely created link with any of a number of recipients using any of a number of digital communication platforms (e.g., Facebook, LinkedIn, Twitter, email, text message), also in real time relative to the event. Example embodiments also allow a recipient to view the selected timestamped live stream media content in real time, provide commentary, and forward the link of the selected timestamped live stream media content to other recipients. Example embodiments can also a recipient to become a user and/or transfer to the live event hosted by a content provider. Example embodiments also provide complete and customizable analytics, available in real time, for a content provider, a user, a recipient, or any other party involved in sharing selected timestamped live stream media content.

Accordingly, many modifications and other embodiments set forth herein will come to mind to one skilled in the art to which sharing timestamped live stream media content in real time pertain having the benefit of the teachings presented in the foregoing descriptions and the associated drawings. Therefore, it is to be understood that sharing timestamped live stream media content in real time are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A system for sharing timestamped live stream media content in real time, comprising:
a controller configured to be communicably coupled to a content delivery network (CDN) and an app on a user system, wherein the controller comprises a database module and a uniform resource identifier (URI) generator, wherein the controller is configured to:
receive a selection of the timestamped live stream media content from the app on the user system, wherein the selection comprises an identification of the timestamped live stream media content, and a start time and an end time associated with a plurality of timestamps embedded in the timestamped live stream media content by an origin server, wherein the timestamped live stream media content is substantially concurrent with a corresponding live event;
generate, by the database module and based on the selection of the timestamped live stream media content, a table populated with the selection and other information associated with the selection of the timestamped live stream media content;
generate, by the URI generator, a URI, wherein the URI is derived from contents of the table associated with the selection of the timestamped live stream media content; and
send the URI to the app on the user system.

2. The system of claim 1, wherein the controller further comprises a page generator, wherein the controller is further configured to:
receive, from a recipient system, notification of a URI selection of the URI;
generate, by the page generator, a viewing page for the recipient system in response to receiving the URI selection, wherein the viewing page is generated using the contents of the table; and
send the viewing page through the CDN to the recipient system.

3. The system of claim 2, wherein the controller further comprises:
an analytics module that continuously collects and processes analytics information associated with the URI, wherein the analytics module further generates an analytics output of the analytics information.

4. A method for sharing timestamped live stream media content of a live event in real time, comprising:
receiving, by a controller of a live media sharing system, a first selection of the timestamped live stream media content from an app on a user system, wherein the first selection comprises an identification of the timestamped live stream media content, and a first start time and a first end time associated with a plurality of timestamps embedded in the timestamped live stream media content by an origin server, wherein the timestamped live stream media content is substantially concurrent with the live event;
generating, by the controller and based on the first selection of the timestamped live stream media content, a first table populated with the selection and other information associated with the selection of the timestamped live stream media content;
generating, by a URI generator, a first uniform resource identifier (URI), where the first URI is derived from first contents of the first table associated with the portion first selection of the timestamped live stream media content; and
sending the first URI to the app on the user system.

5. The method of claim 4, further comprising:
receiving, from a first recipient system, notification of a first URI selection of the first URI;
generating, by a page generator, a first viewing page in response to receiving the first URI selection, wherein the first viewing page is generated using the first contents of the first table; and
sending, by the controller, the first viewing page through a content delivery network (CDN) to the first recipient system.

6. The method of claim 5, wherein the first contents of the first table used to generate the first viewing page comprise the first selection of the timestamped live stream media content, the first start time, the first end time, a first duration, user comments, and associated content provider information.

7. The method of claim 5, wherein generating the first table, generating the first URI, sending the first URI, generating the first viewing page, and sending the first viewing page are all performed in real time.

8. The method of claim 5, further comprising:
receiving, from the app on the user system, a revised first selection of the timestamped live stream media content;
updating, in real time, the first table with revised first information based on the first revised selection;
receiving, from the recipient system, notification of a second URI selection of the first URI;
generating, in real time by the page generator in response to the second URI selection, a revised first page using the revised first information; and
sending, in real time by the controller, the revised first page through a content delivery network (CDN) of the live media sharing system to the first recipient system.

9. The method of claim 5, further comprising:
receiving a second selection of the timestamped live stream media content from the first recipient system through the app, wherein the second selection alters the first information of the first selection of the timestamped live stream media content;
generating, by the page generator in real time and based on the second selection of the timestamped live stream media content, a second table populated with the second selection and other information associated with the second selection of the timestamped live stream media content;
generating, in real time and based on the second selection of the timestamped live stream media content, a second URI, where the second URI is derived from second contents of the second table associated with the timestamped live stream media content;
sending, in real time, the second URI to the first recipient system through the app;
receiving, from a second recipient system, notification of a second URI selection of the second URI;
generating, in real time by a page generator, a second viewing page in response to receiving the second URI selection, wherein the second viewing page is generated using the second contents of the second table; and
sending, in real time by the controller, the second viewing page through a content delivery network (CDN) of the live media sharing system to the second recipient system.

10. The method of claim 5, further comprising:
collecting analytics information, continuously and in real time, associated with the first URI;
generating, in real time, an analytics output of the analytics information,
wherein the analytics output is continuously updated and provided in real time.

11. The method of claim 5, wherein the timestamped live stream media content is automatically pushed to the live media sharing system by the origin server in real time.

12. The method of claim 4, wherein a user of the user system is attending the live event.

13. The method of claim 4, wherein the app is part of a software development kit.

14. The method of claim 4, further comprising:
generating a unique identification number associated with the first selection of the timestamped live stream media content, wherein the unique identification number is used to generate the first URI.

15. A system for sharing timestamped live stream media content of a live event in real time, comprising:
a first encoder configured to:
receive streaming media content of the live event; and
encode the streaming media content continuously and in real time to generate contribution feed; and
a controller coupled to the first encoder, wherein the controller is configured to:
send the contribution feed to a second encoder of a cloud service provider, wherein the second encoder is configured to encode the contribution feed continuously to generate streaming content, wherein the second encoder is configured to send the streaming content continuously to an origin server of the cloud service provider, wherein the origin server is configured to timestamp and package the streaming content to generate, continuously, the timestamped live stream media content, wherein the origin server is further configured to send, continuously, the live stream media content to a live media sharing system of a live media sharing system, wherein the live media sharing system is configured to allow real-time access to a selection of the timestamped live stream media content to a recipient through an app by generating a uniform resource identifier (URI) based on the selection of the timestamped live stream media content by a user using the app.

16. A method for sharing timestamped live stream media content, comprising:
receiving, by a first encoder of a content provider system, live media content of a live event continuously;
encoding, by the first encoder, the live media content into contribution feed continuously; and
sending, by the content provider system, continuously, contribution feed to a second encoder of a cloud service provider, wherein the second encoder is configured to encode the contribution feed continuously to generate streaming content, wherein the second encoder is configured to send the streaming content continuously to an origin server of the cloud service provider, wherein the origin server is configured to timestamp and package the streaming content to generate, continuously, the timestamped live stream media content, wherein the origin server is further configured to send, continuously, the timestamped live stream media content to a live media sharing system of a live media sharing system, wherein the live media sharing system is configured to allow real-time access to a selection of the timestamped live stream media content to a recipient through an app by generating a uniform resource identifier (URI) based on the selection of the timestamped live stream media content by a user using the app.

17. The method of claim 16, wherein the content provider system automatically sends the contribution feed to the second encoder continuously as the live event occurs.

18. The method of claim 16, wherein the content provider system further sends content provider information to the live media sharing system, wherein the content provider information comprises at least one advertisement associated with the timestamped live stream media content.

19. The method of claim 16, further comprising:
receiving, from a recipient device used by a recipient, a selection of a link to the content provider system, wherein the link is presented to the recipient on the recipient device along with the selection of the timestamped live stream media content; and
providing access for the recipient device to the content provider system.

20. A graphical user interface for sharing timestamped live stream media content, comprising:
a list of the timestamped live stream media content that is configured to be individually selectable by a user;
a list of selectable parameters that appears after one of the list of the timestamped live stream media content is individually selected by the user, wherein each parameter in the list of selectable parameters is configured to be adjusted by the user in order to select the timestamped live stream media content for sharing; and
a submission element that is configured to be selectable by a user to submit the timestamped live stream media content selected by the user and a configuration of the list of parameters to a live media sharing system,
wherein a uniform resource identifier (URI), generated by the live media sharing system using the selected timestamped live stream media content and the selected parameters, is subsequently presented, wherein the URI is a forwardable link that allows a recipient, upon selecting the URI, to view the timestamped live stream media content selected by the user.
